(19) United States
(12) Patent Application Publication
(10) Pub. No.: US 2024/0030597 A1
(43) Pub. Date: Jan. 25, 2024

(54) SERIALLY FED SIGNAL DISTRIBUTION NETWORKS

(71) Applicant: Space Exploration Technologies Corp., Hawthorne, CA (US)

(72) Inventors: Kim W. Schulze, Seattle, WA (US); Amir Agah, Kirkland, WA (US); Eric Pepin, Seattle, WA (US); Mehrdad Nosrati, Kirkland, WA (US)

(21) Appl. No.: 18/223,941

(22) Filed: Jul. 19, 2023

Related U.S. Application Data
(60) Provisional application No. 63/390,905, filed on Jul. 20, 2022.

(51) Int. Cl. H01Q 3/26; H01Q 3/28; H01Q 3/36; H04B 7/08; H04B 7/06

(52) U.S. Cl. CPC H01Q 3/2658; H01Q 3/28; H01Q 3/36; H04B 7/086; H04B 7/0617

(57) ABSTRACT

A serially fed front end (FE) network is provided. The serially fed FE network includes a first FE comprising a first FE input/output (IO), a second FE IO, and a first antenna IO coupled to a first antenna element of a plurality of antenna elements. The first FE IO of the first FE is electrically coupled to a particular beamformer (BF) IO of a BF. The serially fed FE network includes a second FE comprising a first FE IO coupled to the second FE IO of the first FE, a second FE IO of the second FE, and a second antenna IO coupled to a second antenna element of the plurality of antenna elements. The BF is communicatively coupled by the serially fed FE network to transmit to and/or receive signals from the first and second antenna elements of the plurality of antenna elements.

### RELATED APPLICATIONS

The present application claims the priority of U.S. Provisional Application No. 63/390,905, filed Jul. 20, 2022, entitled “SERIALLY FED SIGNAL DISTRIBUTION NETWORKS”, the disclosure of which is hereby expressly incorporated by reference in it's entirety.

### TECHNICAL FIELD

The present disclosure generally relates to wireless communications and, more specifically, a serially fed signal distribution network for wireless communication systems.

### BACKGROUND

Phased array antennas are used in a variety of wireless communication systems such as satellite and cellular communication systems. The phased array antennas can include a number of antenna elements arranged to behave as a larger directional antenna. Moreover, a phased array antenna can be used to increase an overall directivity and gain, steer the angle of array for greater gain and directivity, perform interference cancellation from one or more directions, determine the direction of arrival of received signals, and improve a signal to interference ratio, among other things. Advantageously, a phased array antenna can be configured to implement beamforming techniques to transmit and/or receive signals in a preferred direction without physically repositioning or reorientation.

It would be advantageous to configure phased array antennas having reduced routing complexity while maintaining a high ratio of the main lobe power to the side lobe power. Likewise, it would be advantageous to configure phased array antennas and associated circuitry having reduced weight, reduced size, lower manufacturing cost, and/or lower power requirements. Accordingly, embodiments of the present disclosure are directed to these and other improvements in phase array antenna systems or portions thereof.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a phased array antenna system is provided. The phased array antenna system includes: a beamformer (BF) comprising a plurality of BF radio frequency (RF) input/outputs (IOs); a plurality of antenna elements associated with a particular BF RFIO of the plurality of BF RFIOs; and a serially fed front end (FE) network. The serially fed FE network includes: a first FE comprising a first FE RFIO of the first FE electrically coupled to the particular BF RFIO, a second FE RFIO of the first FE, a first antenna IO coupled to a first antenna element of the plurality of antenna elements; and a second FE comprising a first FE RFIO of the second FE electrically coupled to the second FE RFIO of the first FE, a second FE RFIO of the second FE, and a second antenna IO coupled to a second antenna element of the plurality of antenna elements, wherein the first FE is configured to communicatively couple the particular BF RFIO of the plurality of BF RFIOs to the first antenna IO and the second FE RFIO of the first FE.

In accordance with another embodiment of the present disclosure, a phased array antenna system is provided. The phased array antenna system includes: a BF comprising a plurality of BF RFIOs; a plurality of antenna elements associated with a particular BF RFIO of the plurality of BF RFIOs; a first serially fed front end (FE) network associated with a first subset of the plurality of antenna elements; a second serially fed FE network associated with a second subset of the plurality of antenna elements, different from the first subset of the plurality of antenna elements; and distribution network configured to communicatively couple the particular BF IO of the plurality of BF IOs to the first serially fed FE network and the second serially fed FE network to transmit signals to and/or receive signals from the plurality of antenna elements. The first serially fed FE network includes: a first FE comprising a first FE IO of the first FE electrically coupled to the particular BF IO, a second FE IO of the first FE, and a first antenna IO coupled to a first antenna element of the plurality of antenna elements, wherein the first antenna element is included in the first subset of the plurality of antenna elements; and a second FE comprising a first FE IO of the second FE electrically coupled to the second FE IO of the first FE, a second FE IO of the second FE, and a second antenna IO coupled to a second antenna element of the plurality of antenna elements, wherein the second antenna element is included in the first subset of the plurality of antenna elements.

In accordance with another embodiment of the present disclosure, a serially fed FE network is provided. The serially fed FE network includes: a first FE including a first FE input/output (IO) electrically coupled to a particular beamformer (BF) IO of a BF, a first FE RFIO of the first FE, a second FE RFIO of the first FE, and a first antenna IO coupled to a first antenna element of a plurality of antenna elements; and a second FE including a first FE IO of the second FE electrically coupled to the second FE IO of the first FE, a second FE IO of the second FE, and a second antenna IO coupled to a second antenna element of the plurality of antenna elements, wherein the particular BF IO is communicatively coupled, by the serially fed FE network, to transmit signals to and/or receive signals from the first and second antenna elements of the plurality of antenna elements through the first FE IO of the first FE.

In accordance with another embodiment of the present disclosure, a beamformer is provided. The beamformer includes: an antenna port; first and second front-end (FE) Input/Outputs (IOs); and a distribution network configured to distribute a data beam signal received at the first FE IO to the antenna port and to the second FE IO in a transmit configuration and/or to combine a first received signal from the antenna port and an upstream signal from the second FE IO to form a combined received signal in a receive configuration, wherein the combined received signal is electrically coupled to the first FE IO.

In accordance with another embodiment of the present disclosure, a phased array antenna system is provided. The phased array antenna system includes: a beamformer (BF) module including: a BF configured to transmit a data beam in a transmit configuration from a BF input/output (IO) of the BF and/or receive a received data beam by the BF IO of the BF in a receive configuration, wherein the BF module comprises a carrier, and the BF is disposed on a first side of the carrier; and a distribution network configured to couple the BF IO of the BF to a BF module IO of the BF module; and a phased array module including a serially fed front end (FE) network comprising a plurality of FEs, each FE of the serially fed FE network associated with at least one antenna element of a plurality of antenna elements, wherein an initial FE of the serially fed FE network includes a coupling FE IO electrically coupled to a phased array module IO of the phased array module by a coupling trace and a pass-through FE IO of the initial FE electrically coupled to an FE IO of a second FE of the serially fed FE network, wherein the coupling FE IO is electrically coupled to the BF module IO of the BF module.

In accordance with another embodiment of the present disclosure, a phased array antenna system is provided. The phased array antenna system includes: a carrier comprising a plurality of layers; a plurality of antenna elements, wherein the plurality of antenna elements is arranged in an antenna element lattice; a first serially fed FE network comprising a first plurality of front end modules (FEs), wherein each FE of the first serially fed FE network is electrically coupled to at least one antenna element of the plurality of antenna elements; and at least one beamformer (BF) configured to transmit a first data beam to a first BF input/output (IO) and transmit a second data beam to a second BF IO and/or receive the first data beam at the first BF IO and receive the second data beam at the second BF IO, wherein: the first BF IO electrically couples to a first FE IO of an initial FE of the first serially fed FE network; and the second BF IO electrically couples to a second FE IO of the initial FE of the first serially fed FE network.

In accordance with another embodiment of the present disclosure, a phased array antenna system is provided. The phased array antenna system includes: a transceiver including a transceiver input/output (IO); a plurality of antenna elements associated with the transceiver IO; and a serially fed front end (FE) network including: an first FE comprising a first FE IO of the first FE electrically coupled to the transceiver IO, a second FE IO of the first FE, a first antenna IO coupled to a first antenna element of the plurality of antenna elements; and a second FE comprising a first FE IO of the second FE electrically coupled to the second FE IO of the second FE, a second FE IO of the second FE, and a second antenna IO coupled to a second antenna element of the plurality of antenna elements, wherein the first FE is configured to communicatively couple the transceiver IO to the first antenna IO and the second FE IO of the first FE.

In accordance with another embodiment of the present disclosure, a beamformer is provided. The beamformer includes: a transmit antenna port coupled to an antenna element; a receive antenna port coupled to the antenna element; a transmit input; a transmit output; a receive input; a receive output; and a distribution network configured to: distribute a transmit signal received at the transmit input to the transmit antenna port and to the transmit output; combine a first receive signal received at the receive antenna port from the antenna element and a second receive signal received at the receive input into a combined receive signal; and couple the combined receive signal to the receive output.

### BRIEF DESCRIPTION OF THE DRAWINGS

In order to describe the manner in which the various advantages and features of the disclosure can be obtained, a more particular description of the principles described above will be rendered by reference to specific embodiments thereof, which are illustrated in the appended drawings. Understanding that these drawings depict only example embodiments of the disclosure and are not to be considered to limit its scope, the principles herein are described and explained with additional specificity and detail through the use of the drawings in which:

FIG. 1A is a simplified diagram illustrating an example wireless communication system, in accordance with some examples of the present disclosure;

FIG. 1B is a simplified diagram illustrating an example of communication in a satellite communication system, in accordance with some examples of the present disclosure;

FIGS. 2A and 2B are isometric top and bottom views depicting an exemplary antenna apparatus, in accordance with some examples of the present disclosure;

FIG. 3A is an isometric exploded view depicting an exemplary antenna apparatus including the housing and the antenna stack assembly, in accordance with some examples of the present disclosure;

FIG. 3B is a cross-sectional view of an antenna stack assembly of an antenna apparatus, in accordance with some examples of the present disclosure;

FIG. 4A is a diagram illustrating an example illustration of a top view of an antenna lattice, in accordance with some examples of the present disclosure;

FIG. 4B is a diagram illustrating an example phased array antenna system, in accordance with some examples of the present disclosure;

FIG. 4C is a diagram illustrating example components of a beamformer chip and serially fed frontend (FE) networks that interface the beamformer chip with antenna elements, in accordance with some examples of the present disclosure;

FIG. 4D is a diagram illustrating example components that can be included in an individual FE of the serially fed front end (FE) networks described with respect to FIGS. 4B and 4C, in accordance with some examples of the present disclosure;

FIG. 4E through FIG. 4I are diagrams illustrating aditional example configurations for serially fed signal distribution networks, in accordance with some examples of the present disclosure;

FIG. 5A is a diagram illustrating a portion of a single data beam phased array antenna with front end modules (FEMs) connected by a distribution network from a centrally located beamformer (BF), in accordance with some examples of the present disclosure;

FIG. 5B is a diagram illustrating a portion of a single data beam phased array antenna with individual FEMs connected to a BF positioned at an edge of the phased array antenna by a distribution network, in accordance with some examples of the present disclosure;

FIGS. 5C and 5D are simplified cross-sectional diagrams of a printed circuit board (PCB) illustrating example connections between a BF, individual FEs, and corresponding antenna elements for the single beam phased array antennas of FIGS. 5A and 5B, in accordance with some examples of the present disclosure;

FIGS. 6A through 6C are diagrams illustrating different configurations of a portion of a single data beam phased array antenna with serially fed FE networks connected to a BF positioned at an edge of the phased array antenna, in accordance with some examples of the present disclosure;

FIGS. 6D and 6E are simplified cross-sectional diagrams of a PCB illustrating example connections between a BF, serially fed FE networks, and corresponding antenna elements for the single beam phased array antennas of FIGS. 6A through 6C, in accordance with some examples of the present disclosure;

FIGS. 6F and 6G are diagrams illustrating different configurations for routing of digital signals and power for a portion of a single data beam phased array antenna with serially fed FE networks, in accordance with some examples of the present disclosure;

FIGS. 7A and 7B are diagrams illustrating different configurations of a portion of a single data beam phased array antenna with serially fed FE networks connected to a BF included in an auxiliary BF component, in accordance with some examples of the present disclosure;

FIG. 8A is a diagram illustrating a portion of a two data beam phased array antenna with individual FEMs connected to a centrally located BF by a distribution network, in accordance with some examples of the present disclosure;

FIG. 8B is a simplified cross-sectional view of a portion of a PCB including routing traces on two routing layers for the two data beam phased array antenna of FIG. 8A, in accordance with some examples of the present disclosure;

FIG. 9A is a diagram illustrating a portion of a two data beam phased array antenna with serially fed FE networks connected to a BF at an edge of a phased array antenna by a distribution network, according to examples of the present disclosure;

FIG. 9B is a simplified cross-sectional view of a portion of a PCB including routing traces on two routing layers for the two data beam phased array antenna of FIG. 9A, in accordance with some examples of the present disclosure;

FIG. 10A is a diagram illustrating power and noise performance of routing with a distribution/combination configuration corresponding to the distribution/combination configuration of FIG. 5B, in accordance with some examples of the present disclosure;

FIG. 10B is a diagram illustrating power and noise performance of routing with H-distribution/combination configuration corresponding to the distribution/combination configuration of FIG. 6C, in accordance with some examples of the present disclosure;

FIG. 11 is a diagram illustrating an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Language such as “top”, “bottom”, “upper”, “lower”, “vertical”, “horizontal”, “lateral”, in the present disclosure is meant to provide orientation for the reader with reference to the drawings and is not intended to be the required orientation of the components or to impart orientation limitations into the claims.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

In some aspects, systems, apparatuses, processes (also referred to as methods), and computer-readable media (collectively referred to herein as “systems and techniques”) are described herein for beamforming in a phased array antenna.

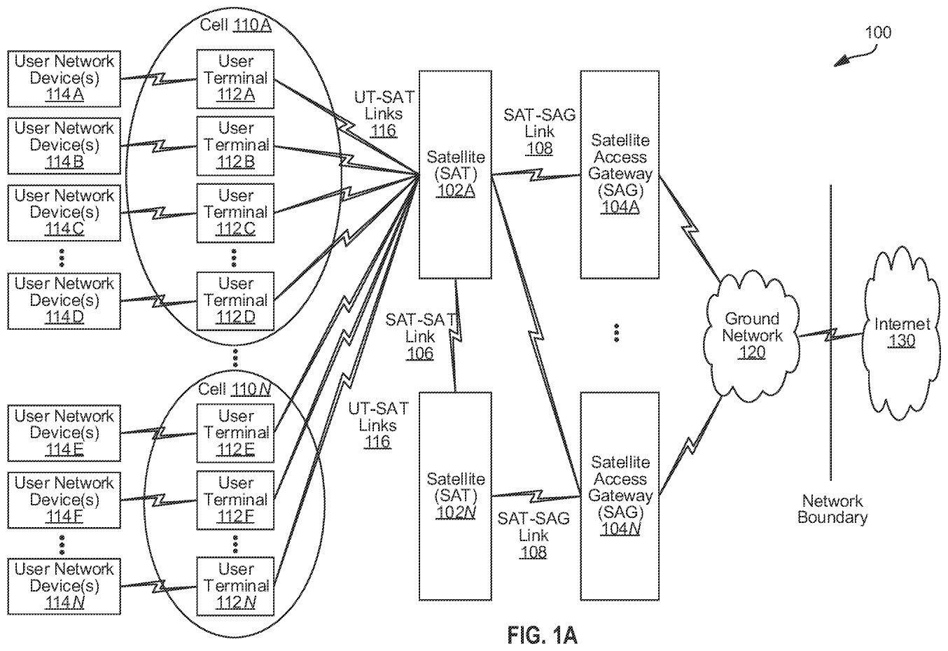

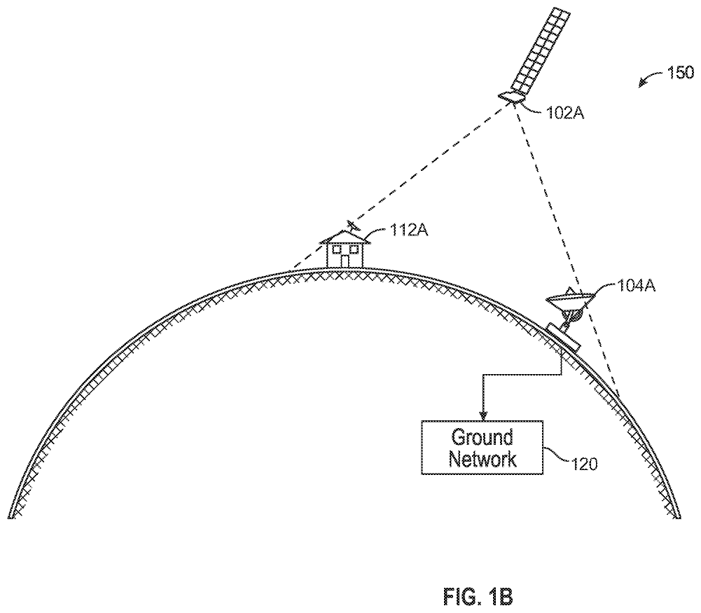

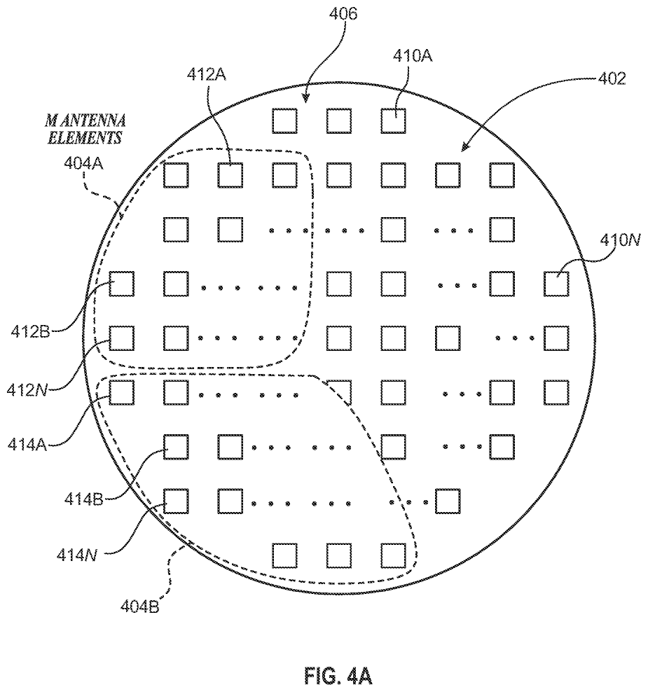

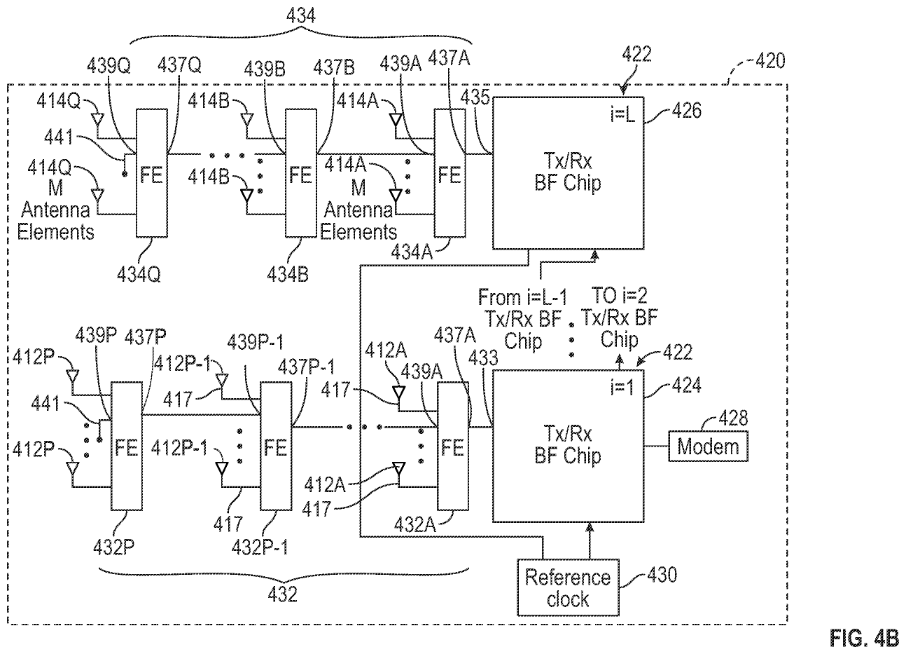

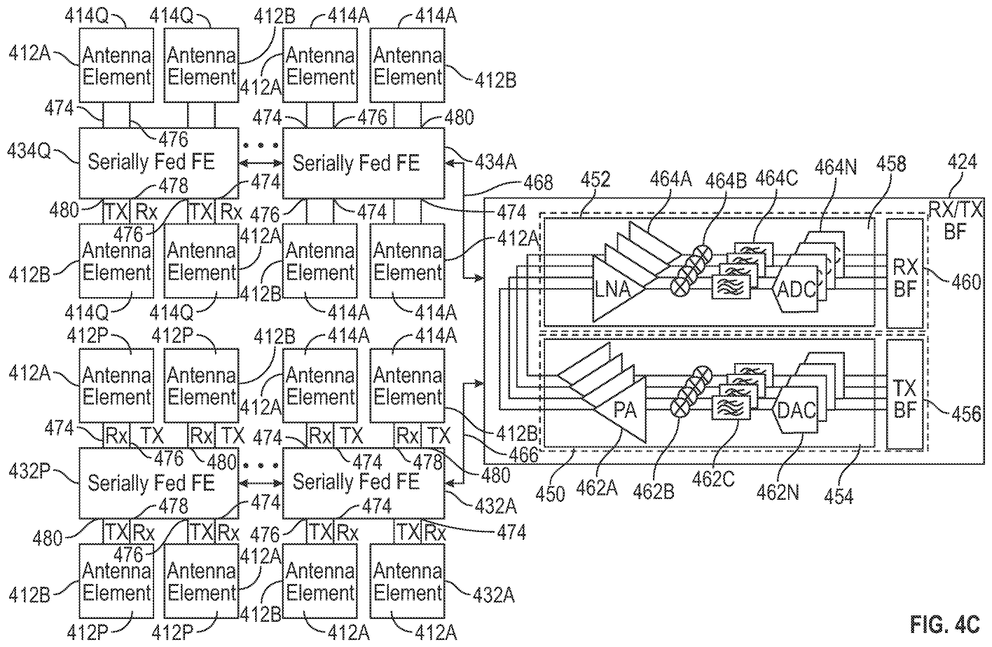

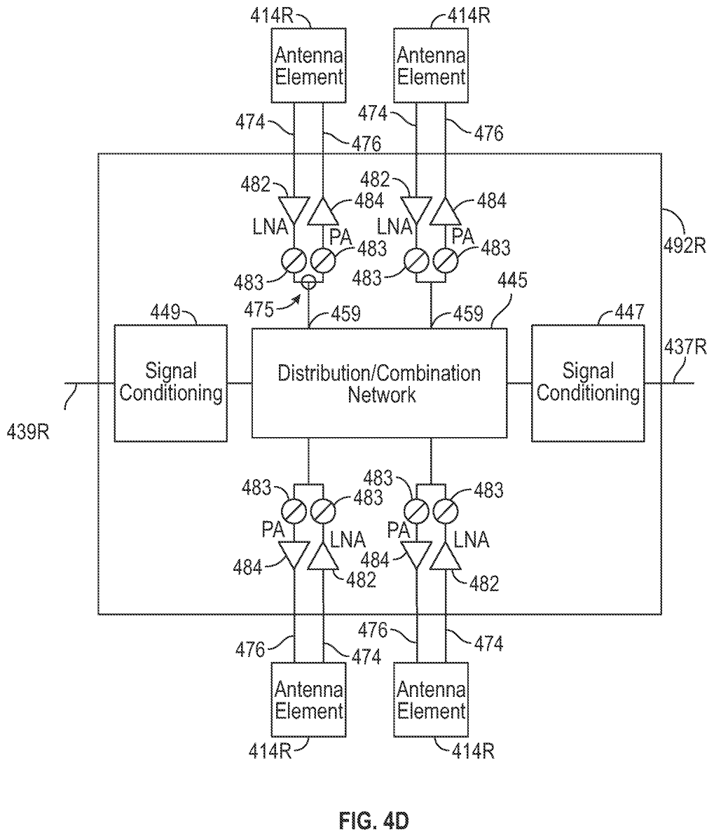

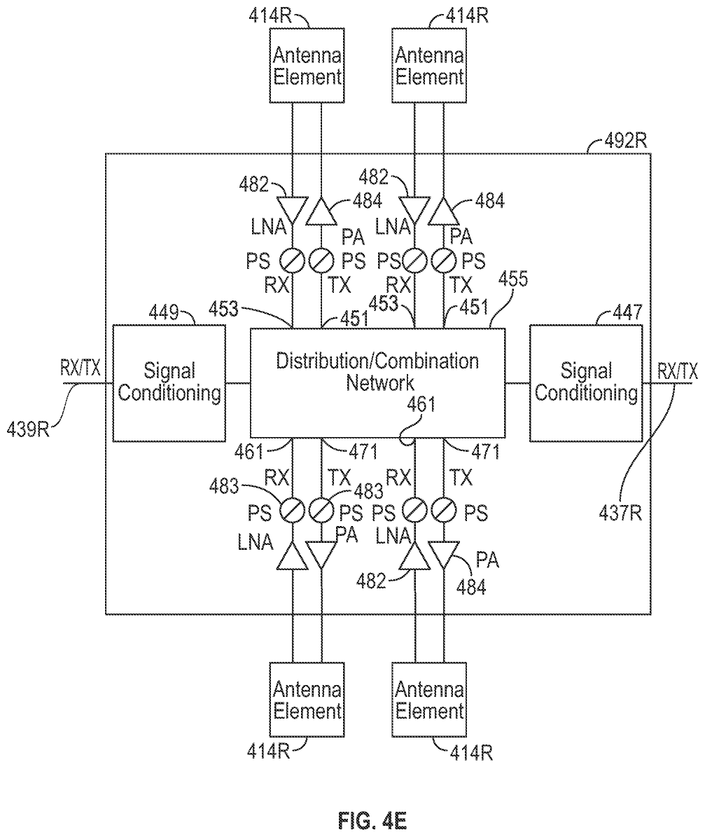

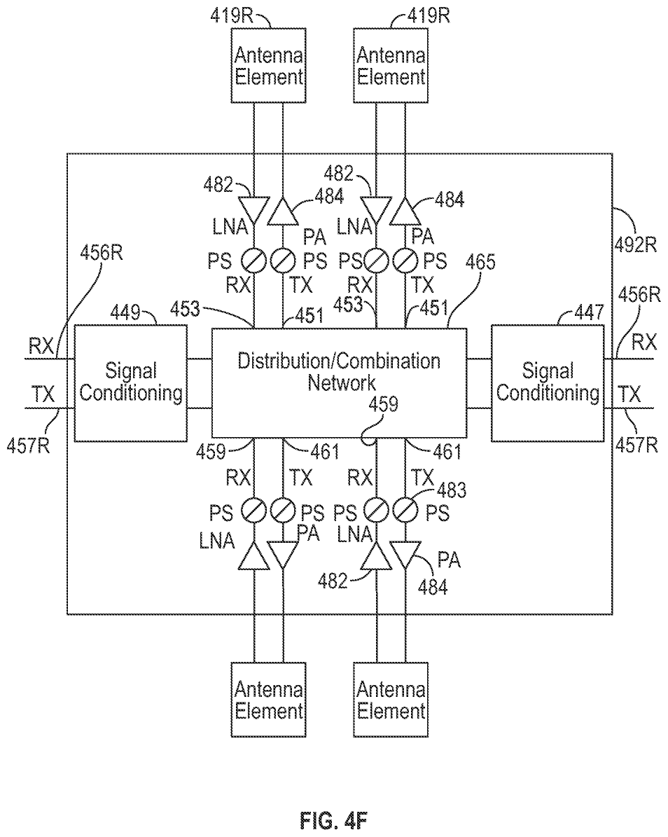

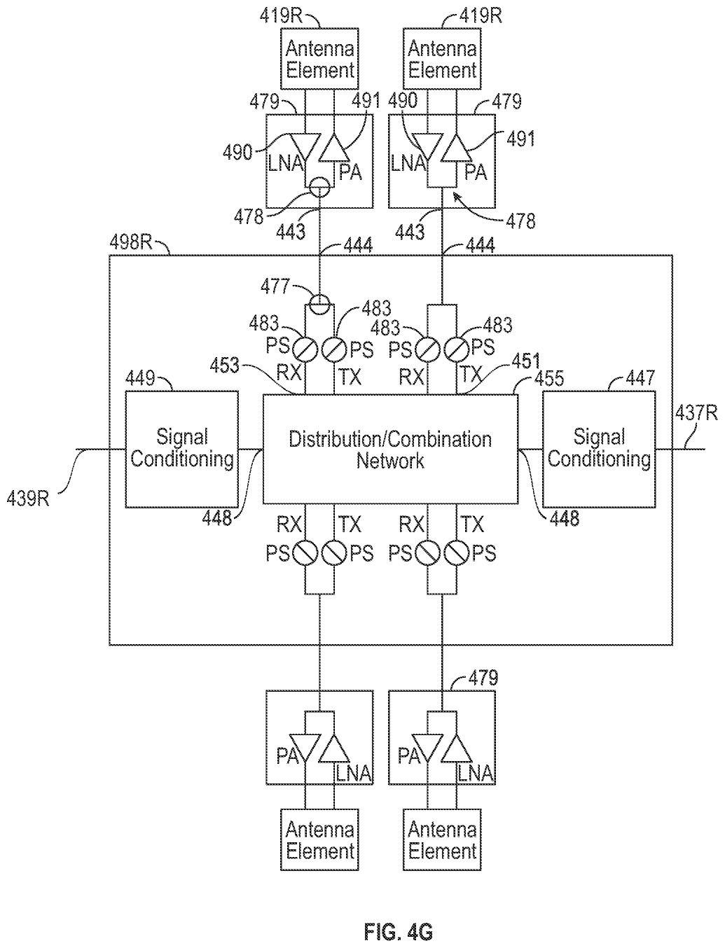

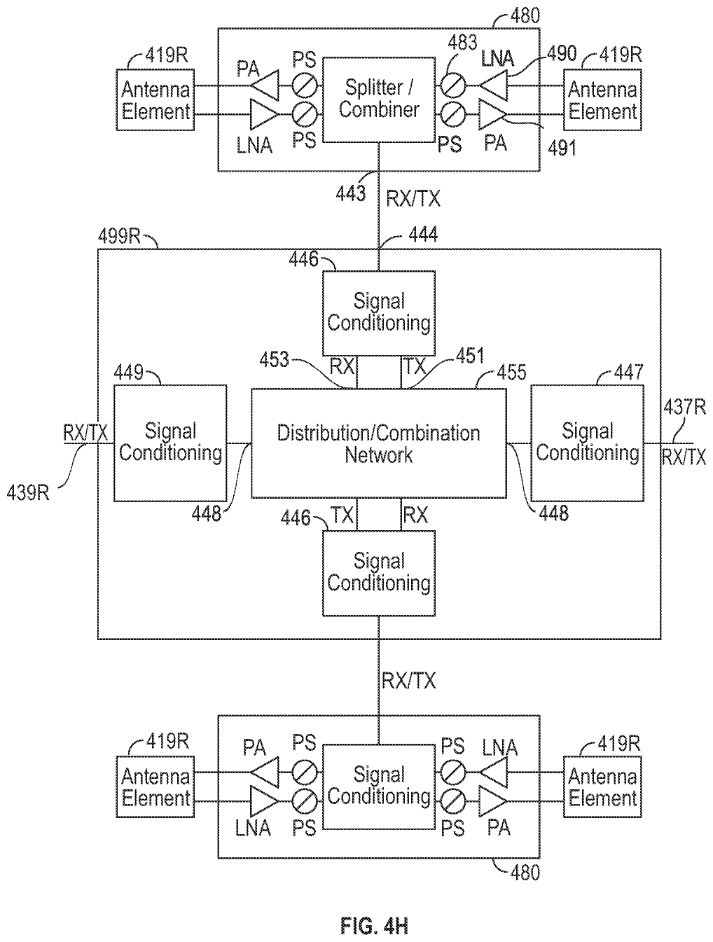

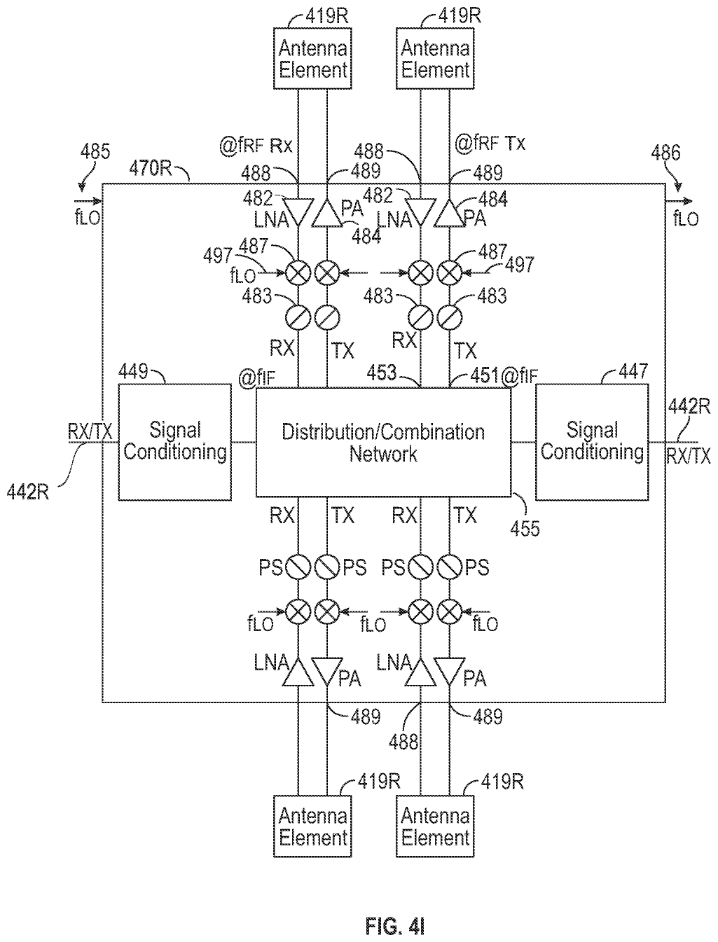

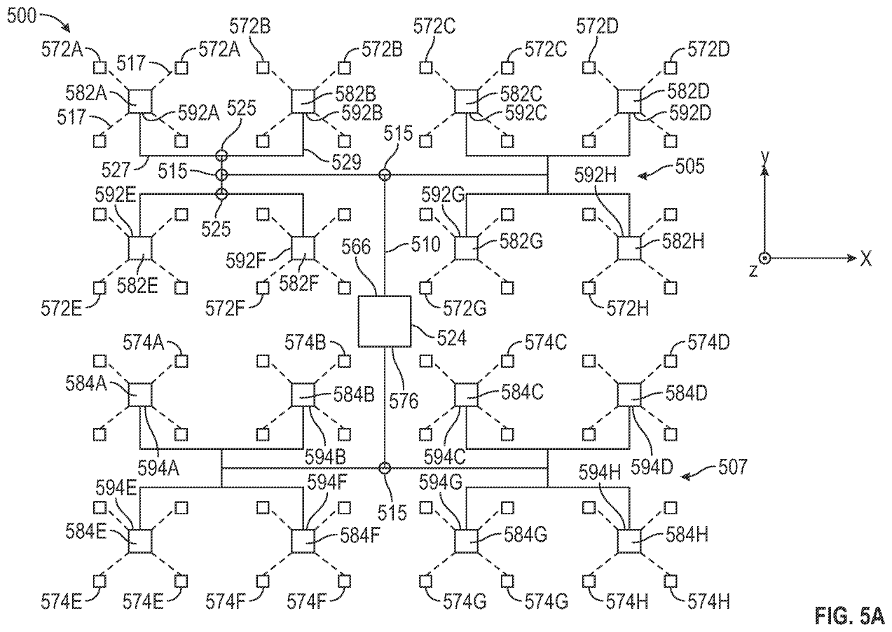

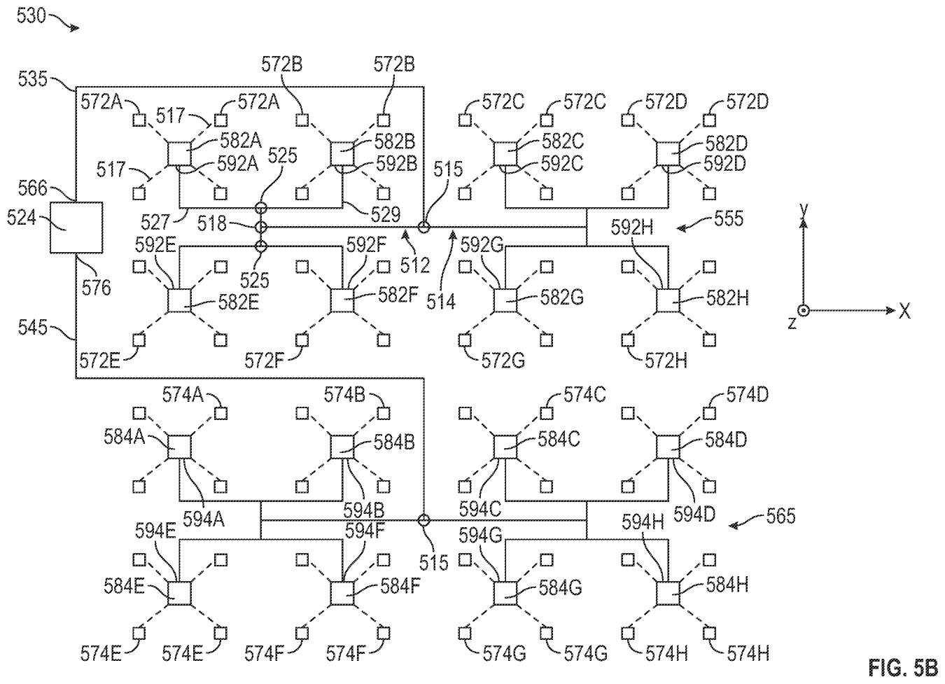

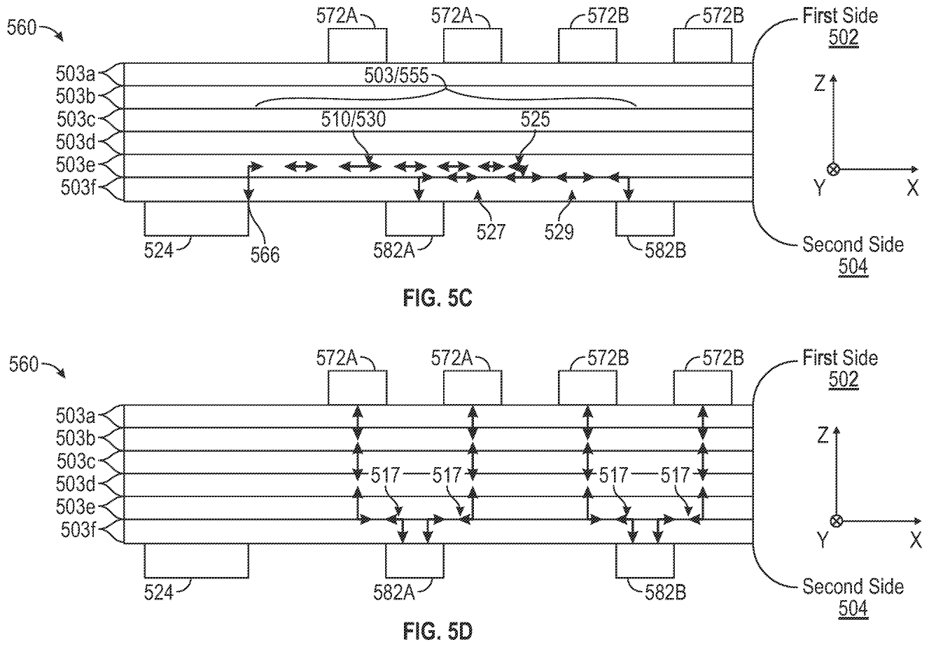

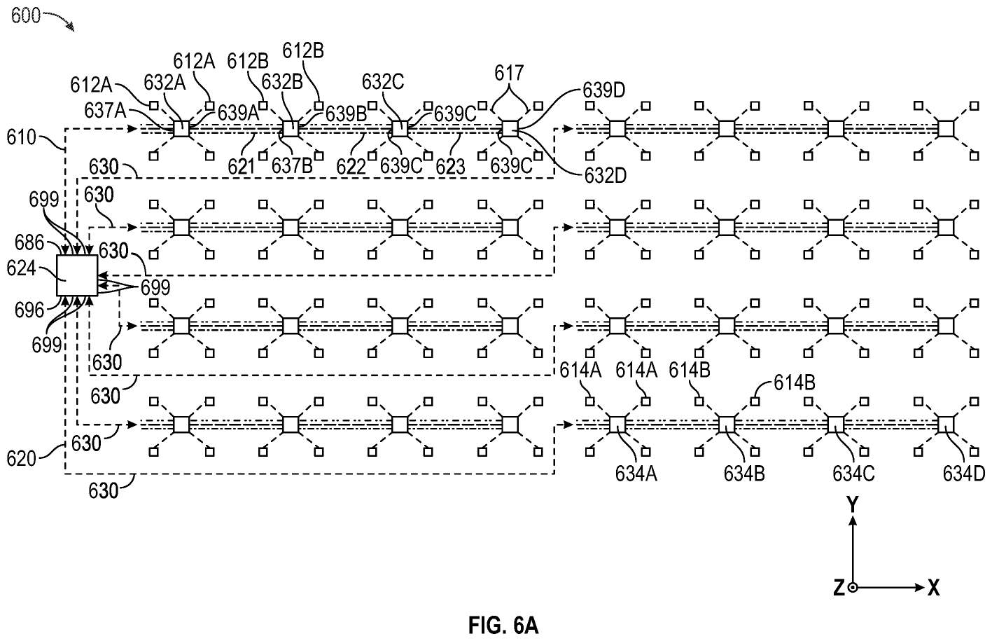

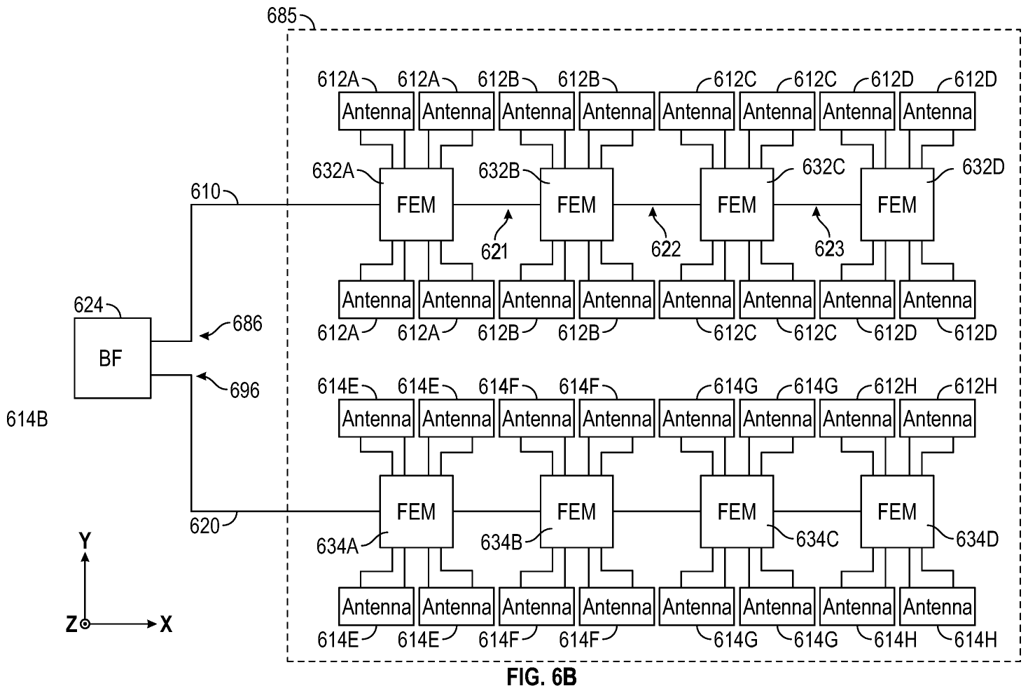

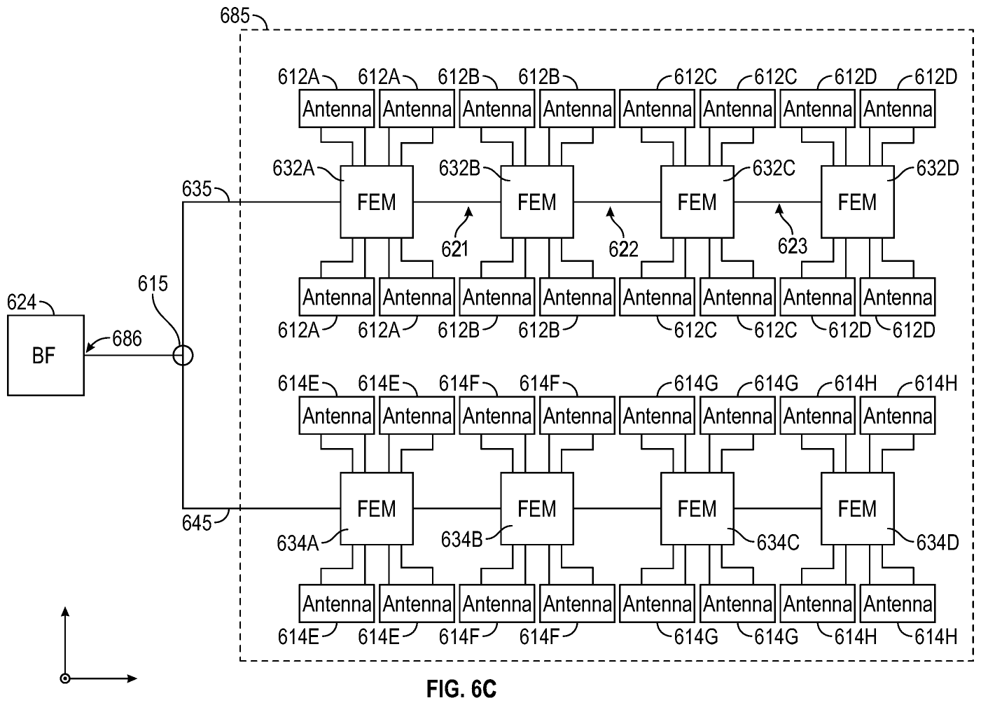

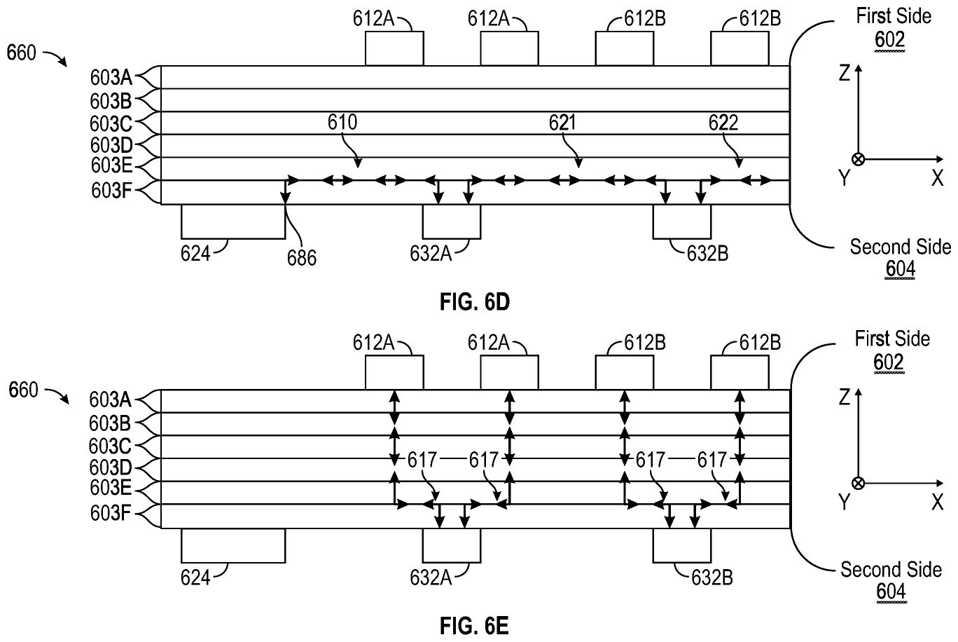

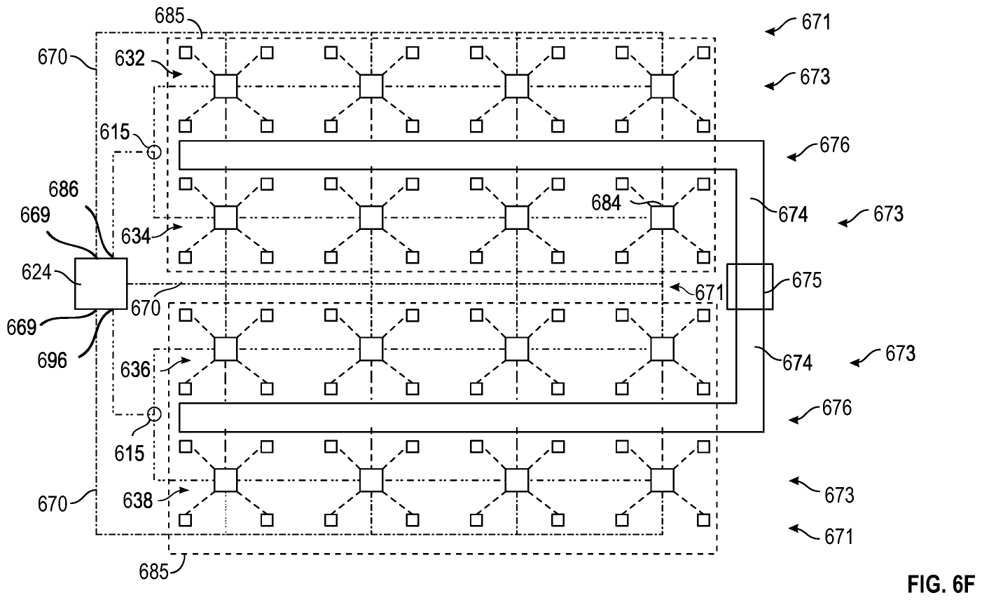

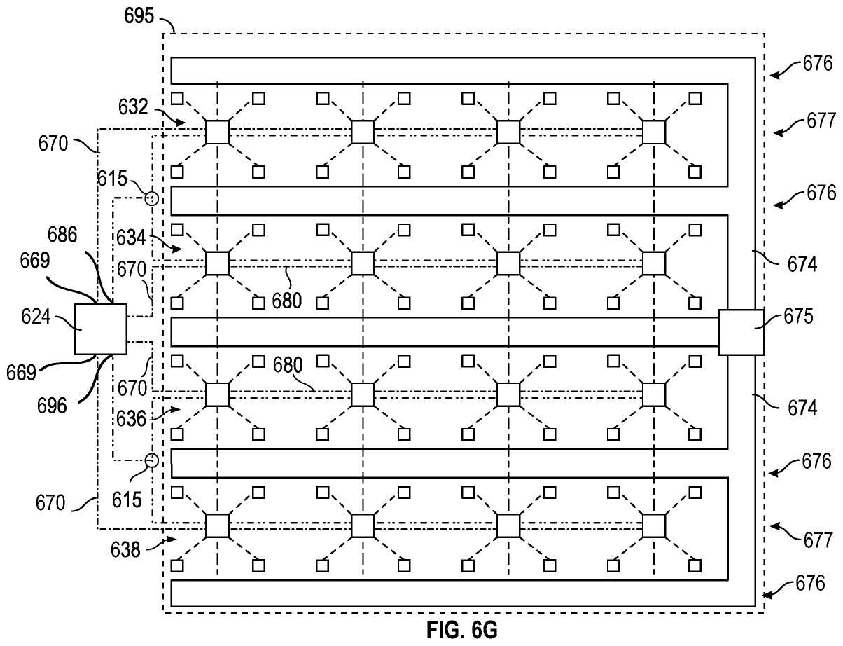

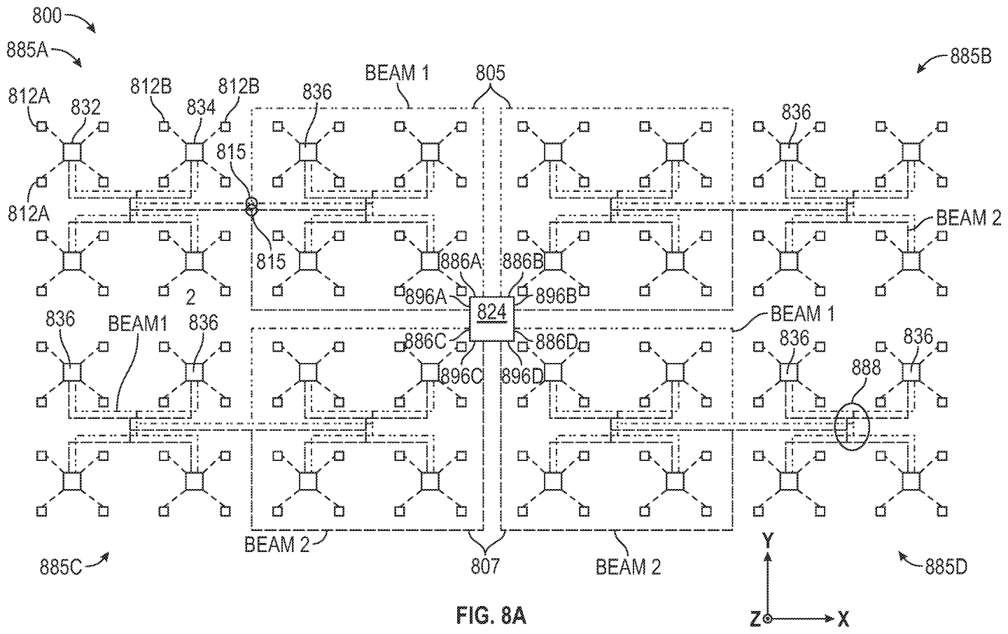

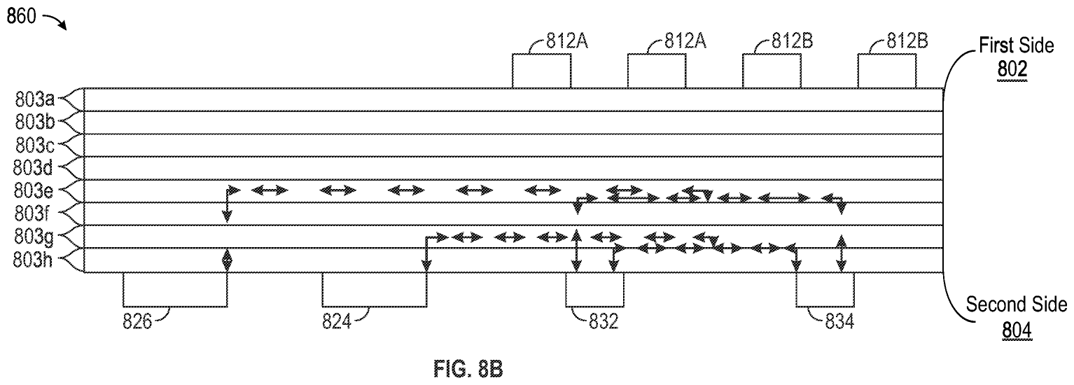

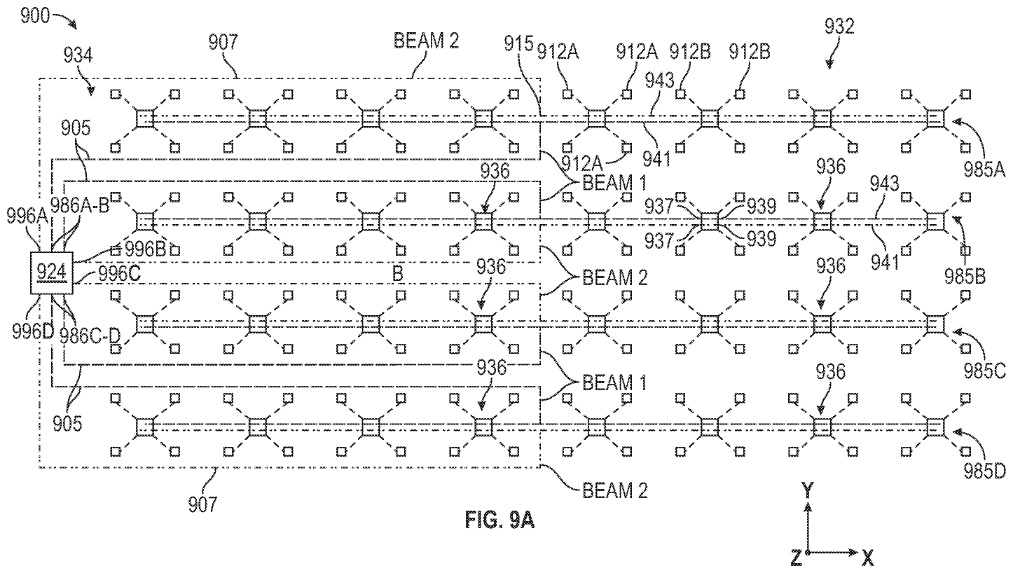

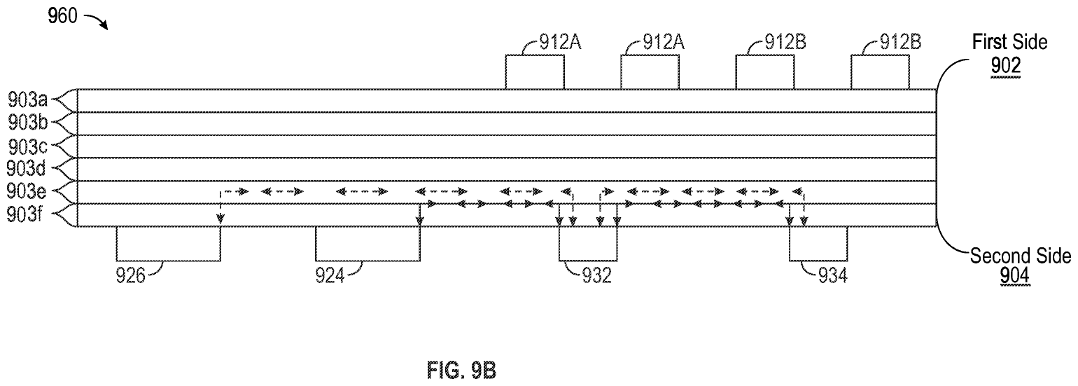

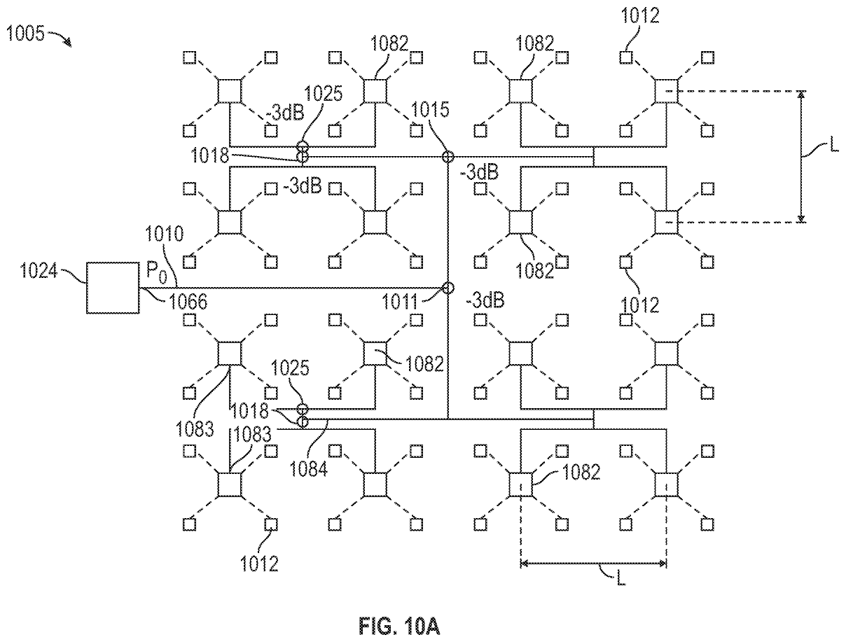

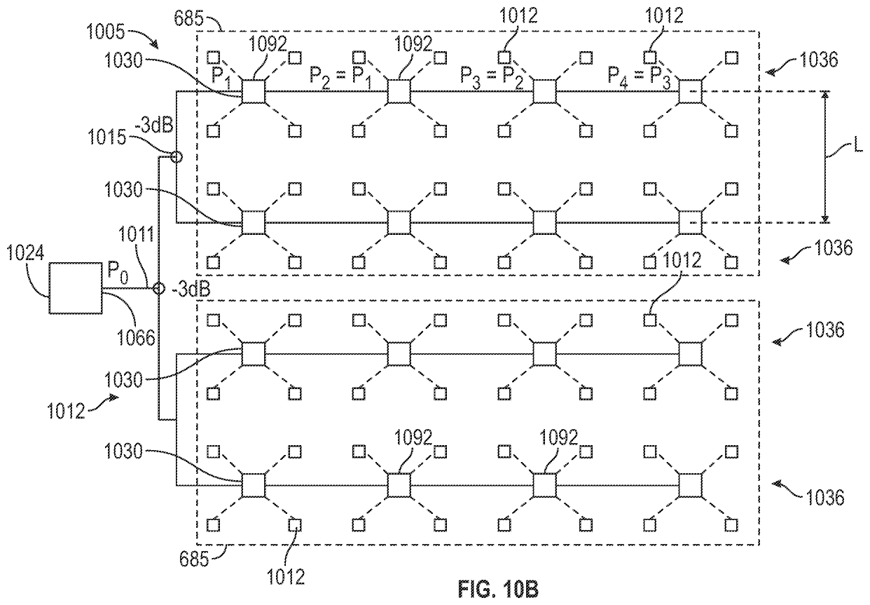

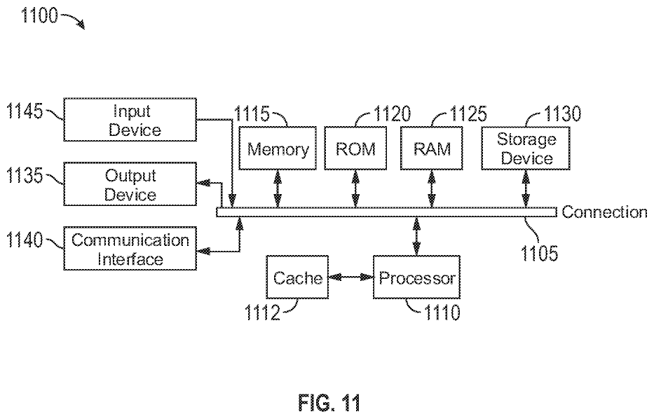

The disclosed systems and techniques will be described in the following disclosure as follows. The discussion begins with a description of example systems and technologies for wireless communications and example phased array antennas and circuits, as illustrated in FIGS. 1A through 4C. A description of example serially fed front end (FE) modules, as illustrated in FIG. 4D, will then follow. Descriptions of additional serially fed signal distribution network configurations, as illustrated in FIG. 4E through FIG. 4I, will then follow. A description of routing between beamformers (BFs) and FE modules (FEMs) using a distribution/combination network connected to individual FEs for a single beam phased array antenna, as illustrated in FIGS. 5A through 5D, will then follow. A description of routing between BFs and serially fed FE networks for a single beam phased array antenna, as illustrated in FIGS. 6A through 6G, will then follow. A description of routing between BFs and individual FE modules using a distribution/combination network connected to individual FEs for a multiple beam phased array antenna, as illustrated in FIGS. 8A through 8B, will then follow. A description of routing between BFs and serially fed FE networks for a multiple beam phased array antenna, as illustrated in FIGS. 9A and 9B, will then follow. A description of power and noise performance of routing to individual FEs compared with routing using serially fed FE networks, as illustrated in FIGS. 10A through 10B, will follow. The discussion concludes with a description of an example computing and architecture including example hardware components that can be implemented with phased array antennas and other electronic systems, as illustrated in FIG. 11. The disclosure now turns to FIG. 1A.

FIG. 1A is a block diagram illustrating an example wireless communication system 100, in accordance with some examples of the present disclosure. In this example, the wireless communication system 100 is a satellite-based communication system and includes one or more satellites (SATs) 102A-102N (collectively “102”), one or more satellite access gateways (SAGs) 104A-104N (collectively “104”), user terminals (UTs) 112A-112N (collectively “112”), user network devices 114A-114N (collectively “114”), and a ground network 120 in communication with a network 130, such as the Internet.

The SATs 102 can include orbital communications satellites capable of communicating with other wireless devices or networks (e.g., 104, 112, 114, 120, 130) via radio telecommunications signals. The SATs 102 can provide communication channels, such as radio frequency (RF) links (e.g., 106, 108, 116), between the SATs 102 and other wireless devices located at different locations on Earth and/or in orbit. In some examples, the SATs 102 can establish communication channels for Internet, radio, television, telephone, radio, military, and/or other applications.

The user terminals 112 can include any electronic devices and/or physical equipment that support RF communications to and from the SATs 102. The SAGs 104 can include gateways or earth stations that support RF communications to and from the SATs 102. The user terminals 112 and the SAGs 104 can include antennas for wirelessly communicating with the SATs 102. The user terminals 112 and the SAGs 104 can also include satellite modems for modulating and demodulating radio waves used to communicate with the SATs 102. In some examples, the user terminals 112 and/or the SAGs 104 can include one or more server computers, routers, ground receivers, earth stations, user equipment, antenna systems, communication nodes, base stations, access points, and/or any other suitable device or equipment. In some cases, the user terminals 112 and/or the SAGs 104 can perform phased-array beamforming and digital processing to support highly directive, steered antenna beams that track the SATs 102. Moreover, the user terminals 112 and/or the SAGs 104 can use one or more frequency bands to communicate with the SATs 102, such as the Ku and/or Ka frequency bands.

The user terminals 112 can be used to connect the user network devices 114 to the SATs 102 and ultimately the Internet 130. The SAGs 104 can be used to connect the ground network 120 and the Internet 130 to the SATs 102. For example, the SAGs 104 can relay communications from the ground network 120 and/or the Internet 130 to the SATs 102, and communications from the SATs 102 (e.g., communications originating from the user network devices 114, the user terminals 112, or the SATs 102) to the ground network 120 and/or the Internet 130.

The user network devices 114 can include any electronic devices with networking capabilities and/or any combination of electronic devices such as a computer network. For example, the user network devices 114 can include routers, network modems, switches, access points, smart phones, laptop computers, servers, tablet computers, set-top boxes, Internet-of-Things (IoT) devices, smart wearable devices (e.g., head-mounted displays (HMDs), smart watches, etc.), gaming consoles, smart televisions, media streaming devices, autonomous vehicles or devices, user networks, etc. The ground network 120 can include one or more networks and/or data centers. For example, the ground network 120 can include a public cloud, a private cloud, a hybrid cloud, an enterprise network, a service provider network, an on-premises network, and/or any other network.

In some cases, the SATs 102 can establish communication links between the SATs 102 and the user terminals 112. For example, SAT 102A can establish communication links 116 between the SAT 102A and the user terminals 112A-112D and/or 112E-112N. The communication links 116 can provide communication channels between the SAT 102A and the user terminals 112A-112D and/or 112E-112N. In some examples, the user terminals 112 can be interconnected (e.g., via wired and/or wireless connections) with the user network devices 114. Thus, the communication links between the SATs 102 and the user terminals 112 can enable communications between the user network devices 114 and the SATs 102. In some examples, each of the SATs 102A-N can serve user terminals 112 distributed across and/or located within one or more cells 110A-110N (collectively “110”). The cells 110 can represent geographic areas served and/or covered by the SATs 102. For example, each cell can represent an area corresponding to the satellite footprint of radio beams propagated by a SAT. In some cases, a SAT can cover a single cell. In other cases, a SAT can cover multiple cells. In some examples, a plurality of SATs 102 can be in operation simultaneously at any point in time (also referred to as a satellite constellation). Moreover, different SATs can serve different cells and sets of user terminals.

The SATs 102 can also establish communication links 106 with each other to support inter-satellite communications. Moreover, the SATs 102 can establish communication links 108 with the SAGs 104. In some cases, the communication links between the SATs 102 and the user terminals 112 and the communication links between the SATs 102 and the SAGs 104 can allow the SAGs 104 and the user terminals 112 to establish a communication channel between the user network devices 114, the ground network 120 and ultimately the Internet 130. For example, the user terminals 112A-D and/or 112E-N can connect the user network devices 114A-114D and/or 114E-114N to the SAT 102A through the communication links 116 between the SAT 102A and the user terminals 112A-D and/or 112E-N. The SAG 104A can connect the SAT 102A to the ground network 120, which can connect the SAGs 104A-N to the Internet 130. Thus, the communication links 108 and 116, the SAT 102A, the SAG 104A, the user terminals 112A-D and/or 112E-N and the ground network 120 can allow the user network devices 114A-114D and/or 114E-114N to connect to the Internet 130.

In some examples, a user can initiate an Internet connection and/or communication through a user network device from the user network devices 114. The user network device can have a network connection to a user terminal from the user terminals 112, which it can use to establish an uplink (UL) pathway to the Internet 130. The user terminal can wirelessly communicate with a particular SAT from the SATs 102, and the particular SAT can wirelessly communicate with a particular SAG from the SAGS 104. The particular SAG can be in communication (e.g., wired and/or wireless) with the ground network 120 and, by extension, the Internet 130. Thus, the particular SAG can enable the Internet connection and/or communication from the user network device to the ground network 120 and, by extension, the Internet 130.

In some cases, the particular SAT and SAG can be selected based on signal strength, line-of-sight, and the like. If a SAG is not immediately available to receive communications from the particular SAT, the particular SAG can be configured to communicate with another SAT. The second SAT can in turn continue the communication pathway to a particular SAG. Once data from the Internet 130 is obtained for the user network device, the communication pathway can be reversed using the same or different SAT and/or SAG as used in the UL pathway.

In some examples, the communication links (e.g., 106, 108, and 116) in the wireless communication system 100 can operate using orthogonal frequency division multiple access (OFDMA) via time domain and frequency domain multiplexing. OFDMA, also known as multicarrier modulation, transmits data over a bank of orthogonal subcarriers harmonically related by the fundamental carrier frequency. Moreover, in some cases, for computational efficiency, fast Fourier transforms (FFT) and inverse FFT can be used for modulation and demodulation.

While the wireless communication system 100 is shown to include certain elements and components, one of ordinary skill will appreciate that the wireless communication system 100 can include more or fewer elements and components than those shown in FIG. 1A. For example, the wireless communication system 100 can include, in some instances, networks, cellular towers, communication hops or pathways, network equipment, and/or other electronic devices that are not shown in FIG. 1A.

FIG. 1B is a diagram illustrating an example of an antenna and satellite communication system 100 in accordance with some examples of the present disclosure. As shown in FIG. 1B, an Earth-based UT 112A is installed at a location directly or indirectly on the Earth's surface such as a house, building, tower, vehicle, or another location where it is desired to obtain communication access via a network of satellites.

A communication path may be established between the UT 112A and SAT 102A. In the illustrated example, the SAT 102A, in turn, establishes a communication path with a SAG 104A. In another example, the SAT 102A may establish a communication path with another satellite prior to communication with SAG 104A. The SAG 104A may be physically connected via fiber optic, Ethernet, or another physical connection to a ground network 120. The ground network 120 may be any type of network, including the Internet. While one satellite is illustrated, communication may be with and between a constellation of satellites.

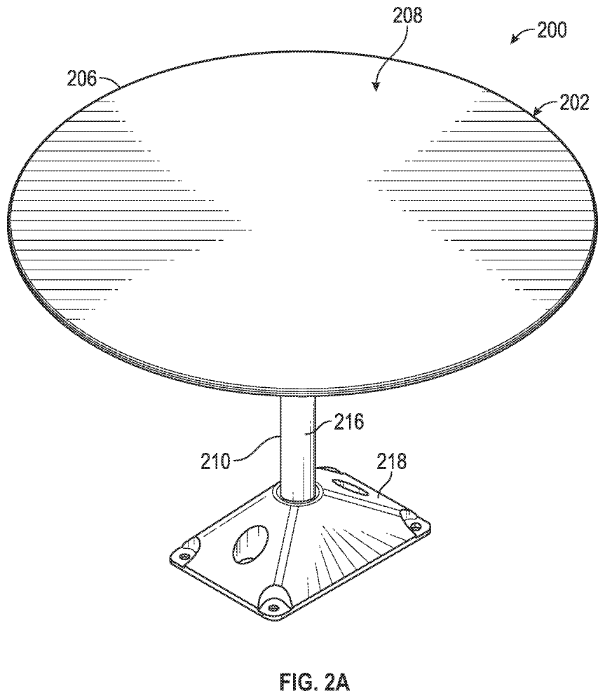

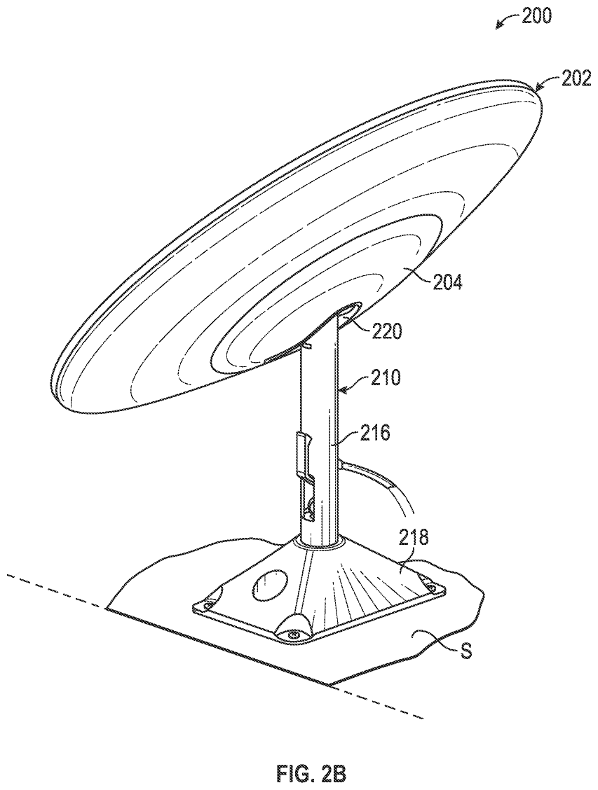

In some examples, the UT 112A may include an antenna system disposed in an antenna apparatus 200, for example, as illustrated in FIGS. 2A and 2B, designed for sending and/or receiving radio frequency signals to and/or from a satellite or a constellation of satellites. FIG. 2A illustrates an example top view of the antenna apparatus 200. The antenna apparatus 200 may include an antenna aperture 207 defining an area for transmitting and receiving signals, such as a phased array antenna system or another antenna system. The antenna apparatus 200 may include a top enclosure 208 that couples to a radome portion 206 to define a housing 202. The antenna apparatus 200 can also include a mounting system 210 having a leg 216 and a base 218.

FIG. 2B illustrates a perspective view of an underside of the antenna apparatus 200. As shown, the antenna apparatus 200 may include a lower enclosure 204 that couples to the radome portion 206 to define the housing 202. In the illustrated example, the mounting system 210 includes a leg 216 and a base 218. The base 218 may be securable to a surface S and configured to receive a bottom portion of the leg 216. A tilting mechanism 220 (details not shown) disposed within the lower enclosure 204 permits a degree of tilting to point the face of the radome portion 206 at a variety of angles for optimized communication and for rain and snow run-off.

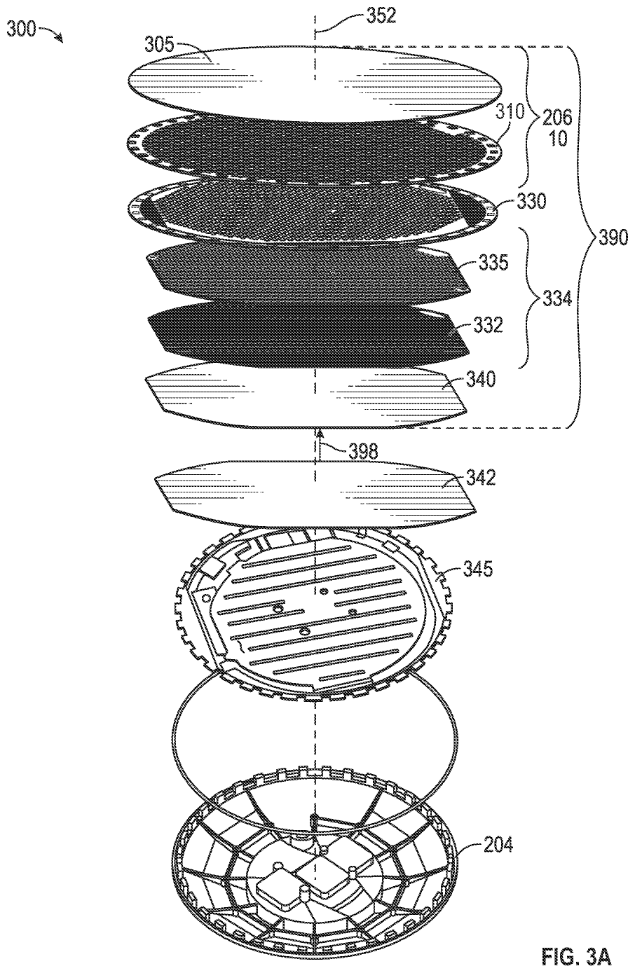

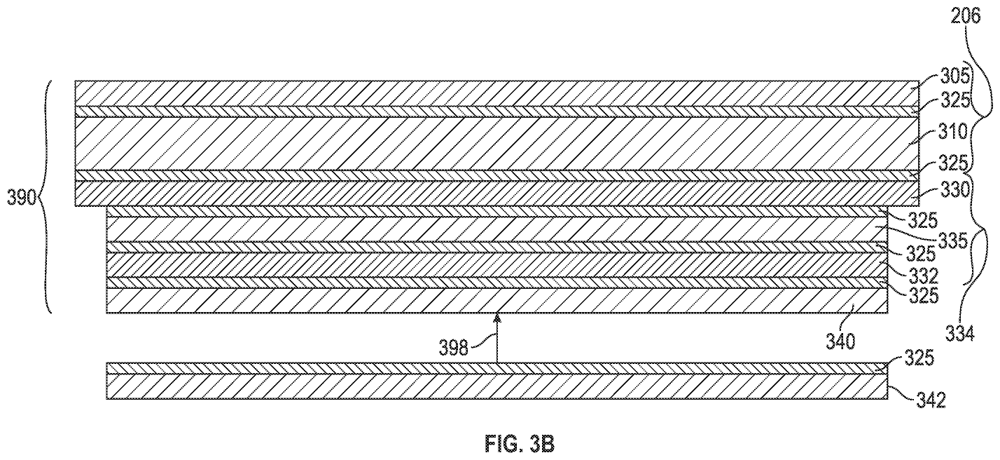

Referring to FIG. 3A, an antenna stack assembly 300 can include a plurality of antenna components, which can include a printed circuit board (PCB) assembly 342 configured to couple to other electrical components disposed within the housing assembly 202 (including lower enclosure 204 and radome assembly 206). In the illustrated example, the antenna stack assembly 300 includes a phased array antenna assembly including a plurality of individual antenna elements configured in an array. The components of the phased array antenna assembly 334 may be mechanically and electrically supported by the PCB assembly 342.

In the illustrated example of FIGS. 3A and 3B, the layers in the antenna stack assembly 300 layup include a radome assembly 206 (including radome 305 and radome spacer 310), a phased array patch antenna assembly 334 (including upper patch layer 330, lower patch layer 332, and antenna spacer 335 in between), a dielectric layer 340, and PCB assembly 342, as will be described in greater detail below. As seen in FIG. 3B, the layers may include adhesive coupling 325 between adjacent layers.

FIG. 4A is a diagram illustrating an example top view of an antenna lattice 406, in accordance with some examples of the present disclosure. The antenna lattice 406 can be part of a phased array antenna system, as further described below with respect to FIGS. 4B and 4C. The antenna lattice 406 can include antenna elements 410A-410N (collectively “410”), 412 A-412N (collectively “412”), 414A-414N (collectively “414”) configured to transmit and/or send radio frequency signals. In some examples, the antenna elements 410, 412, 414 can be coupled to (directly or indirectly) corresponding amplifiers, as further described below with respect to FIGS. 4B and 4C. The amplifiers can include, for example, low noise amplifiers (LNAs) in the receiving (Rx) direction or power amplifiers (PAs) in the transmitting (Tx) direction.

An antenna aperture 402 of the antenna lattice 406 can be an area through which power is radiated or received. A phased array antenna can synthesize a specified electric field (phase and amplitude) across the aperture 402. The antenna lattice 406 can define the antenna aperture 402 and can include the antenna elements 410, 412, 414 arranged in a particular configuration that is supported physically and/or electronically by a PCB.

In some cases, the antenna aperture 402 can be grouped into subsets of antenna elements 404A and 404B. Each subset of antenna elements 404A, 404B of antenna elements can include N number of antenna elements 412, 414, which can be associated with specific beamformer (BF) chips as shown in FIGS. 4B and 4C. The remaining antenna elements 410 in the antenna aperture 402 can be similarly associated with other BF chips (not shown).

FIG. 4B is a diagram illustrating an example phased array antenna system 420, in accordance with some examples. The phased array antenna system 420 can include an antenna lattice 406 including antenna elements 412, 414, and a BF lattice 422, which in this example includes BF chips 424, 426, for receiving signals from a modem 428 in the transmit (Tx) direction and sending signals to the modem 428 in the receive (Rx) direction. The antenna lattice 406 can be configured to transmit and/or receive a beam of radio frequency signals having a radiation pattern from or to the antenna aperture 402.

The BF chips 424, 426 in the BF lattice 422 can include an L number of BF chips. For example, BF chip 424 can include a first BF chip i (i=1, where i=1 to L), and so forth, and BF chip 426 can include the Lth BF chip (i=L) of the BF chips in the BF lattice 422. Each BF chip 424, 426 of the BF lattice 422 electrically couples with one or more serially fed signal distribution networks. For the purposes of illustration, the examples of FIG. 4B through 4D illustrate serially fed FE networks 432, 434. Additional example configurations including serially fed signal distribution networks are shown in FIG. 4E through FIG. 4I. For example, although the examples of FIG. 4B through 4D illustrate amplification by PAs/LNAs and phase shifting by phase shifters included within individual FEs of a serially fed FE network, other example serially fed signal distribution networks may exclude LNAs, PAs, and/or phase shifters without departing from the scope of the present disclosure.

For example, a BF radio frequency input/output (RFIO) 433 of BF chip 424 is electrically coupled to serially fed FE network 432. Similarly, BF RFIO 435 of BF chip 426 is electrically coupled to serially fed FE network 434. Although one BF RFIO 433, 435 is shown for each BF chip 424, 426, each BF can include multiple BF RFIOs which can each couple to one or more serially fed FE networks as described in more detail below with respect to FIGS. 4C, and 6A through 6D below. Although FIG. 4B illustrates a phased array antenna system including multiple BF chips 426, in some cases, a phased array antenna system including a single BF chip 426 (e.g., L=1) can be used with serial fed FE networks (e.g., 432, 434) without departing from the scope of the present disclosure.

The phased array antenna system 420 can include serially fed FE networks 432, 434. Each serially fed FE network 432, 434 can include multiple individual FEs, with serial signal distribution between individual FEs of the serially fed FE networks 432, 434. For example, as illustrated in FIG. 4B, serially fed FE network 432 can include P individual FEs and serially fed FE network 434 can include Q individual FEs. In some embodiments, the number of individual FEs in each serially fed FE network 432, 434 of a phased array antenna system 420 can be equal (e.g., P=Q). However, there is no requirement for each of the serially fed FE networks 432, 434 in a phased array antenna system to include equal numbers of individual FEs.

In some cases, additional digital signals can be communicated between one or more BFs of the BF lattice and individual FEs of the serially fed FE networks. For example, as illustrated in FIG. 6F and FIG. 6G and described in more detail below, digital signals (e.g., one or more clocks, control signals, or the like) can be provided to the serially fed FE networks 434 by the BF chips 424, 426 of the BF lattice 422. In some cases, the digital signals can be provided to each individual FE of the phased array antenna in parallel (e.g., as shown in FIG. 6F). In some cases, the digital signals can be provided to initial FEs (e.g., 432A, 434A) of the serially fed FE networks and serially distributed to the remaining individual FEs of the serially fed FE networks.

Referring to FIG. 4B, each of the individual FEs, 432A-432P of the serially fed FE network 432 can include an RF serial input 437A through 437P and RF serial output 439A through 439P. Similarly, each of the induvial FEs 434A-434Q of the serially fed FE network 434 can include an RF serial input 437A through 437Q and an RF serial output 439A through 439Q. Each individual FE 432A-432P, 434A-434Q of the serially fed FE networks 432, 434 can interface with M antenna elements through coupling antenna traces 417. The value for M can be any positive integer. As used herein, the RF serial inputs 437A through 437P of serially fed FE network 432 and RF serial inputs 437A through 437Q of serially fed FE network 434 are collectively referred to as RF serial inputs 437. As used herein, the RF serial outputs 439A through 439P of serially fed FE network 432 and RF serial outputs 439A through 439Q of serially fed FE network 434 are collectively referred to as RF serial outputs 439. The terms “input” and “output” used to describe RF serial inputs 437 and RF serial outputs 439 are consistent with the phased array antenna system 420 operating in a transmit (Tx) configuration. However, for the purposes of consistently identifying the RF serial input 437 and RF serial output 439 of each individual FE, the descriptors “input” for RF serial input 437 and “output” RF serial output 439 are used whether the phased array antenna system 420 (or a subset of antenna elements of the phased array antenna system 420, such as antenna elements 404A, 404B of FIG. 4A) is operating in a transmit (Tx) configuration or a receive (Rx) configuration. In some cases, such as when the serially fed FE networks are used for both receiving and transmitting configurations, the RF serial inputs 437 and RF serial outputs 439 can also be referred to as RF serial input/outputs (IOs) herein.

As illustrated in FIG. 4B, M antenna elements 412A are coupled to individual FE 432A, M antenna elements 412P-1 are coupled to individual FE 432P-1, and so on with M antenna elements 412P coupled to individual FE 432P at the end of the serially fed FE network 432. Similarly, M antenna elements 414A are coupled to individual FE 434A, M antenna elements 414B are coupled to individual FE 434B, and so on with M antenna elements 412Q coupled to individual FE 432Q at the end of the serially fed FE network 434. In some implementations, the individual FEs of the serially fed FE networks 432, 434 can include circuitry for performing analog processing of RF signals received from and/or transmitted to the antenna elements 412, 414. In some implementations, the BF chips 424, 426 in combination with the serially fed FE networks 432, 434 can collectively form a hybrid beamforming network (e.g., including both analog and digital beamforming components). A hybrid beamforming network may also be referred to as a hybrid beamformer, HBF, or hybrid analog/digital beamformer herein. In some cases, the BFs and FEs can form an analog beamforming network without departing from the scope of the present disclosure. In some implementations, the BF chips illustrated in FIG. 4B can be replaced with any RF transceiver. For example, in the case of a phased array antenna system including a single serially fed FE network (e.g., one of serially fed FE networks 432, 434), a single transceiver can be used in place of a BF chip and beamforming functionality can be performed by the individual FEs of the serially fed FE network. Although multiple BF chips 424, 426 are illustrated in FIG. 4B, a phased array antenna system including a single BF chip can be used with a serially fed FE network without departing from the scope of the present disclosure.

Each serially fed FE network 432, 434 can include an initial FE 432A, 434A, that interfaces with the BF chips 424, 426 and a first set of M antenna elements 412A, 414A. As used herein, references to an initial FE 432A, 434A means that the RF serial input 437A of the initial FE 432A, 434A is communicatively coupled to a BF IO and/or a distribution/combination network coupled to a corresponding BF IO. For example, an RF serial input 437A of initial FE 432A can communicatively couple with BF RFIO 433 of BF chip 424 and RF serial input 437A of the initial FE 434A can communicatively couple with BF RFIO 435 of BF chip 426. As illustrated, the RF serial output 439A of initial FE 432A of the serially fed FE network 432 can subsequently be coupled to the RF serial input 437B of FE 432B, and so on for each subsequent individual FE 432C through 432P to form serially fed FE network 432. Similarly, the RF serial output 439A of initial FE 434A of the serially fed FE network 434 can subsequently be coupled to the RF serial input 437B of FE 434B, and so on for each subsequent individual FE 434C through 434Q to form serially fed FE network 434.

The serially fed FE networks (e.g., serially fed FE networks 432, 434) can be configured to provide the same gain between a BF RFIO (e.g., BF RFIO 433 of BF chip 424, BF RFIO 435 of BF chip 426) and each of the antenna elements (e.g., antenna elements 412, 414) coupled to the BF RFIO through the serially fed FE network. For example, a gain between the BF RFIO 433 and each antenna element 412A coupled to individual FE 432A and a gain between BF RFIO 433 and each antenna element 412P-1 coupled to individual FE 432P-1 can be equal to a common gain. In addition, a gain between the BF RFIO 433 and each antenna element 412P coupled to individual FE 432P can also be equal the common gain. In some cases, the gain between the BF RFIO 433 and different antenna elements of the antenna elements 412 coupled to the individual FEs of serially fed FE network 432 can be different. For example, gains between the BF RFIO 433 and antenna elements 412 can be configured to provide a desired excitation taper (e.g., an amplitude taper)

For the last individual FE 432P in the serially fed FE network 432 and last individual FE 434Q in serially fed FE network 434 there is no individual FE to couple to the RF serial output 439. As illustrated, the RF output of each last individual FE 432P, 434Q can be terminated with a matched termination 441. In some embodiments, the RF output of each last individual FE 432P, 434Q, and/or any associated signal conditioning components (see FIG. 4D) can be disabled. In some cases, disabling the RF output of a last individual FE 432P, 434Q can alleviate a requirement to terminate the RF output with an output termination.

In some implementations, each individual FE module 432A-432P, 434A-434Q of the serially fed FE networks 432, 434 can include RF or millimeter wave (mmWave) frontend integrated circuits, modules, devices, and/or any other type of frontend package and/or component(s). In some cases, the individual FEs 432A-432P, 434A-434Q of the serially fed FE networks 432, 434 can include multiple-input, multiple-output FEs interfacing with multiple antenna elements and one or more BF chips. Illustrative example configurations for individual FEs are described in more detail below with respect to FIG. 4D through FIG. 4I.

Each BF chip of the BF lattice 422 can include an integrated circuit (IC) chip or an IC chip package including a plurality of pins. In some cases, a first subset of the plurality of pins can be configured to communicate signals with a respective, electrically coupled BF chip(s) (e.g., if the BF chips are digital beamformers (DBFs)) in a daisy chain configuration), and/or modem 428 in the case of BF chip 424. A second subset of the plurality of pins can be configured to transmit/receive signals with M antenna elements, and a third subset of the plurality of pins can be configured to receive a signal from a reference clock 430. The BF chips in the BF lattice 422 may also be referred to as transmit/receive (Tx/Rx) BF chips, Tx/Rx chips, transceivers, BF transceivers, and/or the like. As described above, the BF chips may be configured for Rx communication, Tx communication, or both. Although the illustrated example of FIG. 4B shows components such as an ADC normally associated with DBFs, the BF chips 424 can be analog beamformers, DBFs, and in some cases simple transceivers without departing from the scope of the present disclosure.

In some cases, the BF chips 424, 426 in the BF lattice 422 can include amplifiers, phase shifters, mixers, filters, up samplers, down samplers, variable gain amplifiers (VGAs), and/or other electrical components. In the receiving direction (Rx), a beamformer function can include delaying signals arriving from each antenna element so the signals arrive to a combining network at the same time. In the transmitting direction (Tx), the beamformer function can include delaying the signal sent to each antenna element such that the signals arrive at the target location at the same time (or substantially the same time). This delay can be accomplished by using “true time delay” or a phase shift at a specific frequency. In some examples, each of the BF chips 424, 426 can be configured to operate in half duplex mode, where the BF chips 424, 426 switch between receive and transmit modes as opposed to full duplex mode where RF signals/waveforms can be received and transmitted simultaneously. In other examples, each of the BF chips 424, 426 can be configured to operate in full duplex mode, where RF signals/waveforms can be received and transmitted simultaneously.

Each individual FE within the serially fed FE networks 432, 434 electrically couples to a group of respective M number of antenna elements. In turn, the individual FEs 432A-432P, 434A-434Q of the serially fed FE networks 432, 434 collectively couple a BF RFIO 433, 435 from each BF to a respective M number of elements multiplied by the number of FEs in the corresponding serially fed FE network 432, 434. For example, BF RFIO 433 of BF 424 can electrically couple to M*P antenna elements 412 through serially fed FE network 432. Similarly, BF RFIO 435 of BF 426 can electrically couple to M*Q number of antenna elements 414 through serially fed FE network 434.

The serially fed FE networks 432, 434 can include various components, such as RF ports, phase shifters, amplifiers (e.g., PAs, LNAs, VGAs, etc.), signal conditioning components, and the like. In some examples, in Rx mode, the serially fed FE networks 432, 434 can provide a gain to RF contents of each Rx input (e.g., input from antenna traces 417, such as antenna Rx ports 474 of FIGS. 4C and 4D and/or Rx inputs received at RF serial outputs 439 in Rx mode), and low noise power to suppress the signal-to-noise ratio impacts of noise contributors downstream in the Rx chain/path. In some cases, the serially fed FE networks 432, 434 can be configured to provide an equal gain between each individual antenna element of the antenna elements 412, 414 and a corresponding BF RFIO 433, 435. For example, a signal received at antenna element 414Q and a signal received at antenna element 414A can have equal gain along the path to BF RFIO 435.

Moreover, in Tx mode, the serially fed FE networks 432, 434 can provide gain to each Tx path (e.g., output to traces 417, antenna Tx ports 476 of FIGS. 4C and 4D and/or Tx outputs transmitted from RF serial outputs 439 in Tx mode) and drive RF power into a corresponding antenna element 412, 414. In some cases, the serially fed FE networks 432, 434 can be configured to provide an equal gain between each BF RFIO 466, 468 and each corresponding individual antenna element of the antenna elements 412, 414. For example, a signal transmitted from BF RFIO 433 can have an equal gain at antenna element 412A and antenna element 412P-1. In some cases, the serially fed FE networks 432, 434 can be configured to provide gains between the BF RFIOs 433, 435 and different individual antenna elements of the antenna elements 412, 414. For example, the gain to different individual antenna elements can be set to provide an excitation taper (e.g., an amplitude taper) to the antenna elements 412, 414.

In the illustrated example of FIG. 4B, the BF chips in the BF lattice 422 are electrically coupled to each other in a daisy chain arrangement. In some cases, such as where the BF chips are analog BF chips, digital communication between BFs by a daisy chain arrangement can be excluded. The BF chips are also coupled to serially fed FE networks 432, 434 that include analog beamforming functionality in a hybrid beamforming network. The serially fed FE networks 432, 434 can be used in many different configurations without departing from the scope of the present disclosure. For example, the serially fed FE networks 432 can be used with analog BFs, digital BFs, transceivers, receivers, and/or transmitters. As another example, in some cases, aspects of the disclosure can be implemented using BFs and/or FEs having different arrangement(s) and/or electrical coupling structure(s).

FIG. 4C is a diagram illustrating example components of BF chip 424 communicatively coupling with two serially fed FE networks 432, 434 that each interface with the BF chip 424 through separate BF RFIOs 466, 468, respectively. In the illustrated configuration, BF RFIO 466 of the BF 424 is communicatively coupled to serially fed FE network 432 and each individual FE 432A-432P of the serially fed FE network 432 is communicatively coupled to M antenna elements 412A through 412P, respectively. As a result, the BF RFIO 466 can be communicatively coupled to M*P antenna elements 412A through 412P while being connected directly to the initial FE 432A of serially fed FE network 432. As a result, the BF RFIO 466 can be communicatively coupled to M*P antenna elements 412A through 412P while being directly connected to the initial FE 432A of serially fed FE network 432. As illustrated in FIG. 4C, BF RFIO 468 of the BF 424 is communicatively coupled to serially fed FE network 434 and each individual FE 434A-434Q of the serially fed FE network 434 is communicatively coupled to M antenna elements 414A through 414Q, respectively. As a result, the BF RFIO 468 can be communicatively coupled to M*P antenna elements 412A through 412P while only being directly connected to the initial FE 434A of serially fed FE network 434. Each BF in the BF lattice 422 can similarly include multiple BF RFIOs each communicatively coupled to one or more serially fed FE networks, thereby allowing the number of antenna elements 412, 414 in the phased array antenna system 420 to be scaled. In some embodiments, one or more BF RFIOs 466, 468 can also be distributed (e.g., through a distribution network, distributor/combiners, or the like) to multiple serially fed FE networks as a means of scaling the phased array antenna system 420 (see FIGS. 6C, 7A, and 10B)

In the illustrated example of FIG. 4C, the BF chip 424 can include a transmit section 450 and a receive section 452, and the serially fed FE networks 432, 434 can each include an RF serial input 437 and an RF serial output 439. Although described as “input” and “output” ports, in the illustrated embodiment the RF serial input 437 and RF serial output 439 can each be used for bidirectional communication with the BF 424 and/or the antenna elements 412. As illustrated, each individual FE 432A through 432P includes M antenna Rx ports 474 and M antenna Tx ports 476, with an antenna Rx port 474 and an antenna Tx port 476 provided for each of the M connected antenna elements 412. Similarly, each individual FE 434A through 434Q also includes M antenna Rx ports 474 and antenna Tx ports 476, with an antenna Tx port 476 and an antenna Rx port 474 provided for each of the M connected antenna elements 414. In the illustrated example, each individual FE 432A through 432P, 434A through 434Q is coupled to four antenna elements 412, 414 (e.g., M=4). Different values for M can be chosen (e.g., M=2, M=3, M=8, or any other value) without departing from the scope of the present disclosure.

The transmit section 450 of BF 424 can include a transmit beamformer (Tx BF) 456 and one or more Tx RF sections 454. The Tx BF 456 can include a number of components (e.g., digital and/or analog) such as, for example and without limitation, a VGA, a time delay filter, a filter, a gain control, one or more phase shifters, one or more up samplers, one or more IQ gain and phase compensators, and the like. Each Tx RF section 454 can also include a number of components (e.g., digital and/or analog). In this example, each Tx RF section 454 includes a power amplifier (PA) 462A, a mixer 462B, a filter 462C such as a low pass filter, and a digital-to-analog converter (DAC) 464N. The one or more Tx RF sections 454 can be configured to ready the time delay and phase encoded digital signals for transmission. In some examples, the one or more Tx RF sections 454 can include a Tx RF section for each BF RFIO 466, 468 to each serially fed FE network 432, 434. Although the Tx RF section 454 is illustrated in a DBF configuration (e.g., including DACs 462N), an analog BF can be used without departing from the scope of the present disclosure.

The receive section 452 can include a receive beamformer (Rx BF) 460 and one or more Rx RF sections 458. The Rx BF 460 can include a number of components such as, for example and without limitation, a VGA, a time delay filter, a filter, an adder, one or more phase shifters, one or more down samplers, one or more filters, one or more IQ compensators, one or more direct current offset compensators (DCOCs), and the like. Each Rx RF section 458 can also include a number of components. In the example of FIG. 4C, each Rx RF section 458 includes a low noise amplifier (LNA) 464A, a mixer 464B, a filter 464C such as a low pass filter, and an analog-to-digital converter (ADC) 464N. In some examples, the one or more Rx RF sections 458 can include an Rx RF section for each BF RFIO 466, 468 to each serially fed FE network 432, 434, respectively. Although the receive section 452 is illustrated as BF ADCs 464N, an analog RX BF can be used without departing from the scope of the present disclosure.

The serially fed FE networks 432, 434 can include one or more Rx components (see components 482, 483 of FIG. 4D) for processing Rx signals from the antenna elements 412, 414 and one or more Tx components (see components 483, 484 of FIG. 4D) for processing Tx signals for each of the antenna elements 412, 414. As an illustrative and non-limiting example, one or more Rx components for processing Rx signals can include LNAs to amplify respective signals from the antenna elements 412, 414 without significantly degrading the signal-to-noise ratio of the signals, and one or more Tx components for processing Tx signals can include PAs to amplify signals from the transmit section 450 to the antenna elements 412, 414. The phase shifters 483 (e.g., for Rx and/or Tx) can apply a phase shift, a time delay, or the link to Tx and/or Rx signals to provide beamforming and beam steering for a phased array antenna. In some examples, the serially fed FE networks 432, 434 can include other components such as, for example, VGAs. In some cases, VGAs, LNAs 482, PAs 484 and/or phase shifters 483 can be included in separate FE components (not shown) coupled to the serially fed FE networks 432, 434. Individual FEs of the serially fed FE networks 432, 434 can also include one or more ports (not shown) for coupling to power and/or digital control signals (see FIGS. 6F and 6G).

In some cases, the serially fed FE networks 432, 434, can be communicatively coupled to one or more 90-degree hybrid couplers (not shown), which can be communicatively coupled to the antenna elements 412, 414. In some examples, a 90-degree hybrid coupler can be used for power splitting in the Rx direction and power combining in the Tx direction and/or to interface the serially fed FE networks 432, 434 with a circularly polarized antenna element. For example, an antenna Rx port 474 and an antenna Tx port 476 associated with each antenna element 412, 414 can be coupled to first and second isolated ports of a 90-degree hybrid coupler and third and fourth isolated ports of the 90-degree hybrid coupler can be coupled to first and second ports of a corresponding antenna elements 412, 414. While a 90-degree hybrid coupler is provided as an illustrative example, other directional coupler mechanisms are within the scope of the present disclosure.

The BF chip 424 and serially fed FE networks 432, 434 can process data signals, streams, or beams for transmission by the antenna elements 412, 414, and receive data signals, streams, or beams from antenna elements 412, 414. The BF chip 424 can also recover/reconstitute the original data signal in a signal received from antenna elements 412, 414 and serially fed FE networks 432, 434. For example, for a received (Rx) signal, the BF chip 424 can coherently combine a beamformed signal from each connected serially fed FE network 432, 434. Moreover, the BF chip 424 can strengthen signals in desired directions and suppress signals and noise in undesired directions.

For example, in transmit mode (e.g., the transmit direction), the one or more RF sections Tx 454 of the transmit section 450 can process signals from the Tx BF 456 and output corresponding signals amplified by the PA 462A. For example, signals to the antenna elements 412 can be routed from BF RFIO 466 to RF serial input 437A of the initial FE 432A, and signals to the antenna elements 414 can be routed from BF RFIO 468 to RF serial input 437A of the initial FE 434A. The initial FE 432A of serially fed FE network 432 can receive the amplified RF signal at RF serial input 437 and distribute the RF signal to antenna elements 412A. For example, the amplified RF signal can be split equally among each of the antenna elements (e.g., from the distribution/combination ports 459) and the RF serial output 439A of the initial FE 434A. Referring to FIG. 4D, phase shifters (e.g., phase shifters 483) can apply a phase shift to the corresponding split signals to generate a coherently combining transmitted signal in a desired direction (e.g., the beam direction). In turn antenna elements 412A can radiate the amplified and phase adjusted RF signal.

In some embodiments, each individual FE of the serially fed FE networks 432, 434 can include signal conditioning components (see signal conditioning components 447, 449 of FIG. 4D) for amplitude and/or phase adjusting the RF signal in the transmit direction before outputting the RF signal to the next individual FE of the serially fed FE network 432, 434.

In the illustrated embodiment, initial FE 432A of serially fed FE network 432 distributes the RF signal from RF serial output 439A to the RF serial input 437B of the next individual FE 432B. In turn, the individual FE 432B can distribute the RF signal received from initial FE 432A to antenna elements 412B and the RF output 439B of individual FE 432B. The RF signal can be serially passed to each successive individual FE 432C through 432P and corresponding antenna elements 412C through 412P in a similar fashion. Similarly, the initial FE 434A of the serially fed FE network 434 can process an RF signal received from BF RFIO 468 and distribute the RF signal to antenna elements 414A.

In some cases, the signal conditioning components (e.g., signal condition components 447, 449 of FIG. 4D) and/or PAs (e.g., PAs 484 of FIG. 4D) can be configured to provide a common gain between a BF RFIO (e.g., BF RFIO 466, 468 of FIG. 4C) and each of the antenna elements 414R. In some implementations, the signal conditioning components and/or the PAs can be configured to provide a common gain between a BF RFIO 466, 468 and each of the RF serial inputs 437 (see FIG. 4B) of the individual FEs. For example, the signal conditioning components of the initial FE 432A can be configured to make a first gain between a BF RFIO 466, 468 and RF serial input 437A and a second gain between the BF RFIO 433 and the RF serial input 437B equal to the common gain. In some cases, each individual FE can be configured such that the RF serial inputs 437 of each individual FE of the serially fed FE network 432 receives a signal with a matched gain relative to the BF RFIO. In one illustrative example, a gain of one (e.g., unity gain) can be set between each RF serial input 437A through 437P-1 and each subsequent corresponding RF serial input 437B through 437P. In some cases, providing a unity gain can result in each individual FE of the serially fed FE networks 432 receiving a signal having the same amplitude at each RF input 437A-437P of the individual FEs 432A-432P.

In some examples, the signal conditioning components 447, 449, and/or the PAs 484 of individual FEs included in a phased array antenna can be configured to provide different gains to different antenna elements 414R. In one illustrative example, the gain of different PAs 484 in different individual FEs 492R can be varied to provide an excitation taper (e.g., and amplitude taper) to signals transmitted from the antenna elements 414R of the phased array antenna.

In receive mode (e.g., the receive direction), serially fed FE networks 432, 434 can receive RF signals from antenna elements 412, 414 and process the RF signals. For example, the initial FE 432A of the serially fed FE network 432 can receive RF signals from antenna elements 412A via respective antenna Rx ports 474. The one or more RX components (see components 482, 483 of FIG. 4D) of the last individual FE 432P of the serially fed FE network 432 can, for example, amplify respective RF signals received from the antenna elements 412P without significantly degrading the signal-to-noise ratio of the RF signals (e.g., with one or more LNAs). The one or more Rx components (see components 482, 483 of FIG. 4D) of the last individual FE 432P can also combine the signals from each of the antenna elements 412P. In one illustrative and non-limiting example, a distribution/combination network can combine the signals from each of the antenna elements 412P The last individual FE 432P can output the received RF signal (e.g., the combined signal from antenna elements 412P) to RF serial input 437P of the individual FE 432P, which can serve as an RF output port in the receive mode as mentioned above.

The one or more Rx components (see components 482, 483 of FIG. 4D) of the next to last individual FE 432P-1 can, for example, amplify respective RF signals from the antenna elements 412P-1 without significantly degrading the signal-to-noise ratio of the RF signals. The RF serial output 439P-1 (which can act as an RF input port in the receive mode) of next to last individual FE 432P-1 can also receive the RF signal output (e.g., the combined signal from antenna elements 412P) from RF serial input 437P of last individual FE 432P. The one or more Rx components (see components 482, 483 of FIG. 4D) of individual FE 432P-1 can also combine the RF signals from each of the antenna elements 412P-1 with the RF signal received from last individual FE 432P. The RF signals received from each of the antenna elements 412P-1 can be phased shifted (e.g., by phase shifters 483) so that the received signals originating from a desired direction (e.g., a beam direction) can be combined coherently. In some embodiments, each individual FE of the serially fed FE network can include signal conditioning components for amplitude adjusting (e.g., an amplifier) and/or phase adjusting (e.g., phase shifters 483) the RF signal in the receive direction before outputting the RF signal to the next individual FE of the serially fed FE networks 432.

The next to last individual FE 432P-1 can output the combined RF signal to RF input port 437P-1, which can then be input by the RF output port 439P-2 of the next individual FE 432P-2 of the serially fed FE network 432 and combined with RF signals received from the antenna elements 412P-2 coupled to the next individual FE 432P-2 and so on until a combined RF signal that includes the RF signals received from each of the antenna elements 412A through 412P is output from the RF serial input 437A of the initial FE 432A. The combined RF signal can be routed from the RF serial input 437A of the initial FE 432A through the BF RFIO 466 to the receive section 452 of the BF 424. Similarly, the serially fed FE network 434 can output a combined RF signal from RF serial input 437A of the initial FE 434A that includes the RF signals received from each of the antenna elements 414A through 414Q to the BF RFIO 468 which can be connected to the receive section 452 of the BF 424.

In some cases, the signal conditioning components (e.g., signal conditioning components 447, 449 of FIG. 4D) and/or the LNAs (e.g., LNAs 482 of FIG. 4D) can be configured to provide an equal gain between each of the antenna elements 414R and a BF RFIO (e.g., BF RFIO 466, 468 of FIG. 4C). In some implementations, the signal conditioning components (e.g., signal conditioning components 447, 449 of FIG. 4D) and/or the LNAs (e.g., 482 of FIG. 4D) can be configured to provide a common gain between each of the RF serial output 439R of the individual FEs and a BF RFIO 466, 468. For example, the signal conditioning components (e.g., signal conditioning components 447, 449 of FIG. 4D) and/or the LNAs (e.g., LNAs 482 of FIG. 4D) of the initial FE 492A can be configured to make a first gain between RF serial output 439A and a BF RFIO 466, 468 and a second gain between the RF serial out 439B and the BF RFIO 466, 468 equal to the common gain. In some cases, each individual can be configured such that the RF serial outputs 439 of each individual FE of the serially fed FE network 432 receives a signal with a matched gain relative to the BF RFIO 466, 468. For example, the gain between RF serial output 439A and RF serial out B can be made equal to one (1). In some embodiments, a gain of one (e.g., unity gain) can be set between each RF serial output 439P-439B and each adjacent corresponding RF serial output 439P-1-439A.

The one or more Rx RF sections 458 of the receive section 452 of the BF 424 can process the received RF signals and output the processed signal to the Rx BF 460. In some examples, the processed signal can include a signal amplified by an LNA 464A of Rx RF section 458. The Rx BF 460 can receive the signal and output a beamformed signal to a modem (e.g., modem 428 of FIG. 4B).

In some examples, the transmit section 450 and the receive section 452 can support a same number and/or set of antenna elements and/or serially fed FE networks. In other examples, the transmit section 450 and the receive section 452 can support different numbers and/or sets of antenna elements and/or serially fed FE networks. Moreover, while FIG. 4C illustrates two serially fed FE networks 432, 434 interfacing with two separate BF RFIOs 466, 468 of the BF chip 424, it should be noted that a BF chip can interface with a single serially fed FE network or more than two serially fed FE networks. The configuration of each BF RFIO 466, 468 of the BF chip interfacing with a single serially fed FE network in FIG. 4C is merely an illustrative example provided for explanation purposes. For example, a combiner/distributer (or a network of combiner/distributors) can allow a single BF RFIO 466, 468 of the BF 424 to interface with multiple serially fed FE networks. Also, while the serially fed FE networks 432, 434 are shown in FIG. 4C with one RF serial input, one RF serial output, four antenna Rx ports 474 and four antenna Tx ports 476 supporting four (e.g., M=4) antenna elements, it should be noted that, in other examples, the serially fed FE networks 432 can include more or fewer RF inputs/outputs and can support more or fewer antenna elements than shown in FIG. 4C. For example, in some cases, the serially fed FE networks 432, 434 can include two RF inputs and two RF outputs (e.g., for two separate data beams as shown in FIGS. 9A and 9B). In some cases, the serially fed FE networks 432, 434 can support two, three, five, or more antenna elements with an antenna Rx port 474 and an antenna Tx port 476 provided for each supported antenna element.

In the illustrative example of FIG. 4C, a TX/RX BF 424 is shown and the serially fed FE networks 432, 434 are also illustrated as bidirectional serially fed FE networks. In some implementations, serially fed FE networks can be configured for transmit (Tx) only operation or receive (Rx) only operation. In some implementations, serially fed FE networks configured for Tx only operation can be used with Tx BFs in a transmitting (Tx) phased array antenna. In some implementations serially fed FE networks configured for Rx only operation can be used with Rx only BFs in a receiving (Rx) phased array antenna. In some implementations, TX only BFs, RX only BFs, and/or TX/RX BFs (e.g., TX/RX BF 424) can be used with TX only serially fed FE networks, Rx only serially fed FE networks, Tx/Rx serially fed FE networks, and/or any combination thereof without departing from the scope of the present disclosure.

FIG. 4D illustrates an example individual FE 492R, which can be included in a serially fed FE network 492 (not shown). For the purposes of the illustration of FIG. 4D, the value R can correspond to an index of the individual FE 492R within a serially fed FE network 492 (not shown). For example, an initial FE 492A of the serially fed FE network 492 has an index of R=A. The serially fed FE network 492 (not shown) that includes individual FE 492R can correspond to serially fed FE networks 432, 434 shown in FIGS. 4B and 4C and the individual FE 492R can correspond to any of the individual FEs included in serially fed FE networks 432, 434. As shown in FIG. 4D, individual FE 492R can include an RF serial input 437R, an RF serial output 439R, four antenna Rx ports 474 and four antenna Tx ports 476. As illustrated, four two-port antenna elements 414N can be communicatively coupled to a respective antenna Rx port 474 and respective antenna Tx port 476.

The individual FE 492R can include a distribution/combination network 445. The distribution/combination network 445 can combine signals in a receive (Rx) mode and distribute signals in a transmit (Tx) mode. In a transmit (Tx) mode, the distribution/combination network 445 can distribute a signal received at RF serial input 437R of individual FE 492R and conditioned by the signal conditioning components 447 to distribution/combination ports 459 and the RF serial output 439R of individual FE 492R. The distributed signal can be amplified by PAs 484 and/or phase shifted by phase shifters 483 prior to being received by the antenna elements 414R. In a receive (Rx) mode, the distribution/combination network 445 can combine a signal received at the RF serial output 439P and conditioned by the signal conditioning components 449 with signals from each antenna element 414R received at distribution/combination ports 459. The signal from each antenna element 414R can be amplified by LNAs 482 and/or phase shifted by phase shifters 483. In the illustrated example of FIG. 4D, the Tx and Rx signal paths share a common distribution/combination port 459 and the paths are joined at a junction 475. In the example of FIG. 4D with four antenna elements 414R coupled to the individual FE 492R (e.g., M=4), the distribution/combination network 445 can act as a 5-way distributor/combiner. In some cases, for any value of M, the distribution/combination network 445 can include an M+1-way distributor/combiner. In one illustrative example, the distribution/combination network 445 can include an M+1-way Wilkinson distributor/combiner.

In some embodiments, the individual FE 492R can include one or more components 482, 483 for processing Rx signals from the antenna elements 414A and one or more components 483, 484 for processing Tx signals to the antenna elements 414A. In FIG. 4D, the components 482 include LNAs to amplify respective signals from the antenna elements 414A without significantly degrading the signal-to-noise ratio of the signals, and the components 484 include PAs to amplify signals from the transmit section (see transmit section 450 of FIG. 4C) of a BF to the antenna elements 414A.

The individual FE 492R can include signal conditioning components 447 communicatively coupled to the RF serial input 437R and the distribution/combination network 445. The individual FE 492R can also include signal conditioning components 449 communicatively coupled to the RF serial output 439R and the distribution/combination network 445. In some examples, the one or more of the signal conditioning components 447, 449 can include components such as, for example, LNAs, PAs, VGAs, transformers, and/or phase shifters (e.g., for Rx and/or Tx).

As described above with respect to FIGS. 4B and 4C, in a receive mode, the individual FEs 492R of the serially fed FE network 492 can be configured to provide an equal gain between each of the antenna elements 414R and a corresponding BF RFIO (e.g., BF RFIO 466, 468 of FIG. 4C). In some implementations, signal conditioning components 447, 449 and/or LNAs 482 can be configured to provide a common gain between each RF serial output 439R and a corresponding BF RFIO (e.g., BF RFIO 466, 468 of FIG. 4C). In one illustrative example, the signal conditioning components 447, 449 and/or the LNAs 482 of the individual FE 492A and/or the individual FE 492B can be configured to make a first gain between RF serial output 439A of individual FE 492A and the BF RFIO 466, 468 and a second gain between RF serial output 439B of individual FE 492B and the BF RFIO 466, 468 equal to the common gain. In some implementations, the signal conditioning components 447, 449 and/or the LNAs 482 can be configured to provide a unity gain between successive RF serial outputs 439R of each individual FE 492R in the serially fed FE network 492. In some cases, providing a unity gain in the receive mode can result in each individual FE of the serially fed FE network 492 receiving a signal having the same gain at each RF serial output 439R of the individual FEs.

Moreover, in transmit (Tx) mode, the individual FEs 492R of the serially fed FE network 492 can be configured to provide an equal gain between each of the BF RFios (e.g., BF RFIO 466, 468 of FIG. 4C) and each of the antenna elements 414R. In some implementations, signal condition components 447, 449 and/or PAs 484 can be configured to provide a common gain between each BF RFIO 466, 468 and a corresponding RF serial input 437R. In one illustrative example, the signal conditioning components 447, 449 and/or the PAs 484 of the individual FE 492A and/or the individual FE 492B can be configured to make a first gain between the BF RFIO 466, 468 and the RF serial input 437A of individual FE 492A and a second gain between the BF RFIO 466, 468 and the RF serial input 437B of individual FE 492B equal to the common gain. In some examples, the signal conditioning components 447, 449 and/or the PAs 484 can be configured to apply a unity gain between the RF serial input 437A and RF serial input 437B. In some cases, applying a unity gain in the transmit mode can result in each individual FE 492R of the serially fed FE network 492 receiving a signal having the same gain at each RF serial input 437R of the individual FEs.

In some cases, the individual FE 492R can be an initial FE 492A (e.g., R=A) of the serially fed FE network 492 (not shown). The initial FE 492A can correspond to initial FE 432A, 434A of FIGS. 4B, 4C. As described above with respect to FIGS. 4B and 4C, the RF serial input 437A of an initial FE 492A can be coupled to a BF RFIO (e.g., BF RFIOs 433, 435 of FIGS. 4B, 4C) of a BF (e.g., BFs 424, 426 shown in FIGS. 4B, 4C). The RF serial output 439A of an initial FE can be coupled to an RF serial input 437B of an individual FE 492B that is serially connected to the initial FE 492A.

In some cases, the individual FE 492R can be a last individual FE 492P (e.g., last individual FEs 432P, 434Q of FIGS. 4B and 4C). In some embodiments, the RF serial output 439P of the last individual FE 492P can be coupled to a matched termination. In some embodiments, the RF serial output 439P of the last individual FE 492P can be disabled (e.g., by disabling one or more of the signal conditioning components 449).

FIG. 4E illustrates another example configuration for an individual FE 492R of a serially fed FE network. In the illustrated example of FIG. 4E, the distribution/combination network 455 includes separate Rx ports and Tx ports 451. As illustrated in FIG. 4E, in contrast to the configuration of FIG. 4D, the Tx signal path (e.g., including components 483, 484) and Rx signal paths (e.g., containing components 482, 483) can be joined within the distrubution/combination network 455. As shown, the individual FE 492R of FIG. 4E can utilize bidirectional RF serial input 437R and bidirectional RF serial output 439R similar to FIG. 4D.

FIG. 4F illustrates another example configuration of individual FE 492R. In the illustrated example of FIG. 4F, the RF serial input 437R and RF serial output 439R of FIG. 4D are instead replaced by separate Rx ports 456R and Tx ports 457R. Similar to the configuration of FIG. 4E, the distribution/combination network 465 of FIG. 4F can include separate Rx ports 461 and Tx ports 471 for connecting to respective Rx and Tx signal chains for the antenna elements 419R. As illustrated in FIG. 4F, the Tx and Rx signal paths can also remain separate throughout the full signal chain included in the serially fed FE 492R without departing from the scope of the present disclosure. In some examples, a serially fed FE network that includes only a transmit (Tx) path (not shown) or only a receive (Rx) path (not shown), can be used without departing from the scope of the present disclosure.

FIG. 4D through FIG. 4F illustrate examples of individual FEs 492R that can be included in serially fed FE networks. However, it should be noted that serially fed FE networks are a specific example of serially fed signal distribution networks. In addition, each of the individual FE modules of FIG. 4D through FIG. 4F is described as including RF serial inputs connected to RF BFIOs, in some cases, the through paths of signal distribution networks can operate at an intermediate frequency (IF) without departing from the scope of the present disclosure.

FIG. 4G through FIG. 4I are block diagrams illustrating additional configurations for serially fed signal distribution networks. In the examples of FIG. 4G and FIG. 4H, amplification of the signals to/from the antenna elements 419R can occur outside of the individual signal distribution modules 498R, 499R of FIG. 4G, 4H, respectively. In one illustrative example, LNAs 490 and/or PAs 491 can be included in a separate FE module 479 as shown in FIG. 4G. In another illustrative example, the LNAs 490, PAs 491, and/or phase shifters 483 can be included in one or more separate chips. FIG. 4G is an illustrative example of individual signal distribution module 498R of a serially fed signal distribution network 498 (not shown). FIG. 4H is an illustrative example of an individual signal distribution module 499R of a serially fed signal distribution network 499 (not shown). In the example of FIG. 4I, an individual FE 470R of a serially fed FE network 470 (not shown) can include additional components when compared to the individual FE 492R of FIG. 4D. For example, the individual FE 470R of FIG. 4I can include mixers 487 for upconverting/downconverting signals between an RF frequency and an intermediate frequency (IF).

Referring to FIG. 4G, the example individual signal distribution module 498R includes signal conditioning components 447, 449, phase shifters 483, a distribution/combination network 455, and divider/combiners 477. In contrast to the individual FE configurations of FIG. 4D through FIG. 4F, the individual signal distribution module 498R does not include amplifier components such as LNA 482 and PA 484 of FIG. 4D through FIG. 4F. In the example of FIG. 4G, a separate amplifier module is electrically coupled between bidirectional IO ports 444 of the individual signal distribution module 498R and the antenna elements 419R. As illustrated in FIG. 4G, the distribution/combination network 455 can include bidirectional IOs 448 on the serial path while providing separate Tx port 451 and Rx ports 453 on the antenna signal paths. In the illustrated example, each Tx port 451 is coupled to a phase shifter 483 for operation in a transmit (Tx) configuration. Similarly, each Rx port 453 is coupled to a separate phase shifter 483 for operation in a receive configuration. The phase shifters 483 can provide beamforming capability to the phased array antenna including individual signal distribution module 498R. In some cases, divider/combiners 477 can be used to share a single bidirectional IO port 444 of the individual signal distribution module 498R. As shown in the illustrated example, each single bidirectional IO port 444 can correspond to antenna elements 419R.

In the illustrated configuration of FIG. 4G, FE modules 479 are connected between one bidirectional IO port 444 of the individual signal distribution module 498R and one antenna element 419R. The separate FE module 479 can include components such as LNAs 490 for a receiving (Rx) signal path and PAs 491 for a transmitting (Tx) signal path. The separate FE module 479 can include a bidirectional IO port 443 and a combiner/divider 478 for sharing the bidirectional IO port 443 between the receive (Rx) path (e.g., through LNA 490) and the Transmit (Tx) path (e.g., through PA 491) of the separate FE module 479. In some cases, more or fewer components can be included within the separate FE module 479 without departing from the scope of the present disclosure. As illustrated by FIG. 4G, although the examples of FIG. 4D through FIG. 4F refer to individual FEs and serially fed FE networks, front-end components such as LNAs 490 and/or PAs 491 may be included in separate modules from the individual signal distribution module 498R and a corresponding serially fed signal distribution network without departing from the scope of the present disclosure.

The example of FIG. 4H illustrates another example configuration for a serially fed distribution network including an individual signal distribution module 499R. In the example of FIGS. 4G and 4H, like numbered components can be similar and perform similar functions. As shown in FIG. 4H, in some cases, one or more signal conditioning components 446 can be included between the separate Tx port 451 and Rx port 453 of the distribution/combination network 455. In the illustrated example of FIG. 4H, the Rx port 453 and Tx port 451 can be combined into a bidirectional IO port 444 of the individual signal distribution module 499R by the one or more signal conditioning components 446. As shown, the single bidirectional IO port 444 of individual signal distribution module 499R can be coupled to a bidirectional IO port 443 of a separate FE 480. The separate FE 480 can be coupled to two antenna elements 419R. In some examples, the separate FE 480 can include a receiving (Rx) signal path and a transmitting (Tx) path for each connected antenna element 419R. In some cases, the receiving (Rx) path for each antenna element 419R can include an LNA 490 and a phase shifter 483. In some examples, the transmitting (Tx) path for each antenna element 419R can include a PA 491 and a phase shifter 483. The example of FIG. 4H illustrates that front-end components such as LNAs 490 and/or PA 491 as well as phase shifters 483 can be included in a separate module from the individual signal distribution modules 499R and a corresponding serially fed signal distribution network without departing from the scope of the present disclosure.

Referring to FIG. 4I, another example configuration for an individual FE 470R. In the illustrated example of FIG. 4I, the Individual FE 470R includes bidirectional IF serial ports 442R. As shown, the through signal path between individual FEs (e.g., 470R) of a corresponding serially fed FE network 470 (not shown) can operate at an IF while connected antenna elements 419R can transmit and/or receive RF signals. An initial serially fed FE 470A (not shown) of the serially fed FE network 470 (not shown) can be communicatively coupled to a BF IFIO of a BF, similar to connections between BF chip 424 and serially fed FE networks 432, 434 shown in FIG. 4C. As illustrated, conversion between the IF and RF signal frequencies can be performed by mixers 487. As shown, each transmit (Tx) path can include a phase shifter 483, a mixer 487, and a PA 484. Similarly, each receive (Rx) path can include an LNA 482, mixer 487, and a phase shifter 483. In the illustrated example of FIG. 4I, the mixers 487 are shown between the amplifiers (e.g., LNAs 482, PAs 484) and the phase shifters 483. Accordingly, the phase shifters in the illustrated example of FIG. 4I apply a phase shift to the IF signal distributed by the distribution/combination network 455. In some cases (not shown), the mixers 487 can be positioned between the distribution/combination network 455 and the phase shifters 483 without departing from the scope of the present disclosure. In such an example, the phase shifters can apply a phase shift to the RF signals in each of the transmit (Tx) and receive (Rx) paths of the individual serially fed FE 470R. In the illustrative example of FIG. 4I, the individual FE 470R can include separate Rx RF inputs 488 and Tx RF outputs 489 for coupling to the antenna elements 419R.

In the illustrated example of FIG. 4I, the mixers 487 receive a local oscillator (LO) signal fLO at LO ports 497 for converting signals between the IF and RF frequencies. In the illustrated example of FIG. 4I, the individual FE 470R is shown with an LO input 485 and an LO output 486 for serial distribution of the LO signal fLO between individual FEs of the serially fed FE network 470 (not shown). However, in some examples, the LO signal fLO can be distributed in parallel to each individual FE without departing from the scope of the present disclosure. Similar to the configuration of FIG. 4G, distribution/combination network 455 of FIG. 4I can include bidirectional IOs 448 on the through path and separate Tx ports 451 and Rx ports 453 for the signal paths between the distribution/combination network 455 and then antenna elements 419R. In the example of FIG. 4I, the bidirectional IOs 448, Tx ports 451, and Rx port 453 can transmit and/or receive signals at the IF frequency. In the illustrated example, RF Rx inputs 488 and Tx RF outputs 489 of the individual FE 470R can couple with the antenna elements 419R for receiving or transmitting signals at the RF frequency.

Returning to FIG. 4C, while the BF chip 424 is shown to include certain elements and components, one of ordinary skill will appreciate that the BF chip 424 can include more or fewer elements and components than those shown in FIG. 4C. Similarly, while the serially fed FE networks 432, 434 are shown to include certain elements and components, the serially fed FE networks 432, 434 shown in FIG. 4C and the example individual FE 492R shown in FIG. 4D can include more or fewer elements and components than those shown in FIGS. 4C and 4D. For example, in some cases, the BF chip 424 and/or serially fed FE networks 432, 434 can be coupled to, reside on, and/or implemented by, a printed circuit board (PCB) of the phased array antenna system and/or any number of discrete parts on a PCB. The elements and components of the BF chip 424 and serially fed FE networks 432, 434 shown in FIG. 4C are merely illustrative examples provided for explanation purposes. Moreover, the example phased array antenna system 420 in FIG. 4B is merely an example implementation provided for explanation purposes. One of skill in the art will recognize that, in other implementations, the phased array antenna system 420 can include more or less of the same and/or different components than those shown in FIG. 4B. For example, in other implementations, the phased array antenna system 420 can implement other beamformers (e.g., analog, digital, hybrid), a different number and/or arrangement of beamformers and/or FEs, and/or any other type and/or configuration of beamformers and/or FEs.

Signal Distribution from Digital Beamformers IO Front Ends

FIGS. 5A through 5D illustrate example signal distribution/combination configurations for phased array antenna systems utilizing distribution/combination networks coupled to individual FE modules (FEMs). The FEMs shown in FIGS. 5A through 5D do not include serial connections for distributing transmitted and/or received signals. FIG. 5A illustrates a block diagram of a distribution/combination configuration 500 for a single BF 524. In some embodiments, BF 524 can be part of a phased array antenna system that includes a single BF and sixty four (64) antenna elements (e.g., antenna elements 572A through 572H (collectively referred to herein as antenna elements 572) and 574A through 574H (collectively referred to herein as antenna elements 574)) as illustrated. In some embodiments, the BF 524 can correspond to BF chip 424 of FIG. 4C.

As illustrated, the BF 524 includes a BF RFIO 566 and a second BF RFIO 576, which can be similar to and perform similar functions to BF RFIOs 466, 468 of FIG. 4C. In the embodiment of FIG. 5A, the BF 524 is shown centrally located relative to a group of sixteen (16) FEMs coupled to the first and second BF RFIOs 566, 576 of the BF 524. In the illustrated embodiment of FIG. 5A, BF RFIO 566 is coupled to eight FEMs 582A through 582H (collectively referred to herein as FEMs 582) through a distribution/combination network 505. Similarly, the BF RFIO 576 is coupled to eight FEMs 584A through 584H (collectively referred to herein as FEMs 584) through a distribution/combination network 507. As illustrated, the distribution/combination networks 505, 507 provide RF propagation paths between the BF RFIOs 566, 576 and each of the FEMs 582, 584. In some embodiments, the distribution/combination networks 505, 507 can be configured so that the RF propagation paths between the BF RFIOs 566, 576 and each of the FEMs 582, 584 are of equal length as illustrated in FIGS. 5A, 5B. However, in some embodiments, the length of RF propagation paths may not be configured to be equal.

As shown, a first conductive trace 510 can be coupled to the BF RFIO 566 at one end and to a combiner/divider 515 at a second end. In some embodiments, the combiner/divider 515 can equally divide an RF signal transmitted from the BF RFIO 566 and distribute the equally divided RF signals to conductive traces 512 and 514. In the case of a lossless combiner/divider 515, the two equally divided RF signals can have half of the power (e.g., −3 dB) of the RF signal transmitted from the BF RFIO 566. The combiner/divider 515 can also combine RF signals received on conductive trace 512 (e.g., from the FEMs 582A, 582B, 582E, and 582F) and RF signals received on conductive trace 514 (e.g., from FEMs 582C, 582D, 582G, and 582H) and the combined RF signal can be output onto conductive trace 510 and received by BF RFIO 566. As used herein, the conductive traces (e.g., conductive traces 512, 514) that receive a divided RF signal from a combiner/divider (e.g., combiner/divider 515) and/or provide inputs combined by a combiner/divider are referred to as branches of the combiner/divider. In one illustrative example, the combiner/divider 515 can be a Wilkson power combiner/divider. In some embodiments, the power of the RF signal output to each branch of the combiner/divider 515 can be −3 dB from the RF signal input to the combiner/divider 515 from the conductive trace 510. The BF RFIO 576 can similarly couple to combiner/divider 515 by the conductive trace 545.

Referring to FIG. 5A, a conductive trace 512 can be electrically coupled to combiner/divider 515 at a first end and electrically coupled to another combiner/divider 518 at a second end. The branches of combiner/divider 518 can in turn couple to two terminal stage combiner/dividers 525. The combiner/dividers 518 and 525 can be similar to and perform similar functions to the combiner/divider 515. As illustrated, the branches 527, 529 of combiner/divider 525 couple to FEM RFIOs 592A, 592B of FEMs 582A, 582B are also referred to as terminal branches of the distribution/combination network 505. For the distribution/combination networks 505, 507 that each electrically couple a BF RFIO 566, 576 of the BF 524 to eight FEMs as illustrated, a total number of R=3 combiner/dividers 515, 518, 525 are needed. For a distribution/combination network 505, 507 that incorporates combiner/dividers with two branches as illustrated, a total of 2^{R} total terminal branches can be coupled to a single BF RFIO 566, 576.

In some embodiments, each of the FEMs 582 can distribute RF signals received at a corresponding FEM RFIO 592A through 592H (collectively referred to herein as FEM RFIOs 592) to four antenna elements 572A through 572H (collectively referred to herein as antenna elements 572), respectively. The FEMs 582 and antenna elements 572 can be coupled together by antenna traces 517. In some embodiments, the antenna traces 517 can be coupled to an antenna Rx port and an antenna Tx port such as antenna Rx ports 474 and antenna Tx ports 476 of FIGS. 4B through 4D. The four antenna elements per FEM can correspond to a value of M=4 as described with respect to FIGS. 4B and 4C. In the illustrated example with M=4 and four antenna elements per FE, 64 total antenna elements can communicatively couple with the two BF RFIOs 566, 576 of BF 524. In some embodiments, FEMs 582, 584 can distribute a transmitted RF signal received at FEM RFIO 592A from BF 524 to the antenna elements 572A in a transmit configuration and/or combine received RF signals from the antenna elements 572A and output the combined received RF signals to the distribution/combination network 505 in a receive configuration. In some embodiments, the FEMs 582A through 582H can include LNAs for amplifying received RF signals without significantly degrading the signal-to-noise ratio of the received RF signals and/or PAs to amplify the RF signal for transmission by antenna elements 572. For example, without limitation, the FEMs 582 can include the components 482 (e.g., LNAs), 483 (e.g., phase shifters) and/or components 484 (e.g., PAs) shown in the individual FE 492R shown in FIG. 4D as well as other signal conditioning components (not shown). For example, phase shifters (not shown) included in each of the FEMs 582 can perform a beamforming function for signals being sent to and/or received from the antenna elements 572. As illustrated, the FEMs 582, 584 are not initial FEs of serially fed FE networks (e.g., 432, 434 of FIGS. 4B and 4C). Instead, each of the FEMs 582, 584 is directly connected to one of the distribution/combination networks 505, 507.

As illustrated, BF RFIO 576 can be electrically coupled to a combiner/divider 515 by a conductive trace 545. In the illustrated example of FIG. 5A, BF RFIO 576 of BF 524 can communicatively couple with antenna elements 574A through 574H (collectively referred to herein as antenna elements 574) via the distribution/combination network 507 and FEMs 584A through 584H (collectively referred to herein as FEMs 584) in a similar fashion to the communicative coupling between BF RFIO 566 and antenna elements 712 through distribution/combination network 505 and the FEMs 582 as described above. As a result, a total of 16 terminal branches (eight per distribution/combination network 505, 507) are required to communicatively couple the two BF RFIOs 566, 576 of the BF 524 with the 64 antenna elements as shown in the configuration of FIG. 5A.

FIG. 5B illustrates a block diagram of a distribution/combination configuration 530 for a single BF 524. In the illustrated example, the BF 524 can be positioned outside of the array of FEMs 582, 584 and antenna elements 572, 574. As illustrated conductive traces 535, 545 can couple combiner/dividers 515 of respective distribution/combination networks 555, 565. After the RF signal sent from BF RFIOs 566, 576 to conductive traces 535, 545 reach the combiner/dividers 515 of distribution/combination networks 555, 565, the remaining connections to and functionality of FEMs 582, 584 and antenna elements 572, 574 can be identical to the descriptions with respect to FIG. 5A above. In some cases, a distribution/combination configuration 530 as shown in FIG. 5B can be utilized when the BF 524 cannot be located within the same region as the array of FEMs 582, 584 due to lack of sufficient routing area within the region of a phased array antenna system occupied by the array of FEMs 582, 584.

FIG. 5C is a simplified cross-sectional diagram of a PCB 560 illustrating example connections between BF 524 and FEMs 582A, 582B of FIGS. 5A and 5B using either distribution/combination configuration 500 of FIG. 5A or distribution/combination configuration 530 of FIG. 5B. Antenna elements 572A, 572B corresponding to respective FEMs 582A, 582B (see FIGS. 5A, 5B) are illustrated as being physically and electrically coupled to a first side 502 of the PCB 560. In some embodiments, BF 524 and FEMs 582A, 582B can be physically and electrically coupled to a second side 504 of the PCB 560, opposite the first side 502.

As illustrated in FIG. 5C, the PCB 560 can include multiple layers 503A through 503F (collectively referred to herein as PCB layers 503). Conductive traces and/or planes on the individual PCB layers 503A through 503F can be used to provide electrical connections (e.g., RF connections, digital control signal connections, etc.) between components on a same PCB layer and/or different PCB layer(s) of the PCB layers 503, and/or to provide ground and power connections. In the illustrated example of FIG. 5C, double sided arrows represent a signal routing path between BF 524 and the FEMs 582A, 582B through the distribution/combination network 505/555 as shown and described with respect to FIGS. 5A and 5B. Because of the two-dimensional nature of FIG. 5C, the full distribution/combination network 505 cannot be shown. In the illustrated example, a portion of the distribution/combination network 505 corresponds to the conductive traces 510, 535 of FIGS. 5A, 5B. The combiner/dividers 515, 518 are not shown in the illustration, but a terminal stage divider/combiner 525 is illustrated, with branches 527, 529 coupling to FEMs 582A, 582B, respectively. Although the double sided arrows representing the signal path through the distribution/combination network 505 have the appearance of not being on a same layer of the PCB layers 503, in some cases, the full distribution/combination network 505 can be routed on a single metal layer, such as a metal layer between PCB layers 503E, 503F. In the illustrated example, the disparity between vertical position (e.g., in the z-axis direction of FIG. 5C) of the different double sided arrows for conductive traces 510, 535 and combiner/divider 525 when compared to the branches 527, 529 is provided to more closely resemble the terminal portions of the distribution/combination network 505 shown in FIGS. 5A and 5B. In some embodiments (not shown), the distribution/combination network 505 can be routed on any single layer and/or multiple layers of the PCB layers 503.

FIG. 5D illustrates another cross-sectional view of PCB 560 illustrating routing paths between the FEMs 582A, 582B and corresponding antenna elements 572A, 572B. The routing paths are indicated by double sided arrows between the FEMs 582, 584 and corresponding antenna elements 572A, 572B. As illustrated in FIGS. 5A and 5B, antenna traces 517 can be used to electrically couple FEM RFIOs (e.g., FEM RFIOs 592A of FIGS. 5A and 5B) of FEM 582A to antenna elements 572A and FEM RFIOs (e.g., FEM RFIOs 594A of FIGS. 5A and 5B) of FEM 582B to antenna elements 572B. For example, in a receive mode, LNAs can couple the antenna elements 572 to the FEM RFIOs 594 through the traces 517. Similarly, PAs (e.g., PAs 484 of FIG. 4D) can couple the FE RFIOs to the antenna elements 572 through the antenna traces 517. As illustrated, a portion of the routing paths can be done on the same metal layer (e.g., the metal layer between PCB layers 503E and 503F) as the distribution/combination network 505 of FIG. 5C. In some examples, to reach the first side of the PCB 560, vias (not shown) can be provided to make connections between the PCB layers 503. Although the double-sided arrows indicate that the antenna traces 517 may pass directly (e.g., by one or more vias) from the metal layer between PCB layers 503E and 503F to the first side 502 of the PCB 560, additional routing an occur on any of the layers of the PCB 560. For example, the antenna traces 517 can include meandering sections on any of the PCB layers 503. In some embodiments, meandering sections can be used to ensure that the effective length of propagation of RF signals to/from antenna elements 572A, 574B are matched to prevent phase, delay, and/or gain mismatch between signals arriving to the antenna elements 572A, 572B due to the routing. In some embodiments, the meandering can include the use of vias between two or more layers to alter the effective length of propagation for a signal path. In some embodiments, meandering for the routing paths between FEMs 582A, 582B and antenna elements 572A, 572B may be restricted to the same metal layer as routing for the distribution/combination networks 505, 507 of FIGS. 5A and 5B. As a result, in some cases, the routing for all of the necessary connections on a single layer can be challenging.

FIGS. 6A through 6G illustrate example signal distribution/combination configurations utilizing serially fed FE networks. For example, the configurations illustrated in FIGS. 6A through 6G can be utilized to distribute and/or combine signals for processing by one or more BFs using the serially fed FE networks 432, 434 of FIGS. 4B and 4C.

FIG. 6A illustrates an example block diagram of a distribution/combination configuration 600 using serially fed FE networks. For example, the BF 624 shown in FIG. 6A can correspond to BF chips 424, 426, and/or any other BF in the BF lattice 422 of FIG. 4B. In the illustrated example of FIG. 6A, BF 624 is shown with eight BF RFIOs. In the illustrated example, the routing configuration of two example BF RFIOs 686, 696 of the BF 624 are shown to provide illustrative examples and the remaining six BF RFIOs 699 can be configured according to the same principles. As shown in FIG. 6A, the BF RFIO 686 can communicatively couple to an initial FE 632A of a serially fed FE network that includes four individual FEs 632A through 632D (collectively referred to herein as serially fed FE network 632) by a routing trace 610. Similarly, the BF RFIO 696 can communicatively couple to an initial FE 634A of a serially fed FE network that includes for individual FEs 634A through 634D (collectively referred to herein as serially fed FE network 634). The serially fed FE networks 632, 634 can correspond to, for example, serially fed FE networks 432, 434 of FIG. 4C.

In the illustrated example of FIG. 6A, RF through paths 621, 622, and 623 can provide communicative coupling between the individual FEs of the serially fed FE network 632. In the illustrated example, the RF through paths 621, 622, 623 are illustrated with three conductive traces. In one illustrative example, the three conductive traces included in each of the RF through paths 621, 622, 623 can correspond to multiple signal beam distributions with corresponding RFIOs for each individual FE of the serially fed FE networks 632, 634. In the illustrated example, the BF 624 is shown with one BF RFIO 686, 696, 699 coupled to a middle signal path of the three conductive traces for each serially fed FE network. In some cases, the remaining conductive traces can be coupled to BF RFIOs of one or more additional BFs (not shown). In another illustrative example, the three conductive traces can correspond to a positive differential signal path, a negative differential signal path, and a common or reference signal path for the RF transmitted and/or received signals. In some cases, a converter between single ended and differential signal representations of the RF signal can be provided between single-ended routing traces 610, 620, 630 and the serially fed FE networks. In some implementations, the routing traces 610, 620, 630 can also include multiple traces for providing differential representation of the RF transmitted and/or received signals to/from the BF RFIOs 686, 696, 699. The remaining six BF RFIOs 699 can each couple to a respective initial FE of serially fed FE networks including four individual FEs by a corresponding routing trace 630. The individual FEs 632A through 632D can each respectively include FE RF inputs 637A through 637D and FE RF outputs 639A through 639D. As illustrated, each respective individual FE of the serially fed FE network 632 is coupled to four antenna elements by antenna traces 617. For example, the initial FE 632A is coupled to four antenna elements 612A, the individual FE 632B is coupled to four antenna elements 612B, and so on. The configuration illustrated in FIG. 6A can correspond to a value of M=4 as described with respect to FIGS. 4B and 4C.

As illustrated in FIG. 6A, the routing traces 610, 620, 630 can each be provided through routing channels, such as the spacing between the serially fed FE networks of FIG. 6A. In the illustrated example, no combiner/dividers, such as combiner/dividers 515, 518, 525 of FIGS. 5A and 5B are used to form a distribution/combination network such as distribution/combination networks 505, 507 of FIGS. 5A and/or distribution/combination networks 555, 565 of FIG. 5B. In contrast, each of the BF RFIOs 686, 696, 699 is coupled to a single initial FE of a corresponding serially fed FE network by routing traces 610, 620, 630 and the serially fed FE networks combine/distribute RF signals to/from corresponding antenna elements as described above with respect to FIGS. 4A and 4B. Although FIG. 6A does not include combiner/dividers, in some configurations, combiner/dividers can be used to distribute/combine RF signals from a single BF RFIO to multiple serially fed FE networks.

Referring to FIG. 6B, a schematic representation of the distribution/combination configuration 600 of FIG. 6A is shown. For the purposes of providing a simplified illustration, the six remaining BF RFIOs 699 are excluded from the illustration, and only BF RFIOs 686, 696 and corresponding serially fed FE networks 632, 634 are illustrated. As shown in FIG. 6A, each BF RFIO 686, 696 can couple to an initial FE 632A, 634A of the serially fed FE networks 632, 634 by a corresponding routing trace 610, 620.

FIG. 6C illustrates an alternative configuration with a single BF RFIO 686 of the BF 624 coupled to two serially fed FE networks 632, 634. In the illustrated example, a combiner/divider 615 is used to divide transmitted RF signals from the BF RFIO 686 to the serially fed FE networks 632, 634 and/or combine received RF signals from the serially fed FE networks 632, 634 to be provided to the BF RFIO 686. The combiner/divider 615 can correspond to any one of the combiner/dividers 515, 518, 525 of FIGS. 5A and 5B. In the illustrated example, traces 635, 645 connected to the branches of combiner/divider 615 can be coupled to respective RF serial inputs (see FIGS. 4B, 4C) of initial FEs 632A, 634A of the serially fed FE networks 632, 634.

In both FIG. 6B and FIG. 6C, two serially fed FE networks 632, 634 are coupled to BF 624 by one or more BF RFIOs 686, 696. In the illustrated embodiments, the serially fed FE networks 632, 634 have an identical structure regardless of whether the serially fed FE networks share a common BF RFIO or not. FIGS. 6B and 6C illustrate a serially fed FE network block 685 including two serially fed FE networks 632, 634. In some embodiments of the present disclosure, serially fed FE network blocks 685 including two serially fed FE networks that are similar to and perform similar functions to the serially fed FE network block 685 of FIGS. 6B and 6C. In some embodiments, the serially fed FE network block 685 can include more or fewer components that shown in serially fed FE network block 685 of FIGS. 6B and 6C without departing from the scope of the present disclosure. For example, individual FEs within a serially fed FE network 632, 634 may include additional ports for power and/or digital signals as described with respect to FIGS. 6F and 6G below.

FIG. 6D is a simplified cross-sectional diagram of a PCB 660 illustrating example connections between BF 624 and individual FEs 632A, 632B of FIGS. 6A through 6C using any of the distribution/combination configurations of FIGS. 6A through 6C. In the illustrated example, an individual FE 632A is also the initial FE 632A of a serially fed FE network 632 (see FIGS. 6A through 6C) and individual FE 632B can be a next individual FE serially coupled to the initial FE 632A. The serially fed FE network 632 can also include additional individual FEs (e.g., four as shown in FIGS. 6A through 6C) serially coupled in a similar fashion to the serial coupling between initial FE 632A and individual FE 632B illustrated in FIG. 6D. As noted with respect to FIGS. 6A through 6C, a last individual FE 632P (see FIGS. 6A through 6C) of the serially fed FE network 632 may have its RF output coupled to a matched termination and/or may have signal conditioning components associated with the RF output disabled. As illustrated, antenna elements 612A, 612B corresponding to respective FEs 632A, 632B (see FIGS. 6A through 6C) are illustrated as being physically and electrically coupled to a first side 602 of the PCB 660. In some embodiments, BF 624 and FEs 632A, 632B can be physically and electrically coupled to a second side 604 of the PCB 660, opposite the first side 602.

As illustrated in FIG. 6D, the PCB 660 can include multiple individual PCB layers 603A through 603F (collectively referred to herein as PCB layers 603). Conductive traces and/or planes on the individual PCB layers 603A through 603F can be used to provide electrical connections (e.g., RF connections, digital control signal connections, etc.) between components on a same PCB layer and/or different PCB layer(s) of the PCB layers 603 and/or to provide ground and power connections. The PCB layers 603 can, for example, be layers of dielectric material mechanically coupled together to form the PCB 660. In the illustrated example of FIG. 6D, double sided arrows represent signal routing paths on a conductive (e.g., metal) layer between PCB layers 603E and 603F. A first signal path corresponding to conductive trace 630 of FIGS. 6A and 6B provides communicative coupling between BF 624 and the initial FE 632A of serially fed FE network 632. A second signal path corresponding to RF through path 621 communicatively couples initial FE 632A and individual FE 632B of the serially fed FE network 632. A third signal path corresponding to RF through path 622 communicatively couples individual FE 632B and a subsequent individual FE (not shown) of the serially fed FE network 632. As compared with FIG. 5C illustrating an example of previously developed technology, the relative simplicity of routing using serially fed FE network 632 alleviates the need to represent the three illustrated signal paths with double sided arrows at different heights. Also as a result of the relatively simple routing using serially fed FE network 632, the first, second, and third signal paths (as well as other signal paths connecting the BF 624 to additional serially fed FE networks) can be routed on a single metal layer, such as a metal layer between PCB layers 603E, 603F. Although the first, second, and third signal paths are illustrated on the metal layer between PCB layers 603E, 603F, in some embodiments (not shown), the first, second, and third signal paths can be routed on any other metal layer and/or multiple metal layers (e.g., connected by vias) of the PCB layers 603 without departing from the scope of the present disclosure.

FIG. 6E illustrates another cross-sectional view of PCB 660 illustrating routing paths between the FEs 632A, 632B and corresponding antenna elements 612A, 612B. The routing paths are indicated by double sided arrows between the FEs 632A, 632B and corresponding antenna elements 612A, 612B. As illustrated in FIG. 6A, antenna traces 617 can be used to electrically couple FE RFIOs (e.g., FE RF inputs 637A, FE RF outputs 639A of FIG. 6A) of FE 632A to antenna elements 612A and/or FE RFIOs of FE 632B to antenna elements 612B. As illustrated in FIG. 6E, a portion of the routing paths can be provided on the same metal layer (e.g., the metal layer between PCB layers 603E and 603F) as the routing traces 610, and through paths 621, 622 of FIG. 6D. In some examples, to reach the first side 602 of the PCB 660, vias (not shown) can be provided to make connections between the PCB layers 603. Although the double-sided arrows indicate that the antenna traces 617 may pass directly (e.g., by one or more vias) from the metal layer between PCB layers 603E and 603F to the first side 602 of the PCB 660, additional routing an occur on any of the layers of the PCB 660. For example, the antenna traces 617 can include meandering sections on any of the metal layers included in PCB layers 603. In some embodiments, meandering sections can be used to ensure that the effective length of propagation of RF signals to/from antenna elements 612, 614 are matched to prevent phase, delay, and/or gain mismatch between signals arriving to the antenna elements 612A, 612B. In some embodiments, the meandering can include the use of vias between two or more layers to alter the effective length of propagation for a signal path. As a result, in some cases, routing the necessary connections on a single layer can be challenging.

FIGS. 6F and 6G illustrate example routing configurations for a phased array antenna system utilizing serially fed FE networks as shown in FIGS. 6A through 6D with additional routing paths illustrated for FE power and digital signals. As illustrated in FIG. 6F, the example routing configuration can include two serially fed FE network blocks 685 as described with respect to FIGS. 6B and 6C above. A first serially fed FE network block 685 of FIG. 6F includes serially fed FE networks 632, 634 and a second serially fed FE network block 685 of FIG. 6F includes serially fed FE networks 636, 638. The connection between the first serially fed FE network block 685 and BF RFIO 686 of the BF 624 corresponds to the configuration shown in FIG. 6C, where a combiner/divider 615 is used to share a single BF RFIO 686 of BF 624 with two serially fed FE networks 632, 634 of first serially fed FE network block 685. Similarly, a combiner/divider 615 is used to share a single BF RFIO 696 of the BF 624 between two serially fed FE networks 636, 638 in the second serially fed FE network block 685.

As illustrated in FIG. 6F, a BF 624 includes two BF RFIOs 686, 696 similar to like numbered components in the example of FIG. 6B. Each of the BF RFIOs 686, 696 is coupled to two serially fed FE networks by a combiner/divider 615. In the illustrated example, the routing of RF signals to/from the serially fed FE networks 632, 634, 636, 638 is provided in RF routing channels 673 which run along a path passing through each individual FE of a respective serially fed FE network 632, 634, 636, 638. As illustrated in FIG. 6F, the BF 624 may also include digital signal IOs 669 for digital signals 670. The digital signals 670 can be used, for example and without limitation, to control gain, phase delay, transmit/receive mode, and/or any combination thereof of the individual FEs of each serially fed FE network 632, 634, 636, 638. The digital signals 670 can be routed in digital signal routing channels 671 as illustrated in FIG. 6F. In the illustrated example, the digital signal routing channels 671 are placed between every second RF routing channel 673. As illustrated a FE power supply 675 can provide power for the serially fed FE networks 632, 634, 636, 638 on power bus 674. As illustrated, individual FEs of the serially fed FE networks 632, 634, 636, 638 can include a port 684 for coupling to the power bus 674. As illustrated, the power bus 674 can be routed in power routing channels 676. Similar to the digital signal routing channels 671, the power routing channels 676 can be placed between every second RF routing channel 673, offset by one RF routing channels 673 when compared with the digital signal routing channels 671.

FIG. 6G illustrates an example routing configuration where digital signals 670 are routed serially through each of the serially fed FE networks 632, 634, 636, 638 in combined RF and digital routing channels 677. Although not labeled, the BF RFIO 686 can be shared by combiner/divider 615 between serially fed FE networks 632, 634 of a first serially fed FE network block 685 (see FIG. 6F) and BF RFIO 696 can be shared by a combiner/divider 615 between serially fed FE networks 636, 634 of a second serially fed FE network block 685 (see FIG. 6F). In the illustration of FIG. 6G, the digital signals 670 from digital signal IOs 669 of BF 624 can couple to initial FEs (e.g., 632A, 634A of FIGS. 6B, 6C) of the serially fed FE networks 632, 634, 636, and 638. Similar to the serially fed RF signals described with respect to FIGS. 6A, 6B, the digital signals 670 can be serially fed through the serially fed FE networks 632, 634, 636, 638 by digital through lines 680. As mentioned above, the digital signals 670 and RF signals (e.g., from BF RFIOs 686 and BF RFIOs 696) can share combined RF and digital routing channels 677. When compared with FIG. 6F, the configuration of FIG. 6G leaves the digital signal routing channels 671 shown in FIG. 6F open to act as power routing channels 676 for the power bus 674 from the FE power supply 675. In some cases, the individual FEs of serially fed FE networks 632, 634, 636, 638 can include multiple power ports 684 (see FIG. 6F), which can reduce the trace distance from the power bus 674 to individual components (see FIG. 6D) within the individually FEs of serially fed FE networks 632, 634, 636, 638.

In the illustrated example of FIG. 6G, a four serially fed FE network block 695 including the power and digital signal routing in combined RF and digital routing channels 677 is provided as an illustrative example. In some embodiments, a similar configuration can be used with more or fewer serially fed FE networks than shown in FIG. 6G. In addition, while each of the serially fed FE networks 632, 634, 636, 638 are illustrated with four individual FEs, more or fewer individual FEs can be included in serially fed FE networks 632, 634, 636, 638 without departing from the scope of the present disclosure.

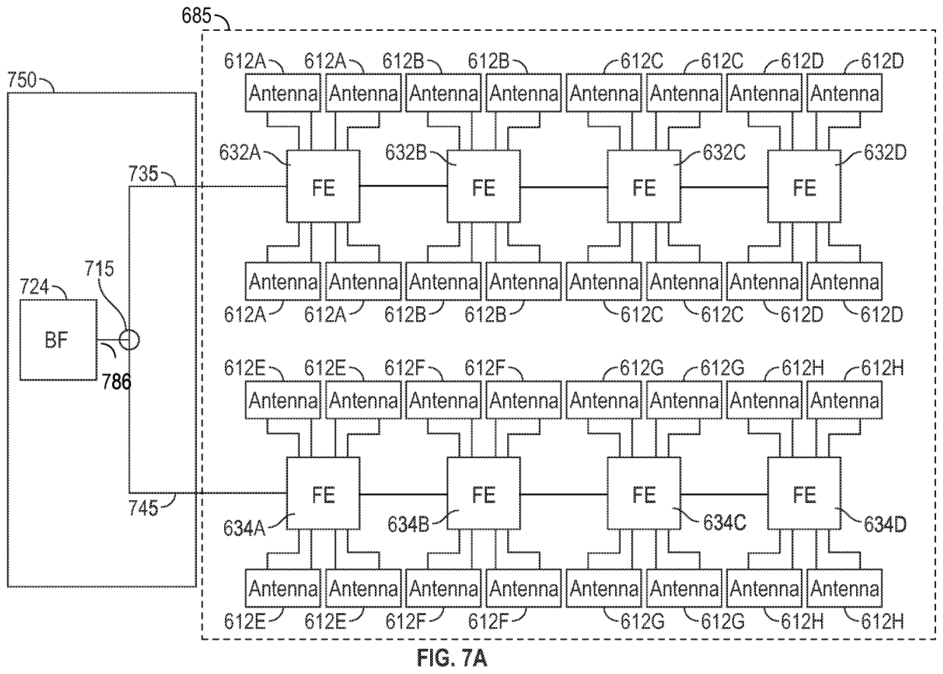

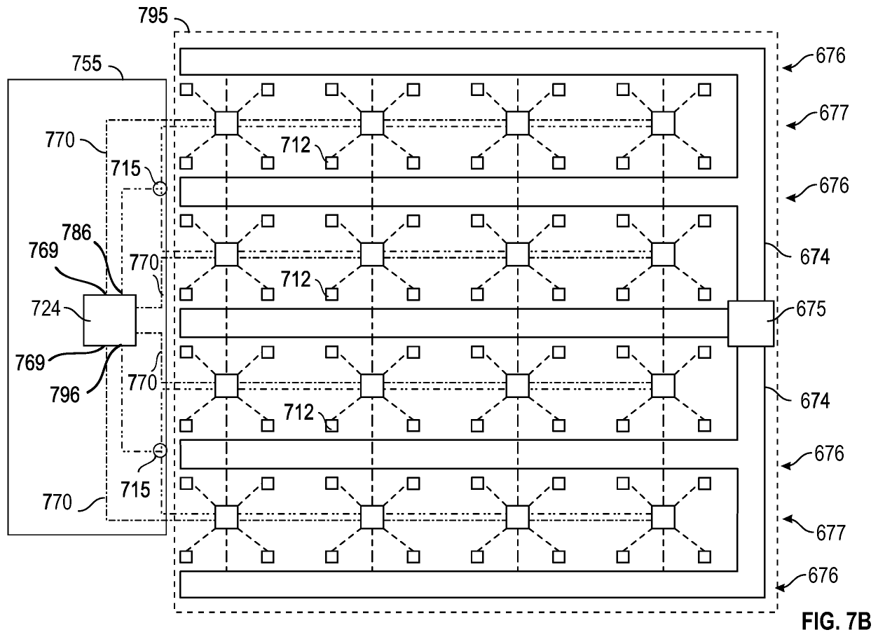

FIG. 7A illustrates a routing configuration for a phased array antenna that utilizes an auxiliary BF component 750. FIG. 7A also illustrates a serially fed FE network block 685 including serially fed FE networks 632, 634, which can be similar to and perform similar functions to the serially fed FE network block 685 of FIGS. 6B, 6C, and 6F. In the illustrated example of FIG. 7A, BF 724 includes a BF RFIO 786 and a combiner/divider 715 with branches 735, 745 included in the auxiliary BF component 750. In one illustrative example, the auxiliary BF component 750 can be a daughter PCB to a main PCB that includes the antenna elements (e.g., 612, 614 of FIGS. 6B and 6C) and serially fed FE networks (e.g., serially fed FE networks 632, 634 of FIGS. 6B and 6C) of a phased array antenna system (e.g., phased array antenna system 420 of FIG. 4B). As illustrated in the example of FIG. 7A, branches 735, 745 connected to the branches of combiner/divider 715 can be coupled to respective RF serial inputs (see FIGS. 4B, 4C) of initial FEs 632A, 634A of the serially fed FE networks 632, 634. In some embodiments, the auxiliary BF component 750 and the branches 735, 745 can be coupled to corresponding traces of a main PCB of a phased array antenna system (e.g., phased array antenna system 420 of FIG. 4B). In some cases, connections between the auxiliary BF component 750 and a main PCB can include, without limitation, a connector, wire bonds, solder balls, wireless coupling (e.g., electrical and/or magnetic AC coupling) or the like.

FIG. 7B illustrates another routing configuration utilizing an auxiliary BF component 755 that includes both BF RFIOs 786, 796, and digital signal IOs 769. In the illustrated example, the auxiliary BF component 755 is communicatively coupled with a four serially fed FE network block 795, which can be similar to and perform similar operations to the four serially fed FE network block 695 of FIG. 6G above. In the illustrated example of FIG. 7B, the auxiliary BF component 755 includes combiner/dividers 715, which can correspond to combiner/dividers 715. As illustrated, the branches of the combiner/divider 715 can be coupled to different serially fed FE networks of the four serially fed FE network block 695 to share the BF RFIOs 786, 796 of the BF 724. The BF 724 also includes digital signal IOs 769 that can be used to communicate with the serially fed FE networks of four serially fed FE network block 695 with digital signals 770 as described above with respect to FIG. 6G. In some embodiments, the RF signal (e.g., via the branches of the combiner/dividers 715) and the digital signals 770 of the auxiliary BF component 755 can be coupled to corresponding traces of a main PCB of a phased array antenna system (e.g., phased array antenna system 420 of FIG. 4B). In some cases, connections between the auxiliary BF component 755 and the main PCB can include, without limitation, a connector, wire bonds, or the like.

In some embodiments, the auxiliary BF components 750, 755 of FIGS. 7A and 7B can include more or fewer components than shown without departing from the scope of the present disclosure. In some embodiments, other components such as a modem (e.g., modem 428 of FIG. 4B), reference clock (e.g., reference clock 430 of FIG. 4B), additional BFs, and/or other components can be included in the auxiliary BF components 750, 755. In some embodiments, a PCB for the auxiliary BF components 750, 755 can include more PCB layers (e.g., PCB layers 603 of FIGS. 6D, 6E) than a main PCB that includes serially fed FE networks 632, 634, antenna elements 612, routing for digital signals, routing for power, routing for RF signals to the serially fed FE networks, other components, and/or any combination thereof.

FIG. 8A illustrates a block diagram for a signal distribution configuration 800 for a multiple beam phased array antenna system. In the illustrated example, the BF 824 can simultaneously receive and/or transmit RF signals corresponding to two separate data beams of a phased array antenna. For example, a first data beam (referred to herein as BEAM 1) may have a first steering direction and a second data beam (referred to herein as BEAM 2) can have a second steering direction, different from the first steering direction. In some cases BEAM 1 and BEAM 2 can have different center frequencies. In one illustrative example, the two data beams can be used to ensure that data communication remains active even if communication via one of the data beams becomes interrupted. For example, referring to FIGS. 1A and 1B a UT 112A can communicate with two SATs 102, each with one of the data beams BEAM 1, BEAM 2. In some embodiments, if the UT 112A loses a communication link with one of the SATs 102, data communication can continue with the remaining connected SAT of the SATs 102 using one of the two data beams BEAM 1, BEAM 2. In some cases, communication with two SATs 102 can be used to increase (e.g., double) data throughput of the UT 112A. For example, the UT 112A can communicate with a first SAT using BEAM 1 and a second SAT using BEAM 2. In some cases, the data transmitted on BEAM 1 and BEAM 2 can be associated with different types of data. For example, without limitation, BEAM 1 can be associated with video and/or audio streaming data and BEAM 2 can be associated with video game data. In some cases, the data transmitted using BEAM 1 and BEAM 2 can be associated with the type of data. For example, without limitation, both BEAM 1 and BEAM 2 can be associated with video and/or audio streaming data. In some cases, two data beams BEAM 1, BEAM 2 can have a same steering direction and can be used to increased (e.g., double) the data throughput of the UT 112A. For example, the UT 112A can communicate with SAT 102A using two data beams BEAM 1, BEAM 2.

In the illustrated example of FIG. 8A, distribution/combination networks similar to the distribution/combination networks 805, 807 are used to couple BF RFIOs 886A-886D, 896A-896D of the BF 824 to individual FEs, 832, 834, 836. In the illustrated example, BF RFIOs 886A-886D (collectively referred to herein as BF RFIOs 886) are used by the BF 824 to transmit and/or receive RF signals corresponding to the first data beam 1. As illustrated, the RF signals to/from BF RFIOs 886 are distributed by four distribution/combination networks collectively referred to herein as distribution/combination networks 805 (shown as dashed-and-dotted lines to the individual FEs 832, 834, 836). Similarly, as illustrated, BF RFIOs 896A-896D (collectively referred to herein as BF RFIOs 896) are used by the BF 824 to transmit and/or receive RF signals corresponding to the second data beam BEAM 2. As illustrated, the RF signals to/from BF RFIOs 896 are distributed by four distribution/combination networks collectively referred to herein as distribution/combination networks 807 (shown as dashed lines) to the individual FEs 832, 834, 836. In the illustration of FIG. 8A, one RFIO of the BF RFIOs 886 and one RFIO of the BF RFIOs 896 can be communicatively coupled to a respectively block of individual FEs 885A-885D (collectively referred to herein as FE network blocks 885). For example, BF RFIOs 886A, 896A can be communicatively coupled to the individual FEs of FE network block 885A, and so on.

In the illustrated example, the individual FEs 832, 834, 836 can include transmit components and/or receive components configured to transmit and/or receive RF signals associated with the two data beams BEAM 1, BEAM 2 to/from antenna elements coupled to each of the individual FEs 832, 834, 836. In the illustrated example of FIG. 8A, antenna elements 812A coupled to individual FE 832 and antenna elements 812B coupled to individual FE 834 are labeled, while antenna elements coupled to other individual FEs 836 are not labeled. The labeled antenna elements 812A, 812B and unlabeled antenna elements coupled to individual FEs 832, 834, 836 are collectively referred to herein as antenna elements 812.

In the example of FIG. 8A, each of the distribution/combination networks 805, 807 includes a routing structure similar to the distribution/combination networks 555, 565 of FIG. 5B. In the illustrated example, each of the distribution/combination networks 805, 807 is routed with a matching length between a corresponding BF RFIO 886, 896 and each of the corresponding connected individual FEs 832, 834, 836. At each branching junction, the distribution/combination networks 805, 807 can include combiner/divider 815, which can correspond to the combiner/dividers 515, 518, and/or 525 of FIGS. 5A and 5B. In the illustrated example of FIG. 8A, the distribution/combination networks 805, 807 are also routed from the BF RFIOs 886, 896 in different directions to minimize the number of crossings between the conductive traces making up the distribution/combination networks 805, 807. However, a crossing region 888 is illustrated near the terminal ends of distribution/combination networks 805, 807 that couple to the individual FEs 836 of block 885D. As illustrated, for the distribution/combination networks 805, 807 to reach each individual FE in the FE network blocks 885, the distribution/combination networks 805, 807 cross one another one or more times. As a result, routing of both the distribution/combination networks 805, 807 using a single metal layer as described with respect to routing of distribution/combination networks 505, 507, 555, 565 of FIGS. 5A-5C may not be achieved with the configuration shown in FIG. 8A.

FIG. 8B is a simplified cross-sectional diagram of a PCB 860 illustrating example connections between BFs 824, 826 and FEs 832, 834 included in FE network block 885A of FIG. 8A using distribution/combination networks 805, 807 of FIG. 8A. Antenna elements 812A, 812B corresponding to respective FEs 832, 834 (see FIG. 8A) are illustrated as being physically and electrically coupled to a first side 802 of the PCB 860. In some embodiments, BFs 824, 826 and FEs 832, 834 can be physically and electrically coupled to a second side 804 of the PCB 860, opposite the first side 802.

As illustrated in FIG. 8B, the PCB 860 can include multiple layers 803A through 803H (collectively referred to herein as PCB layers 803). Conductive (e.g., metallic) traces and/or planes between the individual PCB layers 803A through 803H can be used to provide electrical connections (e.g., RF connections, digital control signal connections, etc.) between components on a same PCB layer and/or different PCB layer(s) of the PCB layers 803, and/or to provide ground and power connections. In the illustrated example of FIG. 8B, double sided arrows represent signal routing paths between BFs 824, 826 and the FEs 832, 834 through the distribution/combination networks 805, 807. In the illustrated example of FIG. 8B, the BF RFIO 896A associated with BEAM 2 is included in a second BF 826 that is not shown in FIG. 8A. The single BF configuration of FIG. 8A and the two BF configuration shown in FIG. 8B illustrate that a multi-beam phased array antenna system can utilize a single BF or multiple BFs for the multiple beams without departing from the scope of the present disclosure. In some embodiments utilizing the single BF 824 configuration of FIG. 8A, the BF RFIO 896A of BF 826 can instead be routed from BF RFIO 896A of BF 824 as shown in FIG. 8A in a similar fashion to the routing illustrated in signal distribution configuration 800 of FIG. 8B. Because of the two-dimensional nature of FIG. 8B, the full distribution/combination networks 805, 807 cannot be shown. The combiner/dividers 815 of FIG. 8A are not shown in the illustration of FIG. 8B, but a terminal stage divider/combiner (e.g., divider combiners included in the crossing region 888 of FIG. 8A) are illustrated, with branches coupling to FEs 832, 834, respectively. As a result of the crossing described with respect to crossing region 888 of FIG. 8A above, at least a portion of the distribution/combination networks 805, 807 may need to be routed on different PCB layers. In the illustrated example, the disparity between vertical position (e.g., in the z-axis direction of FIG. 8B) of the different double sided arrows for portions of the distribution/combination networks 805, 807 when compared to the branches is provided to more closely resemble the terminal portions of the distribution/combination networks 805, 807 shown in FIG. 8A.

In the illustrated example of FIG. 8B, each distribution/combination network 805, 807 may be routed in a single routing layer. For example, distribution/combination network 807 can be routed on conductive traces between the PCB layers 803D, 803E and distribution/combination network 805 can be routed on the conductive traces between PCB layers 803G, 803H. In some cases, the requirement for an additional routing layer at the crossing points of the distribution/combination networks 805, 807 (see crossing region 888 of FIG. 8A) can add one or more layers to a minimum number of layers required to route the PCB 860. For example, when compared to the six PCB layers 503 of FIG. 5C, the PCB layers 803 include two additional layers for a total of eight layers. The two additional layers can correspond to a ground layer and a signal routing layer for the extra distribution/combination network needed to route a second data beam to the FEs 832, 834. In some embodiments (not shown), the distribution/combination networks 805, 807 can be routed on any single layer and/or multiple layers of the PCB layers 803. In some cases, adding layers to PCB 860 can add cost, weight, and/or routing complexity to a phased array antenna system that utilizes the signal distribution configuration 800 shown in FIG. 8A. In addition, crossing of signal routing traces associated with different data beams (e.g., BEAM 1, BEAM 2) can increase the chance of coupling data between BEAM 1 and BEAM 2. In some examples, coupling data between BEAM 1 and BEAM 2 can result in reduced SNR (e.g., for transmitted and/or received signals) and/or unintended emissions of data from BEAM 1 at the frequency of BEAM 1 in the steering direction of BEAM 2 or vice-versa.

FIG. 9A illustrates a block diagram for a signal distribution configuration 900 for a multiple beam phased array antenna system. In the illustrated example, the BF 924 can simultaneously receive and/or transmit RF signals corresponding to two separate data beams BEAM 1, BEAM 2 of a phased array antenna similar to BF 824 of FIG. 8A.

In the signal distribution configuration 900 of FIG. 9A, BF RFIOs 986, 996 are coupled to initial FEs (e.g., initial FEs 432A, 434A of FIGS. 4B and 4C) of serially fed FE networks 932, 934, 936. In the illustrated example, the serially fed FE networks 932, 934, 936 can be similar to and perform similar functions to the serially fed FE networks 432, 434 of FIGS. 4B, 4C and individual FEs of the serially fed FE networks 932, 934, 936 can correspond to individual FE 492R of FIG. 4D. In the illustrated example, of FIG. 9A, the serially fed FE networks 932, 934, 936 are arranged in pairs in FE network blocks 985A-985D (collectively referred to herein as FE network blocks 985). In the illustrated example of FIG. 9A, antenna elements 912A and 912B are coupled to individual FE 932, while antenna elements coupled to other individual FEs of the serially fed FE networks 934, 936 are not labeled. The labeled antenna elements 912A, 912B and unlabeled antenna elements coupled to individual FEs of the serially fed FE networks 932, 934, 936 are collectively referred to herein as antenna elements 912.

In the illustrated example of FIG. 9A, each of the BF RFIOs 986A-986D (collectively referred to herein as BF RFIOs 986) and BF RFIOs 996A-996D (collectively referred to herein as BF RFIOs 996) of the BF 924 can electrically couple to the initial FEs of two different serially fed FE networks 932, 934, 936. For example, in the illustrated example of FIG. 9A, each of the individual FEs of the serially fed FE networks 932, 934, 936 can include two RF serial inputs 937 and two RF serial outputs 939. Each individual RF serial input 937 can correspond to an RF serial input 437 of FIGS. 4B, 4D for a respective data beam 1, BEAM 2. In some embodiments, the individual FEs (e.g., individual FE 492R of FIG. 4D) can include additional components, including but not limited to additional receive (Rx) components and/or additional transmit (Tx) components to process the two data beams BEAM 1, BEAM 2 to/from the antenna elements 912.

In the example of FIG. 9A, each of the distribution/combination networks 905, 907 includes a routing structure similar to the routing connections between BF RFIO 686 and serially fed FE networks 632, 634 of FIG. 6C. In the illustrated example, each of the distribution/combination networks 905, 907 is from a corresponding BF RFIO 986, 996 to a midpoint between two serially fed FE networks of each of the serially fed FE network blocks 985A through 985D (collectively referred to herein as serially fed FE network blocks 985). As illustrated, each distribution/combination network 905, 907 includes a branching junction that connects the corresponding distribution/combination network 905, 907 to the initial FEs of two serially fed FE networks of each serially fed FE network block 985. As illustrated the distribution/combination networks 905, 907 can include combiner/dividers 915, which can correspond to the combiner/dividers 515, 518, and/or 525 of FIGS. 5A and 5B. In the illustrated example of FIG. 9A, the distribution/combination networks 905, 907 are also routed from the BF RFIOs 986, 996 in routing channels that can run between the rows formed by the FE network blocks 985. It should be noted that the routing illustrated in FIG. 9A provides only an example and routing configurations on different numbers of layers and/or over different routing paths can be used without departing from the scope of the present disclosure. In some cases, the signals from BF RFIOs 986, 996 received at RF serial inputs 937 of the serially fed FE networks 932, 934, 936 can be routed to additional individual FEs of the serially fed FE networks by through paths 941, 943 for BEAM 1 and BEAM 2, respectively. The RF through paths 941, 943 can provide serial connections between individual FEs of the serially fed FE networks 932, 934, 936 as illustrated in FIG. 9A. Accordingly, each BF RFIO 986, 996 can be communicatively coupled with thirty-two (32) antenna elements in the configuration shown in FIG. 9A.

In one illustrative example, the distribution/combination networks 905, 907 can couple to initial FEs of the serially fed FE networks 932, 934, 936, and routing to the other individual FEs can occur through RF through paths 941 and RF through paths 943. In some cases, a BF RFIO associated with BEAM 2 (e.g., BF RFIO 996A) can be electrically coupled to the RF through path 943 of a serially fed FE network. For example, as illustrated, BF RFIO 996A associated with BEAM 2 is electrically coupled to the paths 943 (e.g., the upper paths) of the serially fed FE networks 932, 934. In contrast, BEAM 2 is coupled to the paths 941 (e.g., the lower paths) of the serially fed FE networks 936 in the second block 985B. In some implementations, each of the RF through paths 941, 943 can be configured to selectively operate on any of two or more beams (e.g., BEAM 1, BEAM 2) to facilitate a non-overlapping layout. For example, the individual FEs of the serially fed FE networks 932, 934, 936 can be programmable to provide signal distribution and/or beamforming for either BEAM 1 or BEAM 2. As illustrated in FIG. 9A, using the serially fed FE networks 932, 934, 936 in the configuration 900, the distribution/combination networks 905, 907 do not cross. Because of the lack of crossing between the conductive traces of the distribution/combination networks 905, 907, in some cases, all of the routing between BF 924 and the serially fed FE networks 932, 934, 936 can be included in a single layer of a PCB.

The example of FIG. 9A illustrates only one example configuration for distribution of signals from a single BF RFIO (e.g., BF RFIO 996A to multiple serially fed FE networks (e.g., serially fed FE networks 932, 934). For example, although the serially fed FE network block 985A is shown with two serially fed FE networks 932, 934 arranged in a same “row” (e.g., along a straight line in the x-axis direction), other configurations can be used without departing from the scope of the present disclosure. For example, a serially fed FE network block can include serially fed FE networks in different “rows” of the phased array antenna. For example, a serially fed FE network block can include the serially fed FE network 934 and an adjacent serially fed FE network 936. In some examples, more than two (e.g., three or more) serially fed FE networks can share a single BF RFIO by including an additional combiner/divider layer to couple the BF RFIO to any number of serially fed FE networks. In one illustrative example, the serially fed FE networks included in serially fed FE network blocks 985A, 985B can be combined into a serially fed FE network block (not shown) including four serially fed FE networks. In such a configuration, a single BF RFIO (e.g., BF RFIO 996A) can be mapped to sixty-four (64) antenna elements for either BEAM 1 or BEAM 2.

In addition, although each of the serially fed FE networks 932, 934, 936 of FIG. 9A are shown including an equal number of individual FEs (e.g., four), serially fed FE networks of a phased array antenna can include a different number of individual FEs (e.g., two or more). In some cases, serially fed FE network blocks can include serially fed FE networks with differing numbers of individual FEs. For example, in an alternative configuration, serially fed FE network 932 can include four individual FEs and serially fed FE network 934 can include three (or two, five, or more) individual FEs instead of the four individual FEs shown in FIG. 9A.

In some embodiments, the BF 924 and portions of the distribution/combination networks 905, 907 can be included in an auxiliary component (e.g., auxiliary BF components 750, 755 of FIGS. 7A, 7B).

FIG. 9B is a simplified cross-sectional diagram of a PCB 960 illustrating example connections between BFs 924, 926 and individual FEs 932A, 932B of the serially fed FE network 932 using distribution/combination networks 905, 907 of FIG. 9A. Antenna elements 912A, 912B corresponding to respective individual FEs 932A, 932B (see FIG. 9A) are illustrated as being physically and electrically coupled to a first side 902 of the PCB 960. In some embodiments, BFs 924, 926 and individual FEs 932A, 932B can be physically and electrically coupled to a second side 904 of the PCB 960, opposite the first side 902.

As illustrated in FIG. 9B, the PCB 960 can include multiple layers 903A through 903F (collectively referred to herein as PCB layers 903). Conductive traces and/or planes on the individual PCB layers 903A through 903F can be used to provide electrical connections (e.g., RF connections, digital control signal connections, etc.) between components on a same PCB layer and/or different PCB layer(s) of the PCB layers 903, and/or to provide ground and power connections. In the illustrated example of FIG. 9B, double sided arrows represent signal routing paths between BFs 924, 926 and individual FEs 932A, 932B of the serially fed FE network 932 through the distribution/combination networks 905, 907. In the illustrated example of FIG. 9B, the BF RFIO 996A associated with data beam 2 is included in a second BF 826 that is not shown in FIG. 9A. The single BF configuration of FIG. 9A and the two BF configuration shown in FIG. 8B illustrate that a multi-beam phased array antenna system can utilize a single BF or multiple BFs for the multiple beams without departing from the scope of the present disclosure. In some embodiments utilizing the single BF 924 configuration of FIG. 9A, the BF RFIO 996A of BF 926 can instead be routed from BF RFIO 996A of BF 924 as shown in FIG. 8A routed in a similar fashion to the routing illustrated in signal distribution configuration 900 of FIG. 9B. Because of the two-dimensional nature of FIG. 9B, the full distribution/combination networks 905, 907 cannot be shown. The combiner/dividers 815 of FIG. 9A are not shown in the illustration of FIG. 9B, and only one branch of each of the distribution/combination networks 905, 907 associated with BF RFIOs 986A, 996A and coupled to the serially fed FE network 932 are shown. Because there are no crossings of the distribution/combination networks 905, 907 required to distribute the two data beams BEAM 1, BEAM 2 In the illustrated example, the disparity between vertical position (e.g., in the z-axis direction of FIG. 9B) of the different double sided arrows for portions of the distribution/combination networks 905, 907 when compared to the branches is provided to provide visibility of both the distribution/combination networks 905, 907 in the illustration. In some embodiments, the through paths 941 and 943 can be routed on the same layer as the distribution/combination networks 905, 907. Although not shown, additional through paths 941, 943 can be used to route to additional individual FEs of the serially fed FE network 932.

In the illustrated example of FIG. 9B, both of the distribution/combination networks 905, 907 can be routed on a same layer of the PCB 960. For example, distribution/combination networks 905, 907 can be routed on conductive traces between the PCB layers 903E, 903F. In some embodiments, the routing between individual FEs (e.g., individual FEs 932A, 932B) can also be on the same PCB layer as the distribution/combination network 905, 907. In some cases, no additional layers are required to include an additional data beam (e.g., relative to the configurations shown in FIGS. 5A-5D and 6A-6G) as shown in configuration 900 of FIG. 9A. In some embodiments, the PCB 960 can include the same number of layers used for the single beam configurations shown in FIGS. 5A-5D and 6A-6G.

### Power and Noise Performance of Serially Fed Fe Networks

FIGS. 10A and 10B are block diagrams illustrating different example routing combinations according to the present disclosure and resulting power distribution. In the illustrated examples of both FIGS. 10A and 10B, a 8×8 antenna matrix 1005 and corresponding 4×4 matrix of FEMs 1082 is arranged with a BF 1024 included in a region outside of the antenna matrix 1005. FIG. 10A illustrates a distribution technique utilizing distribution/combination networks that have terminal ends connected to each one of the individual FEs (see FIGS. 5A-5D) included in the antenna matrix 1005 of FIG. 10A. In contrast, although FIG. 10B also includes a distribution/combination network, the terminal ends of the distribution/combination network are coupled only to initial FEs of the serially fed FE networks of the antenna matrix 1005.

Returning to FIG. 10A, the distribution/combination network 1010 includes four combiner/dividers (see combiner/dividers 1011, 1015, 1018, and 1025), between the BF RFIO 1066 of BF 1024 and each of the individual FE of the antenna matrix 1005. As illustrated, the BF 1024 can transmit signals in a transmit mode with a power level of Po. Assuming that the combiner/dividers 1011, 1015, 1018, and 1025 are ideal, each of the branches from the respective divider/combiners can receive half the power (e.g., −3 dB) that enters the combiner/divider. In the embodiment of FIG. 5A, the use of four combiner/dividers 1011, 1015, 1018, 1025 for distributing RF signals from the BF RFIO 1066 can result in a power level received at the individual FEs of antenna matrix 1005 that is 12 dB less than Po.

Referring to FIG. 10B, the distribution/combination network 1010 includes two combiner/dividers (see combiner/dividers 1011, 1015 of FIG. 10B) between the BF RFIO 1066 of BF 1024 and initial FEs of each of the serially fed FE networks in each of the two serially fed FE network blocks 685. As noted above with respect to FIG. 10A, if the combiner/dividers 1011, 1015 are ideal, each of the branches of the respective divider/combiners can receive half the power (e.g., −3 dB) that enters the combiner/divider. Within the serially fed FE networks of the serially fed FE network blocks 685, the power level of the RF signal from the BF RFIO 1066 can be maintained between each serial link of the individual FEs 1092. For example, signal conditioning components (e.g., signal conditioning components 447, 449 of FIG. 4D) can provide gain to the RF signal through the serial links of the serially fed FE networks. In some embodiments, reducing the power requirement for power output from the BF RFIO 1066 of the BF 1024 can reduce the number of BFs required in a phased array antenna system, and/or loosen constraints on the design of BFs in the phased array antenna system.

In addition to the benefits of reducing the amount of power lost through the distribution/combination network 1010 of FIG. 10B when compared with the distribution/combination network 1010 of FIG. 10A, the serially fed FE network configuration of FIG. 10B can also provide benefits to noise performance.

For example, referring to FIG. 10B, the serially fed FE networks 1036 can be operated in an Rx configuration. Each signal path associated with an antenna element 1012 can contribute an amount of noise power N. In one illustrative example, the signal-to-noise ratio (SNR) of a signal received from each of the antenna elements 1012 can be equal to a SNR value of SNR₁. The FEMs 1082 and the individual FEs 1092 can perform beamforming e.g., by phase shifting using phase shifters 483 of FIG. 4D) on the received signal from each connected antenna element (e.g., four antenna elements 1012). The resulting beamformed signals from each antenna element 1012 can be coherently added in the current/voltage domain. As a result of coherently combining the signals from four antenna elements 1012, the output SNR of signals from each FEM 1082 (e.g., at FEM RFIOs 1083) and/or each individual FE 1092 can be equal to 4*SNR₁. Through further coherent current/voltage combination of the signals from four individual FEs of the serially fed FE networks 1036, the SNR at the RFIO 1030 can be equal to 4*4*SNR₁. Similarly, the signals from four FEMs 1082 can be combined by combiners/dividers 1018, 1025 and the resulting SNR at the output 1084 of combiner/divider 1018 can be equal to 4*4*SNRI. Accordingly, for an equal number of combined antenna signals, the SNR produced by the configuration of FIG. 10A and the configuration of 10B can be equal.

However, although he SNR for the configurations of FIG. 10A and FIG. 10B can be equal, the absolute noise power for each configuration may differ. As noted above, each of the individual FEs 1092 of the serially fed FE networks 1036 combines signals from four antenna elements (e.g., M=4). In the illustrated example, the noise power N can be uncorrelated and therefore when the noise power contributions from the four antenna element signal paths connected to an individual FE 1092 are combined, the resulting noise power from each individual FE 1092 of the serially fed FE networks 1036 is equal to M*N. In the example of FIG. 10B, the noise contribution of each individual FE 1092 of the serially fed FE networks (e.g., four individual FEs connected in series) can combine similarly and the resulting noise power at the RFIO ports 1030 can be equal to 4*M*N. By comparison, each FEM 1082 can provide a noise power contribution from four connected antenna elements 1012 equal to the noise power contribution of M*N, which can be equal to the noise power contribution provided by individual FE 1092. However, the noise power from combining the noise from two FEMs 1082 by a combiner/divider (e.g., 1015, 1018, 1025) can be equal to the average noise power of the two signals being combined assuming the noise signals are uncorrelated and sufficiently higher in power than the thermal noise of the system. Assuming the noise power output by each FEM 1082 is equal to M*N, the total noise for four FEMs 1082 (e.g., at the output 1084 of combiner/divider 1018) can be equal to M*N. Accordingly, the noise power for a serially fed FE network 1036 can be larger than the noise power for an equal number of FEMs 1082 by a factor equal to the number of individual FEs 1092 in the serially fed FE networks 1036.

In some cases, as long as comparable signal to noise ratio is attained by the serially fed FE networks 1036, a larger absolute noise power (e.g., by a factor of 4) can be advantageous. For example, the larger noise power associated with serially fed FE networks 1036 can have the effect of suppressing other downstream noise sources such as routing losses between the BF 1024 and the serially fed FE networks 1036, noise figure of the BF 1024, and/or any other downstream noise sources. In some cases, the linear operational range of receive (Rx) components (e.g., LNAs 464A of FIG. 4C) within the BF 1024 may need to be extended to accommodate the larger overall signal provided by serially fed FE networks 1036.

In some examples, one or more processes, such as digital signaling and/or data processing operations, may be performed by one or more computing devices or apparatuses. In some examples, the phased array antenna systems, FEs, RFIO circuits, and/or other components described herein can be implemented by a user terminal or SAT shown in FIG. 1A and/or one or more computing devices with the computing device architecture 1100 shown in FIG. 11. In some cases, such a computing device or apparatus may include a processor, microprocessor, microcomputer, or other component of a device that is configured to carry out one or more operations described herein. In some examples, such computing device or apparatus may include one or more antennas for sending and receiving RF signals. In some examples, such computing device or apparatus may include an antenna and a modem for sending, receiving, modulating, and demodulating RF signals.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

In some cases, one or more operations described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which any operations are described is not intended to be construed as a limitation, and any number of the described operations can be combined in any order and/or in parallel to implement the processes.

FIG. 11 illustrates an example computing device architecture 1100 of an example computing device which can implement various techniques and/or operations described herein. For example, the computing device architecture 1100 can be used to implement at least some portions of the SATs 102, the SAGs 104, the user terminals 112 and/or the user network devices 114 shown in FIG. 1A, and perform at least some of the operations described herein. The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM) 1120 and random access memory (RAM) 1125, to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general purpose processor and a hardware or software service stored in storage device 1130 and configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art, such as a display, projector, television, speaker device. In some instances, multimodal computing devices can enable a user to provide multiple types of input to communicate with the computing device architecture 1100. The communication interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include software, code, firmware, etc., for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using signals and/or computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication devices, or integrated circuit devices having multiple uses including application in wireless communications and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

While illustrative embodiments have been illustrated and described, it will be appreciated that various changes can be made therein without departing from the spirit and scope of the disclosure.

Illustrative aspects of the disclosure include:

Aspect 1. A phased array antenna system comprising: a beamformer (BF) comprising a plurality of BF input/outputs (IOs); a plurality of antenna elements associated with a particular BF IO of the plurality of BF IOs; and a serially fed front end (FE) network comprising: a first FE comprising a first FE IO of the first FE electrically coupled to the particular BF IO, a second FE IO of the first FE, a first antenna IO coupled to a first antenna element of the plurality of antenna elements; and a second FE comprising a first FE IO of the second FE electrically coupled to the second FE IO of the first FE, a second FE IO of the second FE, and a second antenna IO coupled to a second antenna element of the plurality of antenna elements, wherein the first FE is configured to communicatively couple the particular BF IO of the plurality of BF IOs to the first antenna IO and the second FE IO of the first FE.

Aspect 2. The phased array antenna system of Aspect 1, wherein the second FE is configured to communicatively couple a signal from the second FE IO of the first FE received at the first FE IO of the second FE to the second antenna M.

Aspect 3. The phased array antenna system of any of Aspects 1 to 2, wherein the BF is communicatively coupled by the serially fed FE network to transmit RF signals to and/or receive RF signals from the first and second antenna elements of the plurality of antenna elements.

Aspect 4. The phased array antenna system of any of Aspects 1 to 3, wherein in a transmit configuration: the BF is configured to transmit a data beam to the particular BF IO; the first FE is configured to distribute the data beam received at the first FE IO of the first FE to the first antenna element and the second FE IO of the first FE; and the second FE is configured to distribute the data beam received at the first FE IO of the second FE from the second FE IO of the first FE to second antenna element.

Aspect 5. The phased array antenna system of any of Aspects 1 to 4, wherein the first FE includes one or more signal conditioning elements configured to adjust one or more of an amplitude, a phase, or a delay of a portion of the data beam distributed to the second FE IO of the first FE to produce a conditioned data beam.

Aspect 6. The phased array antenna system of any of Aspects 1 to 5, wherein the one or more signal conditioning elements comprises at least one amplifier.

Aspect 7. The phased array antenna system of any of Aspects 1 to 6, wherein: the second FE includes additional one or more signal conditioning elements; the additional one or more signal conditioning elements includes at least one additional amplifier; the at least one amplifier is configured to provide a common gain between the particular BF IO and the first antenna element of the plurality of antenna elements; and the at least one additional amplifier is configured to provide the common gain between the particular BF IO and the second antenna element of the plurality of antenna elements.

Aspect 8. The phased array antenna system of any of Aspects 1 to 7, wherein in a transmit (Tx) configuration: the second FE includes additional one or more signal conditioning elements; the additional one or more signal conditioning elements includes at least one additional amplifier; the at least one amplifier is configured to provide a first gain between the particular BF IO and the first antenna element of the plurality of antenna elements; and between the particular BF IO and the second antenna element of the plurality of antenna elements, wherein the first gain and the second gain are based on an excitation taper of the phased array antenna system.

Aspect 9. The phased array antenna system of any of Aspects 1 to 8, wherein the at least one amplifier is configured to generate a gain adjusted data beam based on the data beam received at the first FE IO of the first FE, wherein: the gain adjusted data beam is received at the first FE IO of the second FE; and the at least one amplifier is configured to provide the gain adjusted data beam to the first FE IO of the second FE with a first gain between the particular BF IO and the first FE IO of the second FE and a second gain between the particular BF IO and the first FE IO of the first FE, wherein the first gain and the second gain comprise a common gain.

Aspect 10. The phased array antenna system of any of Aspects 1 to 9, wherein the one or more signal conditioning elements comprises a phase shifter.

Aspect 11. The phased array antenna system of any of Aspects 1 to 10, wherein the first FE includes one or more signal conditioning elements configured to adjust one or more of an amplitude, a phase, or a delay of a portion of the data beam distributed to at least one of the first antenna IO or the second FE IO of the first FE.

Aspect 12. The phased array antenna system of any of Aspects 1 to 11, wherein the serially fed FE network comprises a plurality of individual FEs, and the plurality of individual FEs comprises the first FE and the second FE.

Aspect 13. The phased array antenna system of any of Aspects 1 to 12, wherein a last FE of the plurality of individual FEs includes a first FE IO of the last FE coupled to a second FE IO of another individual FE of the plurality of individual FEs and a second FE IO of the last FE is terminated.

Aspect 14. The phased array antenna system of any of Aspects 1 to 13, further comprising a distribution network disposed between the particular BF IO of the plurality of BF IOs and the first FE IO of the first FE of the serially fed FE network.

Aspect 15. The phased array antenna system of any of Aspects 1 to 14, wherein the distribution network communicatively couples the particular BF IO of the plurality of BF IOs to the serially fed FE network and at least one additional serially fed FE network.

Aspect 16. The phased array antenna system of any of Aspects 1 to 15, wherein the distribution network comprises a combiner/divider configured to equally divide a transmitted RF signal to the serially fed FE network and the at least one additional serially fed FE network.

Aspect 17. The phased array antenna system of any of Aspects 1 to 16, wherein, in a receive configuration: the second FE is configured to communicatively couple a received RF signal from the second antenna element by the first FE IO of the second FE to the second FE IO of the first FE; and the first FE is configured to: combine the received RF signal from the first antenna element with the received RF signal from the second antenna element to form a data beam; and communicatively couple the data beam to the first FE IO of the first FE.

Aspect 18. The phased array antenna system of any of Aspects 1 to 17, wherein the first FE includes one or more signal conditioning elements configured to adjust one or more of an amplitude, a phase, and a delay of a portion of the data beam received at the second FE IO of the first FE to produce a conditioned data beam.

Aspect 19. The phased array antenna system of any of Aspects 1 to 18, wherein the one or more signal conditioning elements comprises an amplifier.

Aspect 20. The phased array antenna system of any of Aspects 1 to 19, wherein the amplifier is configured to generate a gain adjusted data beam based on a data beam received at the second FE IO of the first FE, wherein: the gain adjusted data beam is received at the particular BF IO of the BF; and the amplifier is configured to provide the gain adjusted data beam to the particular BF IO with a gain of the gain adjusted data beam matching a gain of the data beam at the second FE IO of the first FE.

Aspect 21. The phased array antenna system of any of Aspects 1 to 20, wherein the first FE includes one or more signal conditioning elements configured to adjust one or more of an amplitude, a phase, or a delay of a portion of the data beam received from at least one of the second FE IO of the first FE or the first antenna IO.

Aspect 22. The phased array antenna system of any of Aspects 1 to 21, wherein the one or more signal conditioning elements comprises a phase shifter.

Aspect 23. The phased array antenna system of any of Aspects 1 to 22 further comprising a carrier having a first side and a second side opposing the first side, wherein the BF and the serially fed FE network are disposed on at least one of the first side of the carrier or the second side of the carrier.

Aspect 24. A phased array antenna system comprising: a BF comprising a plurality of BF IOs; a plurality of antenna elements associated with a particular BF IO of the plurality of BF IOs; a first serially fed front end (FE) network associated with a first subset of the plurality of antenna elements comprising: a first FE comprising a first FE IO of the first FE electrically coupled to the particular BF IO, a second FE IO of the first FE, and a first antenna IO coupled to a first antenna element of the plurality of antenna elements, wherein the first antenna element is included in the first subset of the plurality of antenna elements; and a second FE comprising a first FE IO of the second FE electrically coupled to the second FE IO of the first FE, a second FE IO of the second FE, and a second antenna IO coupled to a second antenna element of the plurality of antenna elements, wherein the second antenna element is included in the first subset of the plurality of antenna elements; a second serially fed FE network associated with a second subset of the plurality of antenna elements, different from the first subset of the plurality of antenna elements; and a distribution network configured to communicatively couple the particular BF IO of the plurality of BF IOs to the first serially fed FE network and the second serially fed FE network to transmit signals to and/or receive signals from the plurality of antenna elements.

Aspect 25. The phased array antenna system of Aspect 24, wherein the distribution network comprises a Wilkinson combiner/divider.

Aspect 26. A serially fed front end (FE) network comprising: a first FE comprising a first FE input/output (IO) electrically coupled to a particular beamformer (BF) IO of a BF, a first FE IO of the first FE, a second FE IO of the first FE, and a first antenna IO coupled to a first antenna element of a plurality of antenna elements; and a second FE comprising a first FE IO of the second FE electrically coupled to the second FE IO of the first FE, a second FE IO of the second FE, and a second antenna IO coupled to a second antenna element of the plurality of antenna elements, wherein the particular BF IO is communicatively coupled, by the serially fed FE network, to transmit signals to and/or receive signals from the first and second antenna elements of the plurality of antenna elements through the first FE IO of the first FE.

Aspect 27. The serially fed FE network of Aspect 26, the first FE further comprising one or more signal conditioning components configured to provide a transmit gain between the first FE IO of the first FE and the first FE IO of the first FE in a transmit mode and/or provide a receive gain between the second FE IO of the first FE and the second FE IO of the first FE in a receive mode.

Aspect 28. The serially fed FE network of any of Aspects 26 to 27, wherein the transmit gain is configured to produce an equal signal gain at the first FE IO of the first FE and the first FE IO of the second FE.

Aspect 29. The serially fed FE network of any of Aspects 26 to 28, wherein the receive gain is configured to produce an equal gain at the second FE IO of the first FE and the second FE IO of the second FE.

Aspect 30. The serially fed FE network of any of Aspects 26 to 29, wherein the one or more signal conditioning components comprise at least one of a variable gain amplifier (VGA), power amplifier (PA), low-noise amplifier (LNA), or a phase shifter.

Aspect 31. The serially fed FE network of any of Aspects 26 to 30, the first FE further comprising one or more first signal conditioning components and the second FE further comprising one or more second signal conditioning components, wherein: the one or more first signal conditioning components are configured to provide a common gain between the first FE IO of the first FE and the first antenna element of the plurality of antenna elements; and the one or more second signal conditioning components are configured to provide the common gain between the first FE IO of the first FE and the second antenna element of the plurality of antenna elements.

Aspect 32. The serially fed FE network of any of Aspects 26 to 31, further comprising: a last FE comprising: a first FE IO of the last FE electrically coupled to an FE IO of an additional FE of the serially fed FE network, wherein the additional FE immediately precedes the last FE in the serially fed FE network; a second FE IO of the last FE, wherein the second FE IO of the last FE is not coupled to any FE IO associated with the serially fed FE network; and a third antenna IO coupled to a third antenna element of the plurality of antenna elements, wherein the second FE IO of the last FE is not coupled to any other FE IO.

Aspect 33. The serially fed FE network of any of Aspects 26 to 32, wherein: the serially fed FE network comprises four FEs; the last FE comprises a fourth FE of the serially fed FE network; and the additional FE comprises a third FE of the serially fed FE network, wherein an additional FE IO of the additional FE is coupled to the second FE IO of the second FE.

Aspect 34. The serially fed FE network of any of Aspects 26 to 33, wherein the second FE IO of the last FE is terminated at a matched termination.

Aspect 35. The serially fed FE network of any of Aspects 26 to 34, wherein the last FE comprises last one or more signal conditioning components coupled to the second FE IO of the last FE, and at least one of the last one or more signal conditioning components of the last FE is disabled.

Aspect 36. The serially fed FE network of any of Aspects 26 to 35, wherein the first FE comprises first one or more signal conditioning components coupled to the second FE IO of the first FE and at least one of the first one or more signal conditioning components is enabled while the at least one of the last one or more signal conditioning components of the last FE is disabled, wherein the enabled at least one of the first one or more signal conditioning components corresponds to the disabled at least one of the last one or more signal conditioning components.

Aspect 37. The serially fed FE network of any of Aspects 26 to 36, wherein the enabled at least one of the first one or more signal conditioning components and the disabled at least one of the last one or more signal conditioning components comprises one or more of a VGA, a PA, an LNA, or a phase shifter.

Aspect 38. A beamformer comprising: an antenna port; first and second front-end (FE) Input/Outputs (IOs); and a distribution network configured to distribute a data beam signal received at the first FE IO to the antenna port and to the second FE IO in a transmit configuration and/or to combine a first received signal from the antenna port and an upstream signal from the second FE IO to form a combined received signal in a receive configuration, wherein the combined received signal is electrically coupled to the first FE IO.

Aspect 39. The beamformer of Aspect 38, further comprising one or more signal conditioning components disposed between the distribution network and the second FE IO.

Aspect 40. The beamformer of any of Aspects 38 to 39, wherein the one or more signal conditioning components comprises at least one of a low-noise amplifier, a power amplifier, a phase shifter, or a mixer.

Aspect 41. The beamformer of any of Aspects 38 to 40, further comprising one or more signal conditioning components disposed between the distribution network and the first FE IO.

Aspect 42. The beamformer of any of Aspects 38 to 41, further comprising one or more signal conditioning components disposed between the distribution network and the antenna port.

Aspect 43. A phased array antenna system comprising: a beamformer (BF) module comprising: a BF configured to transmit a data beam in a transmit configuration from a BF input/output (IO) of the BF and/or receive a received data beam by the BF IO of the BF in a receive configuration, wherein the BF module comprises a carrier, and the BF is disposed on a first side of the carrier; and a distribution network configured to couple the BF IO of the BF to a BF module IO of the BF module; and a phased array module comprising a serially fed front end (FE) network comprising a plurality of FEs, each FE of the serially fed FE network associated with at least one antenna element of a plurality of antenna elements, wherein an initial FE of the serially fed FE network includes a coupling FE IO electrically coupled to a phased array module IO of the phased array module by a coupling trace and a pass-through FE IO of the initial FE electrically coupled to an FE IO of a second FE of the serially fed FE network, wherein the coupling FE IO is electrically coupled to the BF module IO of the BF module.

Aspect 44. The phased array antenna system of Aspect 43, wherein the coupling FE IO is electrically coupled to the BF IO of the BF by at least the coupling trace, the phased array module IO of the phased array module, the BF module IO of the BF module, and the distribution network.

Aspect 45. The phased array antenna system of any of Aspects 43 to 44, wherein the BF module and the phased array module are coupled by at least one connector.

Aspect 46. The phased array antenna system of any of Aspects 43 to 45, wherein the BF module and the phased array module are communicatively coupled by at least one of a wire bond, a solder ball, or a wireless coupling.

Aspect 47. A phased array antenna system comprising: a carrier comprising a plurality of layers; a plurality of antenna elements, wherein the plurality of antenna elements is arranged in an antenna element lattice; a first serially fed FE network comprising a first plurality of front end modules (FEs), wherein each FE of the first serially fed FE network is electrically coupled to at least one antenna element of the plurality of antenna elements; and at least one beamformer (BF) configured to transmit a first data beam to a first BF input/output (IO) and transmit a second data beam to a second BF IO and/or receive the first data beam at the first BF IO and receive the second data beam at the second BF IO, wherein: the first BF IO electrically couples to a first FE IO of an initial FE of the first serially fed FE network; and the second BF IO electrically couples to a second FE IO of the initial FE of the first serially fed FE network.

Aspect 48. The phased array antenna system of Aspect 47, further comprising: a second serially fed FE network comprising a second plurality of FEs, wherein each FE of the second serially fed FE network is electrically coupled to at least one antenna element of the plurality of antenna elements; a first distribution network electrically coupled to the first BF IO; and a second distribution network electrically coupled to the second BF IO; wherein: a first portion of the first distribution network electrically couples to the initial FE of the first serially fed FE network; a second portion of the first distribution network electrically couples to the initial FE of the second serially fed FE network; a first portion of the second distribution network electrically couples to the initial FE of the first serially fed FE network; and a second portion of the second distribution network electrically couples to the initial FE of the second serially fed FE network.

Aspect 49. The phased array antenna system of any of Aspects 47 to 48, wherein the first distribution network is routed in a first routing channel of an antenna lattice and the second distribution network is routed in a second routing channel of the antenna lattice.

Aspect 50. The phased array antenna system of any of Aspects 47 to 49, further comprising a third distribution network electrically coupled to a third BF IO, an initial FE of a third serially fed FE network, and an initial FE of an initial FE of a fourth serially fed FE network, wherein the third distribution network is routed in the second routing channel of the antenna lattice.

Aspect 51. The phased array antenna system of any of Aspects 47 to 50, wherein the BF is configured to transmit the second data beam to the third BF IO and/or receive the second data beam at the third BF IO.

Aspect 52. The phased array antenna system of any of Aspects 47 to 51, wherein the first routing channel and the second routing channel are disposed on a common layer of the plurality of layers of the carrier.

Aspect 53. The phased array antenna system of any of Aspects 47 to 52, wherein a plurality of routing channels comprises the first routing channel and the second routing channel, a first subset of the plurality of routing channels including the first routing channel is associated with the first data beam and a second subset of the plurality of routing channels including the second routing channel is associated with the second data beam.

Aspect 54. The phased array antenna system of any of Aspects 47 to 53, wherein the first subset of the plurality of routing channels and the second subset of the plurality of routing channels are disposed in an alternating pattern between rows and/or columns of serially fed FE networks of a plurality of serially fed FE networks, wherein the plurality of serially fed FE networks comprises the first serially fed FE network and the second serially fed FE network.

Aspect 55. The phased array antenna system of any of Aspects 47 to 54, wherein the first routing channel and the second routing channel are included in separate routing channels.

Aspect 56. The phased array antenna system of any of Aspects 47 to 55, wherein the first routing channel and the second routing channel are included in a common routing channel.

Aspect 57. A phased array antenna system comprising: a transceiver comprising a transceiver input/output (IO); a plurality of antenna elements associated with the transceiver IO; and a serially fed front end (FE) network comprising: an first FE comprising a first FE IO of the first FE electrically coupled to the transceiver IO, a second FE IO of the first FE, a first antenna IO coupled to a first antenna element of the plurality of antenna elements; and a second FE comprising a first FE IO of the second FE electrically coupled to the second FE IO of the second FE, a second FE IO of the second FE, and a second antenna IO coupled to a second antenna element of the plurality of antenna elements, wherein the first FE is configured to communicatively couple the transceiver IO to the first antenna IO and the second FE IO of the first FE.

Aspect 58. A beamformer comprising: a transmit antenna port coupled to an antenna element; a receive antenna port coupled to the antenna element; a transmit input; a transmit output; a receive input; a receive output; and a distribution network configured to: distribute a transmit signal received at the transmit input to the transmit antenna port and to the transmit output; combine a first receive signal received at the receive antenna port from the antenna element and a second receive signal received at the receive input into a combined receive signal; and couple the combined receive signal to the receive output.

1. A phased array antenna system comprising:
a beamformer (BF) comprising a plurality of BF input/outputs (IOs);
a plurality of antenna elements associated with a particular BF IO of the plurality of BF IOs; and
a serially fed front end (FE) network comprising:
a first FE comprising a first FE IO of the first FE electrically coupled to the particular BF IO, a second FE IO of the first FE, a first antenna IO coupled to a first antenna element of the plurality of antenna elements; and
a second FE comprising a first FE IO of the second FE electrically coupled to the second FE IO of the first FE, a second FE IO of the second FE, and a second antenna IO coupled to a second antenna element of the plurality of antenna elements, wherein the first FE is configured to communicatively couple the particular BF IO of the plurality of BF IOs to the first antenna IO and the second FE IO of the first FE.

2. The phased array antenna system of claim 1, wherein the second FE is configured to communicatively couple a signal from the second FE IO of the first FE received at the first FE IO of the second FE to the second antenna IO.

3. The phased array antenna system of claim 1, wherein the BF is communicatively coupled by the serially fed FE network to transmit RF signals to and/or receive RF signals from the first and second antenna elements of the plurality of antenna elements.

4. The phased array antenna system of claim 1, wherein in a transmit configuration:
the BF is configured to transmit a data beam to the particular BF IO;
the first FE is configured to distribute the data beam received at the first FE IO of the first FE to the first antenna element and the second FE IO of the first FE; and
the second FE is configured to distribute the data beam received at the first FE IO of the second FE from the second FE IO of the first FE to second antenna element.

5. The phased array antenna system of claim 4, wherein the first FE includes one or more signal conditioning elements configured to adjust one or more of an amplitude, a phase, or a delay of a portion of the data beam distributed to the second FE IO of the first FE to produce a conditioned data beam.

6. The phased array antenna system of claim 5, wherein the one or more signal conditioning elements comprises at least one amplifier.

7. The phased array antenna system of claim 6, wherein:
the second FE includes additional one or more signal conditioning elements;
the additional one or more signal conditioning elements includes at least one additional amplifier;
the at least one amplifier is configured to provide a common gain between the particular BF IO and the first antenna element of the plurality of antenna elements; and
the at least one additional amplifier is configured to provide the common gain between the particular BF IO and the second antenna element of the plurality of antenna elements.

8. The phased array antenna system of claim 6, wherein in a transmit (Tx) configuration:
the second FE includes additional one or more signal conditioning elements;
the additional one or more signal conditioning elements includes at least one additional amplifier;
the at least one amplifier is configured to provide a first gain between the particular BF IO and the first antenna element of the plurality of antenna elements; and
the at least one additional amplifier is configured to provide a second gain, different from the first gain, between the particular BF IO and the second antenna element of the plurality of antenna elements, wherein the first gain and the second gain are based on an excitation taper of the phased array antenna system.

9. The phased array antenna system of claim 6, wherein the at least one amplifier is configured to generate a gain adjusted data beam based on the data beam received at the first FE IO of the first FE, wherein:
the gain adjusted data beam is received at the first FE IO of the second FE; and
the at least one amplifier is configured to provide the gain adjusted data beam to the first FE IO of the second FE with a first gain between the particular BF IO and the first FE IO of the second FE and a second gain between the particular BF IO and the first FE IO of the first FE, wherein the first gain and the second gain comprise a common gain.

10. The phased array antenna system of claim 5, wherein the one or more signal conditioning elements comprises a phase shifter.

11. The phased array antenna system of claim 4, wherein the first FE includes one or more signal conditioning elements configured to adjust one or more of an amplitude, a phase, or a delay of a portion of the data beam distributed to at least one of the first antenna IO or the second FE IO of the first FE.

12. The phased array antenna system of claim 1, wherein the serially fed FE network comprises a plurality of individual FEs, and the plurality of individual FEs comprises the first FE and the second FE.

13. The phased array antenna system of claim 12, wherein a last FE of the plurality of individual FEs includes a first FE IO of the last FE coupled to a second FE IO of another individual FE of the plurality of individual FEs and a second FE IO of the last FE is terminated.

14. The phased array antenna system of claim 12, further comprising a distribution network disposed between the particular BF IO of the plurality of BF IOs and the first FE IO of the first FE of the serially fed FE network.

15. The phased array antenna system of claim 14, wherein the distribution network communicatively couples the particular BF IO of the plurality of BF IOs to the serially fed FE network and at least one additional serially fed FE network.

16. The phased array antenna system of claim 15, wherein the distribution network comprises a combiner/divider configured to equally divide a transmitted RF signal to the serially fed FE network and the at least one additional serially fed FE network.

17. The phased array antenna system of claim 1, wherein, in a receive configuration:
the second FE is configured to communicatively couple a received RF signal from the second antenna element by the first FE IO of the second FE to the second FE IO of the first FE; and
the first FE is configured to:
combine the received RF signal from the first antenna element with the received RF signal from the second antenna element to form a data beam; and
communicatively couple the data beam to the first FE IO of the first FE.

18. The phased array antenna system of claim 17, wherein the first FE includes one or more signal conditioning elements configured to adjust one or more of an amplitude, a phase, and a delay of a portion of the data beam received at the second FE IO of the first FE to produce a conditioned data beam.

19. The phased array antenna system of claim 18, wherein the one or more signal conditioning elements comprises an amplifier.

20. The phased array antenna system of claim 19, wherein the amplifier is configured to generate a gain adjusted data beam based on a data beam received at the second FE IO of the first FE, wherein:
the gain adjusted data beam is received at the particular BF IO of the BF; and
the amplifier is configured to provide the gain adjusted data beam to the particular BF IO with a gain of the gain adjusted data beam matching a gain of the data beam at the second FE IO of the first FE.

21. The phased array antenna system of claim 18, wherein the first FE includes one or more signal conditioning elements configured to adjust one or more of an amplitude, a phase, or a delay of a portion of the data beam received from at least one of the second FE IO of the first FE or the first antenna IO.

22. The phased array antenna system of claim 18, wherein the one or more signal conditioning elements comprises a phase shifter.

23. The phased array antenna system of claim 1 further comprising a carrier having a first side and a second side opposing the first side, wherein the BF and the serially fed FE network are disposed on at least one of the first side of the carrier or the second side of the carrier.

24.-25. (canceled)

26. A serially fed front end (FE) network comprising:
a first FE comprising a first FE input/output (IO) electrically coupled to a particular beamformer (BF) IO of a BF, a first FE IO of the first FE, a second FE IO of the first FE, and a first antenna IO coupled to a first antenna element of a plurality of antenna elements; and
a second FE comprising a first FE IO of the second FE electrically coupled to the second FE IO of the first FE, a second FE IO of the second FE, and a second antenna IO coupled to a second antenna element of the plurality of antenna elements, wherein the particular BF IO is communicatively coupled, by the serially fed FE network, to transmit signals to and/or receive signals from the first and second antenna elements of the plurality of antenna elements through the first FE IO of the first FE.

27. The serially fed FE network of claim 26, the first FE further comprising one or more signal conditioning components configured to provide a transmit gain between the first FE IO of the first FE and the first FE IO of the first FE in a transmit mode and/or provide a receive gain between the second FE IO of the first FE and the second FE IO of the first FE in a receive mode.

28. The serially fed FE network of claim 27, wherein the transmit gain is configured to produce an equal signal gain at the first FE IO of the first FE and the first FE IO of the second FE.

29. The serially fed FE network of claim 27, wherein the receive gain is configured to produce an equal gain at the second FE IO of the first FE and the second FE IO of the second FE.

30. The serially fed FE network of claim 26, the first FE further comprising one or more first signal conditioning components and the second FE further comprising one or more second signal conditioning components, wherein:
the one or more first signal conditioning components are configured to provide a common gain between the first FE IO of the first FE and the first antenna element of the plurality of antenna elements; and
the one or more second signal conditioning components are configured to provide the common gain between the first FE IO of the first FE and the second antenna element of the plurality of antenna elements.

31. The serially fed FE network of claim 27, wherein the one or more signal conditioning components comprise at least one of a variable gain amplifier (VGA), power amplifier (PA), low-noise amplifier (LNA), or a phase shifter.

32. The serially fed FE network of claim 26, further comprising:
a last FE comprising:
a first FE IO of the last FE electrically coupled to an FE IO of an additional FE of the serially fed FE network, wherein the additional FE immediately precedes the last FE in the serially fed FE network;
a second FE IO of the last FE, wherein the second FE IO of the last FE is not coupled to any FE IO associated with the serially fed FE network; and
a third antenna IO coupled to a third antenna element of the plurality of antenna elements, wherein the second FE IO of the last FE is not coupled to any other FE IO.

33. The serially fed FE network of claim 32, wherein:
the serially fed FE network comprises four FEs;
the last FE comprises a fourth FE of the serially fed FE network; and
the additional FE comprises a third FE of the serially fed FE network, wherein an additional FE IO of the additional FE is coupled to the second FE IO of the second FE.

34. The serially fed FE network of claim 32, wherein the second FE IO of the last FE is terminated at a matched termination.

35. The serially fed FE network of claim 32, wherein the last FE comprises last one or more signal conditioning components coupled to the second FE IO of the last FE, and at least one of the last one or more signal conditioning components of the last FE is disabled.

36. The serially fed FE network of claim 35, wherein the first FE comprises first one or more signal conditioning components coupled to the second FE IO of the first FE and at least one of the first one or more signal conditioning components is enabled while the at least one of the last one or more signal conditioning components of the last FE is disabled, wherein the enabled at least one of the first one or more signal conditioning components corresponds to the disabled at least one of the last one or more signal conditioning components.

37. The serially fed FE network of claim 36, wherein the enabled at least one of the first one or more signal conditioning components and the disabled at least one of the last one or more signal conditioning components comprises one or more of a VGA, a PA, an LNA, or a phase shifter.

38.-58. (canceled)
